(19) United States
(12) Patent Application Publication
(10) Pub. No.: US 2014/0088938 A1
(43) Pub. Date: Mar. 27, 2014

(54) Prespacetime model of elementary particles, four forces and consciousness

(71) Applicant: Huping Hu, Stony Brook, NY (US)

(72) Inventor: Huping Hu, Stony Brook, NY (US)

(21) Appl. No.: 14/092,782

(22) Filed: Nov. 27, 2013

Related U.S. Application Data
(63) Continuation of application No. 12/964,558, filed on Dec. 9, 2010.

(51) Int. Cl. G06F 17/10

(52) U.S. Cl. CPC G06F 17/10
USPC 703/2

(57) ABSTRACT

A prespacetime model of elementary particles, four forces and consciousness has been formulated, which illustrates how the self-referential hierarchical spin structure of the prespacetime provides a foundation for creating, sustaining and causing evolution of elementary particles through matrixing processes embedded in said prespacetime. The prespacetime model reveals the creation, sustenance and evolution of fermions, bosons and spinless entities each comprised of an external wave function or external object and an internal wave function or internal object located respectively in an external world and internal world of a dual-world universe. The prespacetime model provides a unified causal structure for weak interaction, strong interaction, electromagnetic interaction, gravitational interaction, quantum entanglement, consciousness and brain function. The prespacetime model provides a unique tool for teaching, demonstration, rendering, and experimentation related to subatomic and atomic structures and interactions, quantum entanglement generation, gravitational mechanisms in cosmology, structures and mechanisms of consciousness, and brain functions.

This application is a continuation application of U.S. patent application Ser. No. 12/964,558 filed on Dec. 9, 2010, which claims priority from U.S. provisional application Ser. No. 61/288,333 filed Dec. 20, 2009, which applications are fully incorporated herein by reference.

### FIELD OF THE INVENTION

The invention herein relates to modeling creation, sustenance and evolution of elementary particles through self-referential hierarchical spin structures of prespacetime. In particular, working model for creating, sustaining and causing evolution of fermions, bosons and spinless particles are described as teaching tools. Further, working model for weak interaction, strong interaction, electromagnetic interaction, gravitational interaction, quantum entanglement, consciousness, brain function are also described as teaching tools.

### BACKGROUND OF THE INVENTION

Many experiments have shown that quantum entanglement is physically real (see Aspect, A., Dalibard, J., & Roger, G. Experimental test of Bell's inequalities using time-varying analyzers. Phys. Rev. Lett. 49, 1804-1807 (1982)). It is ubiquitous in the microscopic world and manifests itself macroscopically under some circumstances (see Ghosh, S., Rosenbaum, T. F., Aeppli, G. & Coppersmith, S. N. Entangled quantum state of magnetic dipoles. Nature 425, 48-51 (2003)). However, the essence and implications of quantum entanglement are still hotly debated. For example, it is commonly believed that quantum entanglement alone cannot be used to transmit binary or classical information. Further, despite of the fact that all interactions in biological systems at molecular and sub-molecular levels are quantum interactions in nature, it is commonly believed that quantum effects do not play any roles in biological functions such as brain functions due to quantum decoherence (see Tegmark, M. The importance of quantum decoherence in brain processes. Phys. Rev., 61E: 4194 (2000)).

Yet, I have recently discovered non-local effects of chemical substances on biological systems such as a human brain produced through quantum entanglement (Hu, H. P., & Wu, M. X. Photon induced non-local effect of general anesthetics on the brain. NeuroQuantology 4, 17-31 (2006), Hu, H. P., & Wu, M. X. Non-local effects of chemical substances on the brain produced through quantum entanglement. Progress in Physics v3, 20-26 (2006)). I have also discovered evidence of non-local chemical, thermal and gravitational effects produced through quantum entanglement (Hu, H. P., & Wu, M. X. Evidence of non-local physical, chemical and biological effects supports quantum brain. NeuroQuantology 4, 291-306 (2006); Hu, H. P., & Wu, M. X. Evidence of non-local chemical, thermal and gravitational effects. Progress in Physics v2, 17-21 (2007)).

My invention and discovery were made against such background. No model has previously been known which can model the creation, sustenance and evolution of fermions, bosons and spinless particles through the self-referential hierarchical spin structures of the prespacetime. Further, No model has previously been known which can model in a unified manner weak interaction, strong interaction, electromagnetic interaction, gravitational interaction, quantum entanglement, consciousness, and brain function through the self-referential hierarchical spin structures of the prespacetime.

### SUMMARY OF THE INVENTION

I have now invented the prespacetime model for modeling in the unified manner the creation, sustenance and evolution of fermions, bosons and spinless particles and the weak, strong, electromagnetic and gravitational interactions, quantum entanglement, consciousness, and brain function through the self-referential hierarchical spin structures of the prespacetime.

The subject invention is originated from my research on self-reference, nature of spin, consciousness, brain functions and nature of quantum entanglement. I have theorized that spin is a primordial self-referential process driving quantum mechanics, spacetime dynamics and consciousness (Hu, H. P. & Wu, M. X. Spin as primordial self-referential process driving quantum mechanics, spacetime dynamics and consciousness. NeuroQuantology, 2, 41-49 (2004); also see Cogprints ID2827 (2003)). I have also theorized that spin is a mind-pixel and the nuclear and/or electronic spins inside brain play important roles in certain aspects of brain functions such as perception (Hu, H. P., & Wu, M. X. Spin-mediated consciousness theory. Medical Hypotheses 63, 633-646 (2004); also see arXiv e-print quant-ph/0208068v1 (2002)).

Further, I have discovered the non-local effects of chemical substances on biological systems such as a human brain produced through quantum entanglement (Hu, H. P., & Wu, M. X. Photon induced non-local effect of general anesthetics on the brain. NeuroQuantology 4, 17-31 (2006), Hu, H. P., & Wu, M. X. Non-local effects of chemical substances on the brain produced through quantum entanglement. Progress in Physics v3, 20-26 (2006)). I have also discovered the evidence of non-local chemical, thermal and gravitational effects produced through quantum entanglement (Hu, H. P., & Wu, M. X. Evidence of non-local physical, chemical and biological effects supports quantum brain. NeuroQuantology 4, 291-306 (2006); Hu, H. P., & Wu, M. X. Evidence of non-local chemical, thermal and gravitational effects. Progress in Physics v2, 17-21 (2007)).

The subject invention is based on my realization that in the beginning there was prespacetime alone (e⁰=1) materially empty but wants to express itself. So, it began to imagine through primordial self-referential spin 1=e⁰=e^{iM-iM}=e^{iM}e^{-iM}=e^{-iM}/e^{-iM}=e^{iM}/e^{iM} . . . such that it created an external object to be observed and an internal object as observed, separated them into an external world and an internal world, cause them to interact through a self-referential Matrix and thus gave birth to a universe which it has since sustained and made to evolve.

The prespacetime is comprised of a body mathematically represented by Euler number e and a mind represented by imaginary unit i above e. The body and mind of the prespacetime is ground of all existence, can form external and internal wave functions as external and internal objects (with each pair forms an elementary entity or particle) and interaction fields between elementary entities which accompany the imaginations of the prespacetime. The body and mind can be self-acted on by the self-referential Matrix L_{M} of the prespacetime. The prespacetime has imagining power i to project external and internal objects by projecting, for example, external and internal phase ±M=+±(Et−p·x)/ above the body e. The universe so created is a dual-world comprising of the external world to be observed and internal world as observed under each relativistic frame x^{μ}=(t, x). In one view, the internal world (which by convention may have either negative or positive energy) is the negation/image of the external world (which by convention may also have either positive or negative energy). According to the present model, an absolute frame of reference exists and the said frame is the body e of the prespacetime. Therefore, if the prespacetime stops imagining, the universe would disappear into materially nothingness eⁱ⁰=e⁰=1.

In the present model, there exists an accounting principle for the dual-world which is conservation of zero. By way of an example, the total energy of the external object and its counterpart, the internal object, is zero. Also in this dual-world, self-gravity is the non-local self-interaction (wave mixing) between the external object in the external world and its negation/image in the internal world, that is, the negation appears to its external counterpart as a black hole visa versa. Gravity is the non-local interaction (quantum entanglement) between a first entity and a second entity or the external object of one entity or particle with the internal world as a whole.

According to the prespacetime model: (1) two spinors of a Dirac electron or positron are respectively the external and internal objects of the electron or positron; (2) electric and magnetic fields of a linear photon are respectively the external and internal objects of the photon which are always self-entangled; (3) a proton is likely a spatially confined positron with the confinement through an imaginary momentum, that is, downward self-reference; and (4) a neutron is comprised of an unspinized proton and a bound and spinized electron.

In the prespacetime model, consciousness in a broad embodiment is simply the prespacetime having both transcendental and immanent properties. The transcendental aspect of the consciousness is the origin of primordial self-referential spin including the self-referential Matrix and the consciousness projects the external and internal worlds through the said self-referential spin and, in turn, the immanent aspect of the consciousness observes the external world as the observed internal world through the said self-referential spin. A biological consciousness such as a human consciousness is a limited and particular version of this dual-aspect consciousness such that a human has limited free will and limited observation which is mostly classical at macroscopic levels but quantum at microscopic levels.

Key to the present model is: (1) occurrence of a primordial phase distinction through imagination i of the prespacetime, (2) matrixing of the prespacetime into the external and internal wave functions respectively as the external and internal objects of a first entity or particle in the dual world or interaction fields for interacting with a second entity or particles, and (3) governance of the external and internal wave functions by the self-acting and self-referential Matrix which accompanies the imagination i of the prespacetime so as to enforce the accounting principle of conservation of zero in the dual world.

The prespacetime model provides for interactions of the external and internal worlds through quantum entanglement since I have experimentally demonstrated that gravity is the manifestation of quantum entanglement (Hu, H. P., & Wu, M. X. Evidence of non-local physical, chemical and biological effects supports quantum brain. Neuro-Quantology 4, 291-306 (2006); Hu, H. P., & Wu, M. X. Evidence of non-local chemical, thermal and gravitational effects. Progress in Physics v2, 17-21 (2007)).

The prespacetime model provides for interactions within the external world through classical and relativistic physical laws with light speed c as the speed limit of the external interactions and influences of the internal world on the external objects in the external world through as gravity macroscopically and quantum effects microscopically. Thus, according to the prespacetime model, the interactions within the external world and/or the internal world are local interactions and conform to special theory of relativity, but the interactions across the dual world are non-local interactions, that is, quantum entanglement or gravity.

Therefore, according to the present model, the meaning of the special theory of relativity is that the speed limit c is only applicable in each of the dual world but not interactions between the dual-world. Indeed, the reason that no external object can move faster than the speed of light and it gets heavier and heavier as its speed approach the speed of light is due to its increased quantum entanglement with the internal world through its counterpart the internal object.

My prespacetime model may be more completely understood by reference to the following detailed description considered in connection with the accompanying drawings. However, it should be understood that the drawings are designed for purposes of illustration only and not as a definition of the limits of the invention.

### BRIEF DESCRIPTION OF THE DRAWINGS

FIG. 1 is a schematic view of the primordial phase distinction according to the prespacetime model producing an external and internal phase distinction in the prespacetime.

FIG. 2 is a schematic view of a matrix equation according to the prespacetime model illustrating a relationship among the external object, the internal object and the self-acting and self-referential Matrix Rule.

FIG. 3 is another schematic view of the matrix equation according to the prespacetime model illustrating self-interaction between the external and internal object of an entity/particle through the Matrix Rule.

FIG. 4 is a schematic view of interactions and relationships of a first entity or particle and a second entity or particle in the dual-world according to the prespacetime model.

FIG. 5 is a schematic view of interactions and relationships of a first entity and a second biological entity such as a human brain in the dual-world according to the prespacetime model.

FIG. 6 is a schematic and mathematical view of self-referential hierarchical spin processes for creating elementary entities/particles according to the prespacetime model.

FIG. 7 to FIG. 17 is schematic and mathematical views of metamorphous self-referential spin processes generating different forms of the Matrix Rule according to the prespacetime model.

FIG. 18 to FIG. 34 is schematic and mathematical views of metamorphous self-referential hierarchical spin processes for creating, sustaining and causing evolution of elementary entities/particles according to the prespacetime model.

FIG. 35 to FIG. 38 is schematic and mathematical views of the metamorphous self-referential hierarchical spin processes for creating, sustaining and causing evolution of composite entities/particles such as a neutron and a proton according to the prespacetime model.

FIG. 39 and FIG. 42 are schematic and mathematical views of metamorphous determinant views (equations) of the elementary entities/particles according to the prespacetime model.

FIG. 43 is schematic and mathematical views of meanings of a Schrodinger equation and a quantum potential according to the prespacetime model.

FIG. 44 is schematic and mathematical views of a third state of matter according to the prespacetime model.

FIG. 45 to FIG. 48 is schematic and mathematical views of the weak interactions according to the prespacetime model.

FIG. 49 to FIG. 52 is schematic and mathematical views of the electromagnetic interactions and different forms of Maxwell equations according to the prespacetime model.

FIG. 53 to FIG. 56 is schematic and mathematical views of the strong interactions and spatial self-confinement processes according to the prespacetime model.

FIG. 57 to FIG. 61 is schematic and mathematical views of different forms of the quantum entanglement (self-gravity) and the gravitational interactions between a first entity or particle and a second entity or particle according to the prespacetime model.

FIG. 62 and FIG. 63 are schematic and mathematical views of electromagnetic interactions involving nuclear and/or electronic spin in the brain associated with consciousness and brain function according to the prespacetime model.

### DETAILED DESCRIPTION OF THE INVENTION

The detailed description of the prespacetime model is organized into 10 sections.

### I. Overall Scheme of the Prespacetime Model

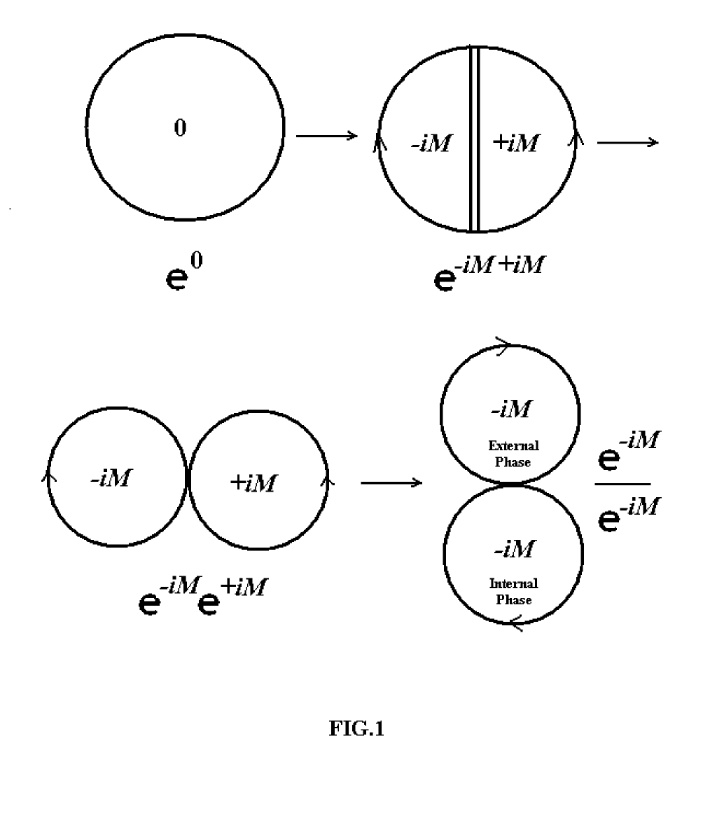

FIG. 1 to FIG. 5 illustrates an overall scheme of the prespacetime model including: (1) occurrence of a primordial phase distinction through imagination i of the prespacetime, (2) matrixing of the prespacetime into the external and internal wave functions respectively as the external and internal objects of a first entity or particle in the dual world or interaction fields for interacting with a second entity or particles, (3) governance of the external and internal wave functions by the self-acting and self-referential Matrix Rule which accompanies the imagination i of the prespacetime so as to enforce the accounting principle of conservation of zero in the dual world, (4) relationships of a first entity and a second entity between themselves and with the external and internal world of the dual-world, and (5) relationships of a first entity and a second biological entity which is a brain and relationships of the said first entity and the brain with the external and internal world of the dual-world.

Considering first FIG. 1, the prespacetime model includes the occurrence of the primordial phase distinction in the mind of the prespacetime comprised of +M and −M through the imagination i of the prespacetime above the body of the prespacetime which can also be expressed as e⁰=e^{iM-iM}=e^{iM}e^{-iM}=e^{-iM}/e^{-iM}=e^{iM}/e^{iM}. In one particular embodiment, ±M=±(Et−p·r)/=±p^{μ}x_{μ}/.

The primordial phase distinction is accompanied by matrixing of the prespacetime into the external and internal wave functions respectively as the external and internal objects of a first entity or particle in the dual world or interaction fields for interacting with a second entity or particles.

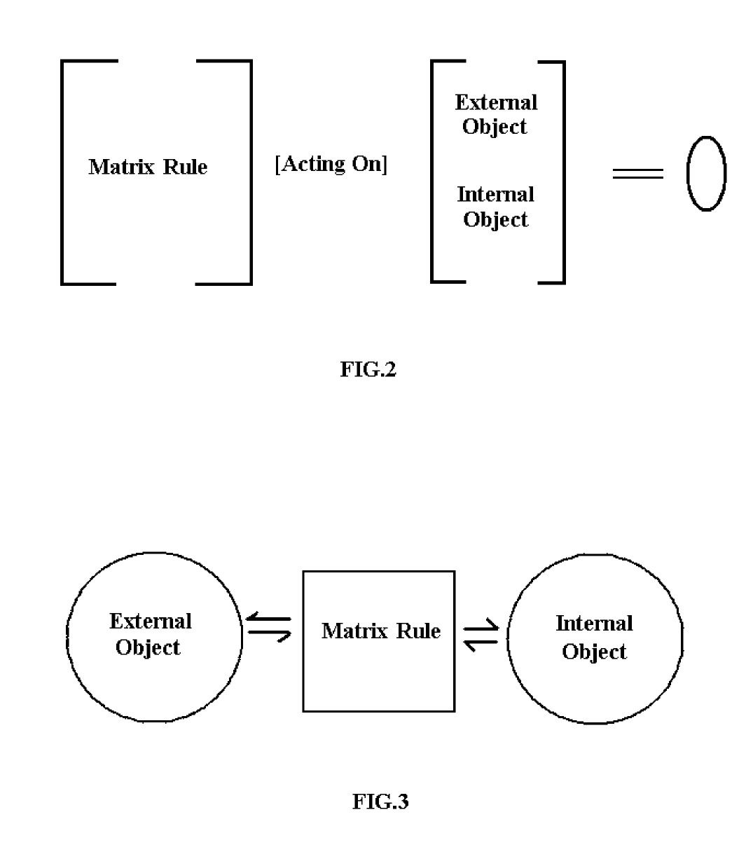

Considering FIG. 2, the prespacetime model includes the external and internal objects, the governance of the external and internal objects by the self-acting and self-referential Matrix to enforce the accounting principle of conservation of zero in the dual world.

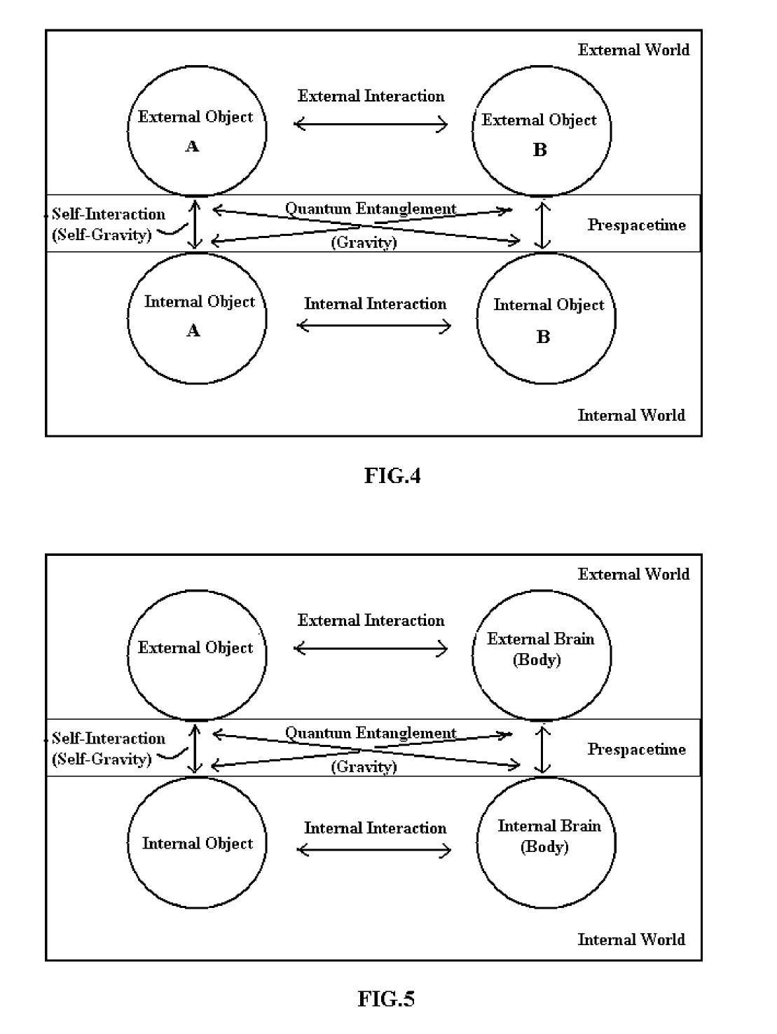

Considering FIG. 3, the prespacetime model includes the self-interaction between the external and internal object of an entity or particle through the Matrix Rule.

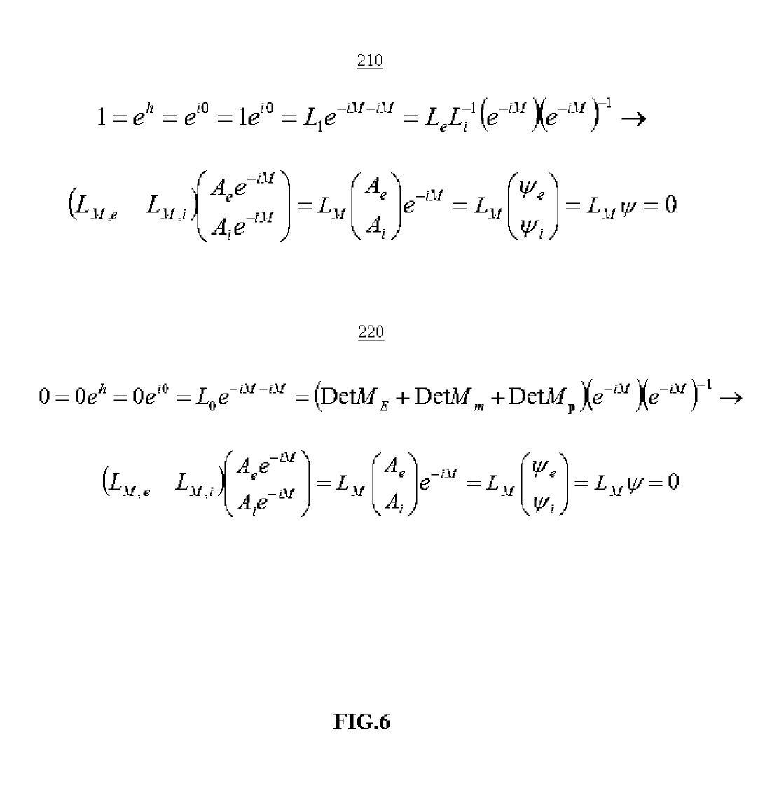

Considering FIG. 4, the prespacetime model includes the relationships of a first entity and a second entity between themselves and with the external and internal world of the dual-world.

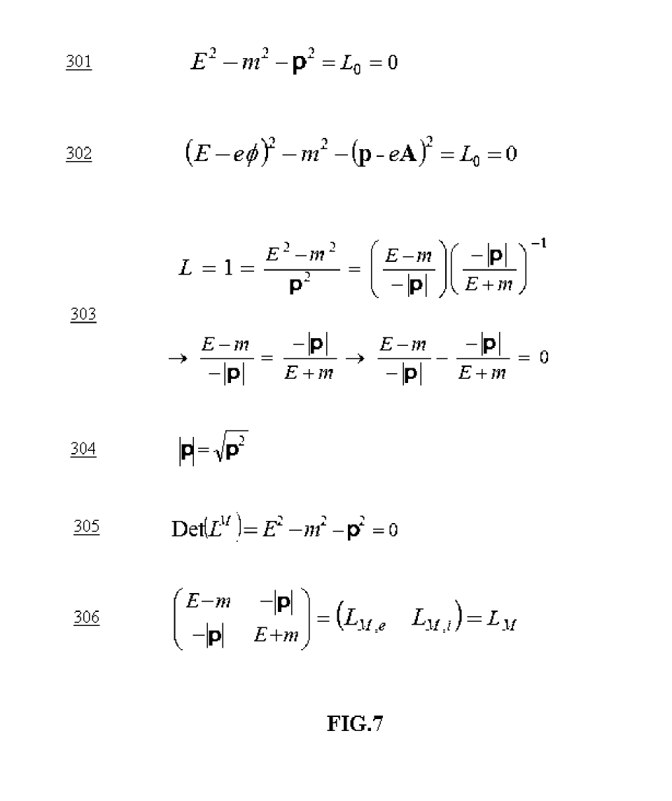

Considering FIG. 5, the prespacetime model includes the relationships of a first entity and a second biological entity such as a brain and relationships of the said first entity and the brain with the external and internal world of the dual-world.

Therefore, as illustrated in FIG. 1 through FIG. 5, the prespacetime is comprised of a body mathematically represented by Euler number e and a mind represented by imaginary unit i above e. The body and mind of the prespacetime is grounds of all existence, can form external and internal wave functions as external and internal objects (with each pair forms an elementary entity or particle) and interaction fields between elementary entities which accompany the imaginations of the prespacetime. The body and mind can be self-acted on by the self-referential Matrix Rule L_{M} of the prespacetime. The prespacetime has imagining power i to project external and internal objects by projecting, for example, external and internal phase ±M=±(Et−p·x)/ above the body e.

The universe so created is a dual-world comprising of the external world to be observed and internal world as observed under each relativistic frame x^{μ}=(t, x). In one view, the internal world (which by convention may have either negative or positive energy) is the negation/image of the external world (which by convention may also have either positive or negative energy). According to the present model, an absolute frame of reference exists and the said frame is the body e of the prespacetime. Therefore, if the prespacetime stops imagining, the universe would disappear into materially nothingness eⁱ⁰=e⁰=1.

The prespacetime model provides for interactions of the external and internal worlds through quantum entanglement since I have experimentally demonstrated that gravity is the manifestation of quantum entanglement (Hu, H. P., & Wu, M. X. Evidence of non-local physical, chemical and biological effects supports quantum brain. Neuro-Quantology 4, 291-306 (2006); Hu, H. P., & Wu, M. X. Evidence of non-local chemical, thermal and gravitational effects. Progress in Physics v2, 17-21 (2007)).

The prespacetime model provides for interactions within the external world through classical and relativistic physical laws with light speed c as the speed limit of the external interactions and influences of the internal world on the external objects in the external world through as gravity macroscopically and quantum effects microscopically. Thus, according to the prespacetime model, the interactions within the external world and/or the internal world are local interactions and conform to special theory of relativity, but the interactions across the dual world are non-local interactions, that is, quantum entanglement or gravity.

Therefore, according to the present model, the meaning of the special theory of relativity is that the speed limit c is only applicable in each of the dual world but not interactions between the dual-world. Indeed, the reason that no external object can move faster than the speed of light and it gets heavier and heavier as its speed approach the speed of light is due to its increased quantum entanglement with the internal world through its counterpart the internal object.

### II. Genesis in a Nutshell

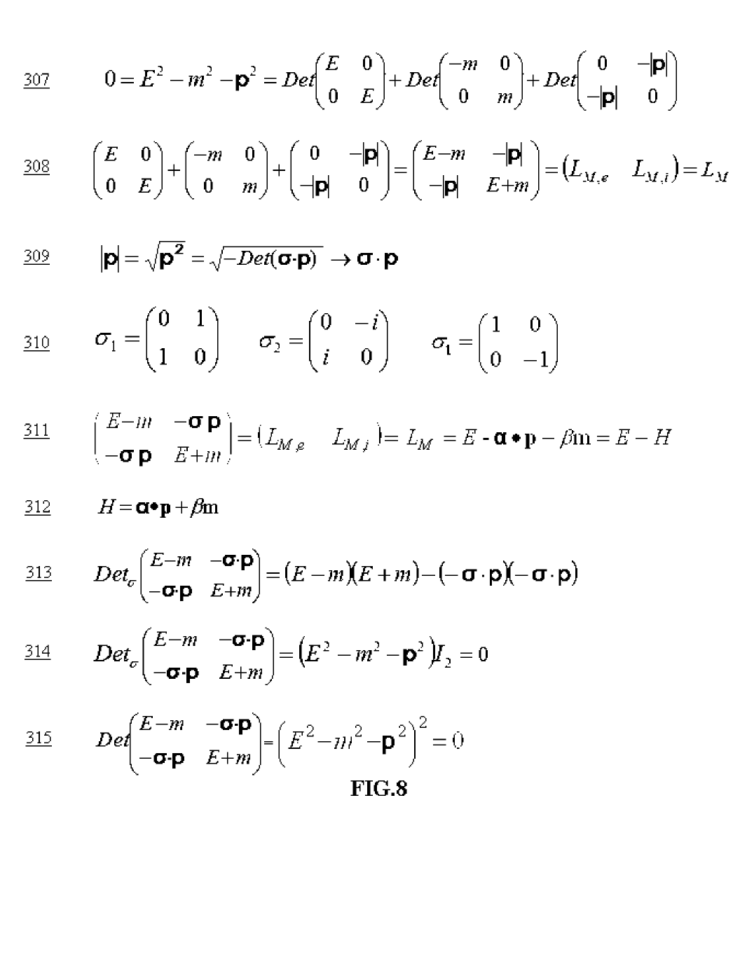

In the present model, the prespacetime is omnipotent, omnipresent and omniscient. The prespacetime creates, sustains and causes evolution of primordial entities or elementary particles within the prespacetime itself by self-referential hierarchical spin as shown in mathematical expression 210 of FIG. 6. in which e is Euler number representing the body (ether)) of the prespacetime, h above e represents the head of the prepsacetime, i is imaginary unit representing imagination of the prespacetime, ±M is content of imagination i, L₁=1 is Rule of One before matrixization, Lₑ is external rule, Lᵢ is internal rule, L_{M,e} is external matrix rule, and L_{M,i} is internal matrix rule, L_{M} is self-referential Matrix Rule comprised of the external and internal matrix rule which governs elementary entities and conserves zero, Aₑe^{-iM}=ψₑ is external wave function (external object), Aᵢe^{-iM}=ψᵢ is internal wave function (internal object) and ψ is the complete wave function (object/entity in the dual-world as a whole).

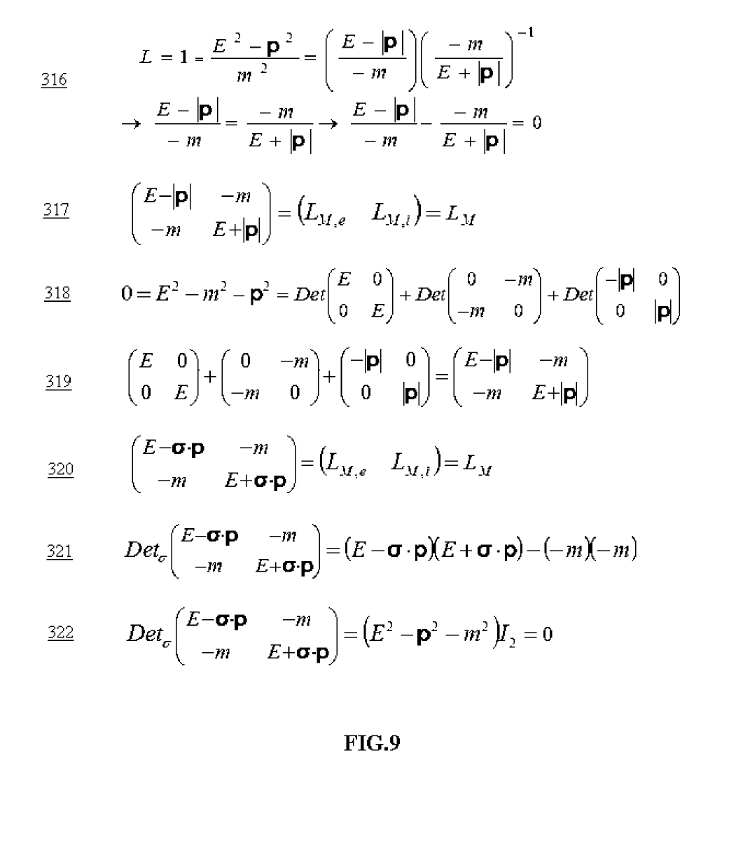

Alternatively, the prespacetime creates, sustains and causes evolution of primordial entities within the prespacetime itself by the self-referential hierarchical spin as shown in mathematical expression 220 of FIG. 6 in which L₀ is Rule of Zero as defined by fundamental relationship 301 of FIG. 7, Det means determinant and M_{E}, Mₘ and Mₚ are respectively matrices with ±E, ±m and ±|p| as elements and E², −m² and −p² as determinants.

The prespacetime spins as 1=eⁱ⁰=e^{iM-iM}=e^{iM}e^{-iM}=e^{-iM}/e^{-iM}=e^{iM}/e^{iM} before matrixization. The prespacetime also spins through the self-acting and self-referential Matrix Rule L_{M} after matrixization which acts on the external object and internal object to cause them to interact with each other as further described below.

The Matrix Rule L_{M} of the prespacetime is derived from the fundamental relationship 301 of FIG. 7 through self-reference within this relationship 301 which accompanies imagination i in the head of the prespacetime. For simplicity, light speed c is set to 1 (c=1) in 301 and, indeed, both the light speed c and Planck Constant will be set to 1 (c==1) through out this application unless it is indicated otherwise. The fundamental relationship 301 of FIG. 7 was discovered by Einstein.

In the presence of an interacting field such as an electromagnetic potential A^{μ}=(φ, A) of a first electrically charged entity or particle, the fundamental relationship 301 of FIG. 7 becomes mathematical expression 302 of FIG. 7 for a second electrically charged entity or particle with an electric charge e.

### III. Metamorphous Forms of the Matrix Rule

As one embodiment of the self-reference within the fundamental relationship 301 of FIG. 7, a first form of the Matrix Rule as shown in 306 of FIG. 7 is derived through a first step shown in mathematical expression 303 in which |p| is defined by 304, and a second step of matrixing left-land side of the last expression in 303 such that mathematical expression 305 holds in order to satisfy the fundamental expression 301 resulting in the first form 306.

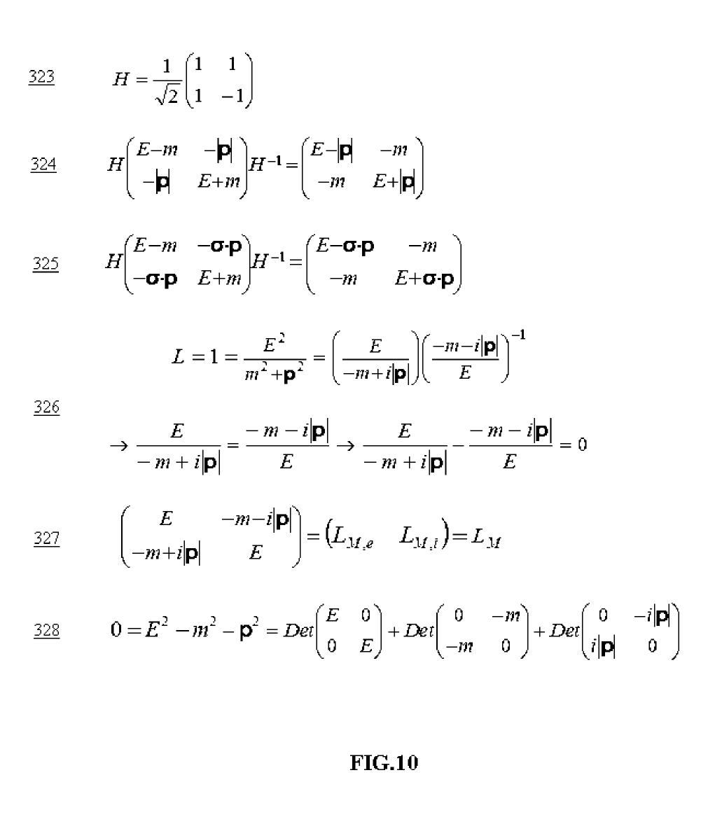

As a second embodiment of the self-reference within the fundamental relationship 301 of FIG. 7, the first form 306 of FIG. 7 can also be derived by the steps of a self-reference as in 307 of FIG. 8 and a matrixing as in 308 of FIG. 8 in which determinant sign Det is removed.

After a fermionic form of spinization as defined in 309 of FIG. 8 where σ=(σ₁, σ₂, σ₃) are Pauli matrices as defined in 310 of FIG. 8, the first form of the Matrix Rule as shown in 306 of FIG. 7 transforms into a second form of the Matrix Rule as shown in 311 of FIG. 8 in which α=(α₁, α₂, α₃) and β are Dirac matrices and H as defined in 312 is the Dirac Hamiltonian. The second form of the Matrix Rule 311 governs fermions in Dirac form such as Dirac electron and positron. On the other hand, the first form of the Matrix Rule 306 governs a third state of matter, that is, an unspinized (spinless) entity/particle with the electric charge e and a mass m such as a meson or a meson-like particle. A bosonic form of spinization shall be illustrated later.

Defining a determinant view shown 313 of FIG. 8, a relationship shown in 314 can be derived. Therefore, in the determinant view, the fundamental relationship 301 is also satisfied. Indeed, a conventional determinant shown in 315 is also obtained.

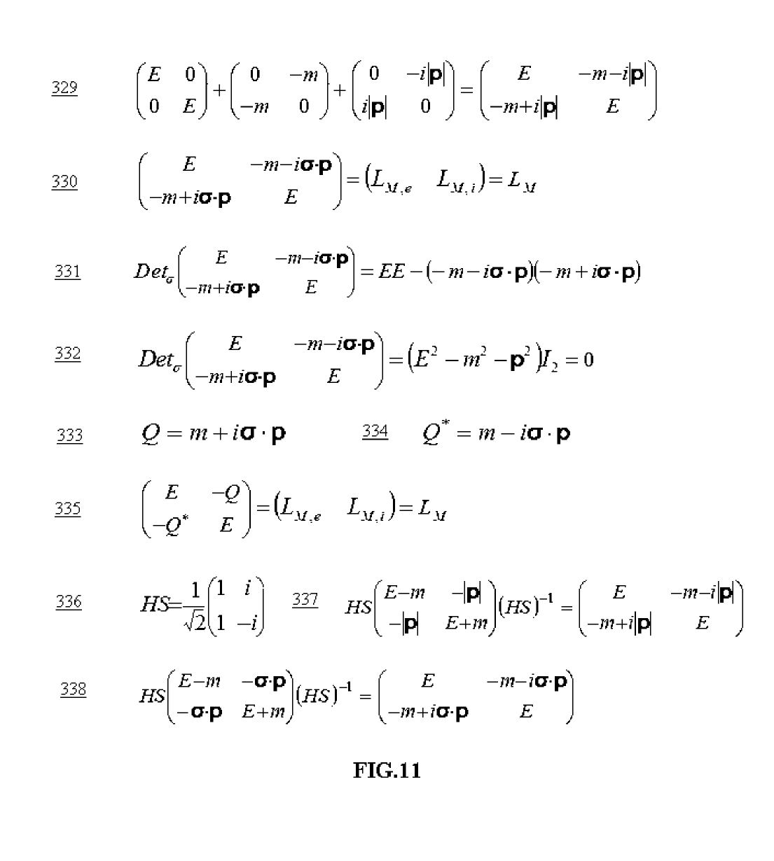

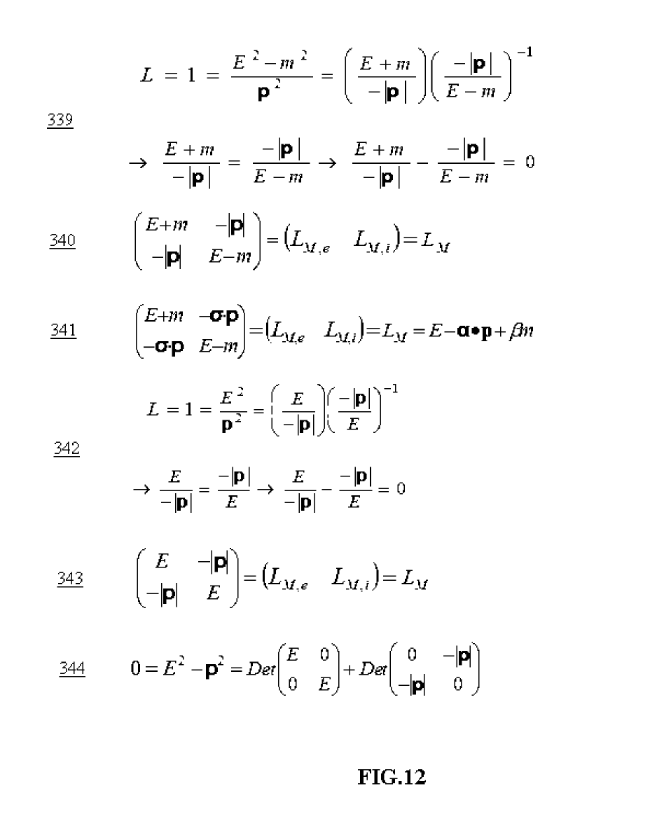

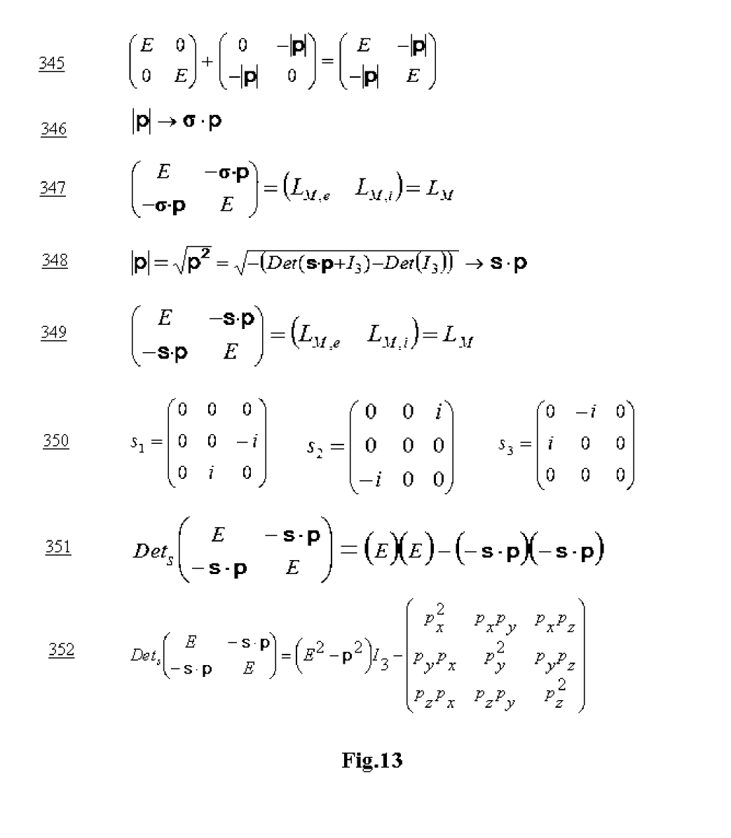

One kind of metamorphosis of mathematical expressions 303, 306, 307, 308, 311, 313 and 314 respectively is as 316, 317, 318, 319, 320, 321 and 322 of FIG. 9. 317 is a unspinized form of the Matrix Rule in Weyl (chiral) form and is connected to 306 by a transform defined in 324 in which H is Hadamard matrix defined in 323 of FIG. 10. 320 is a spinized form of the Matrix Rule in Weyl (chiral) form and is connected to 311 by a transform defined in 325 in which H is 4×4 Hadamard matrix.

A second kind of metamorphosis of mathematical expressions 303, 306, 307, 308, 311, 313 and 314 respectively is as 326, 327, 328, 329, 330, 331 and 332. Indeed, Q as defined in 333 is a quaternion and Q′ as defined in 334 is the conjugate of Q, Thus, 332 can be now rewritten as 335. 327 is a unspinized form of the Matrix Rule in a third form and is connected to 306 by a transform defined in 337 in which HS is a matrix defined in 336. 330 is a spinized form of the Matrix Rule in a third form and is connected to 311 by a transform defined in 338 in which HS is a 4×4 form of the matrix 336.

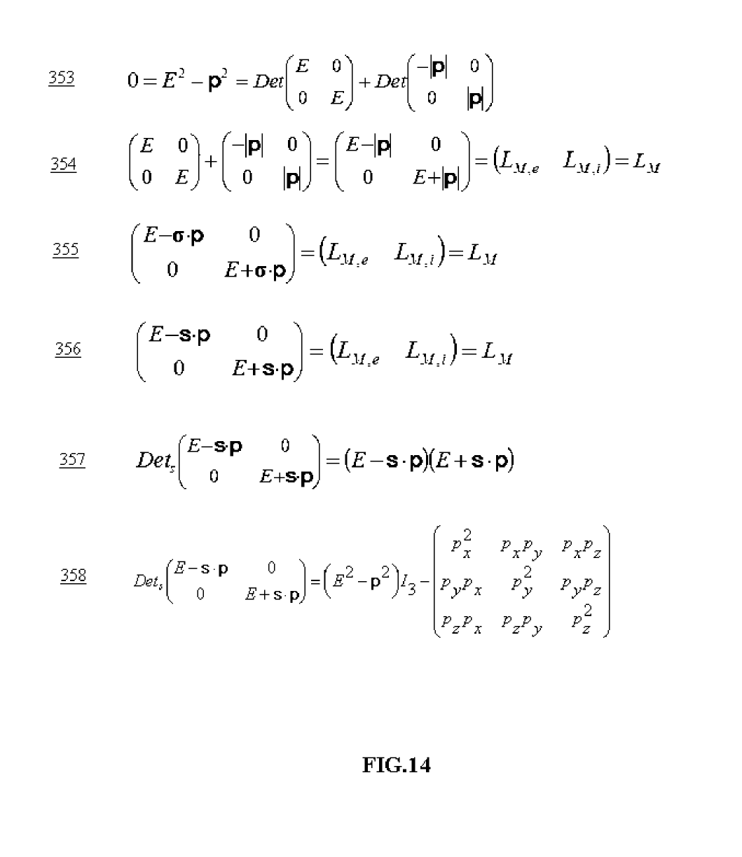

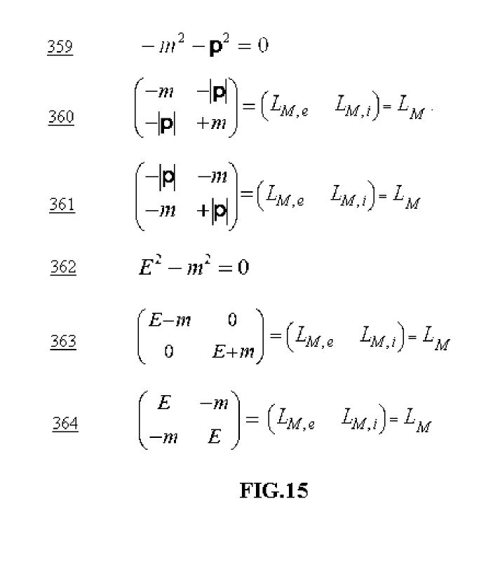

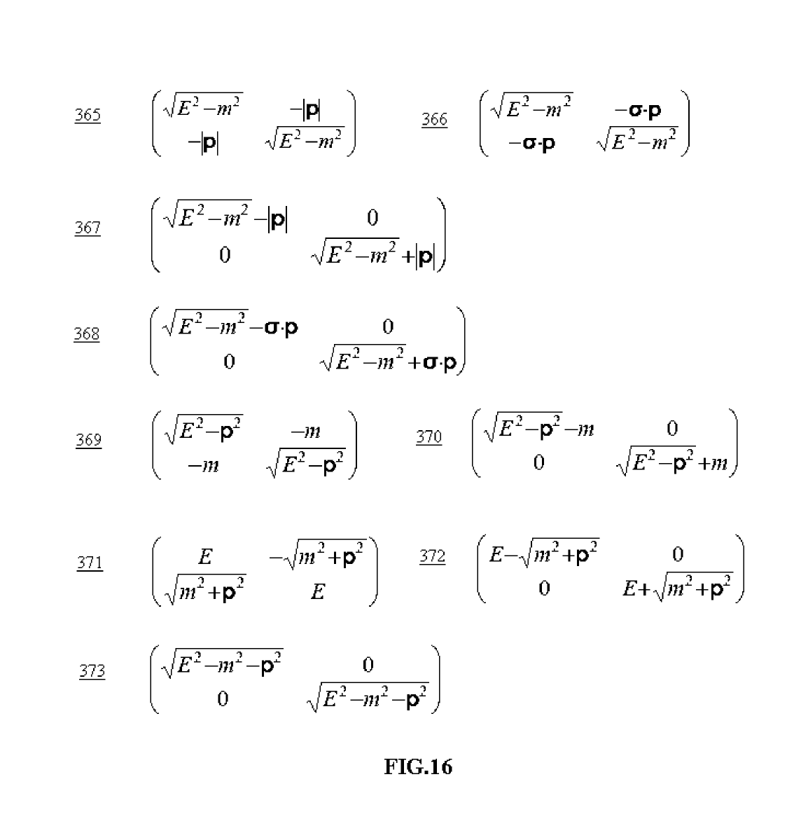

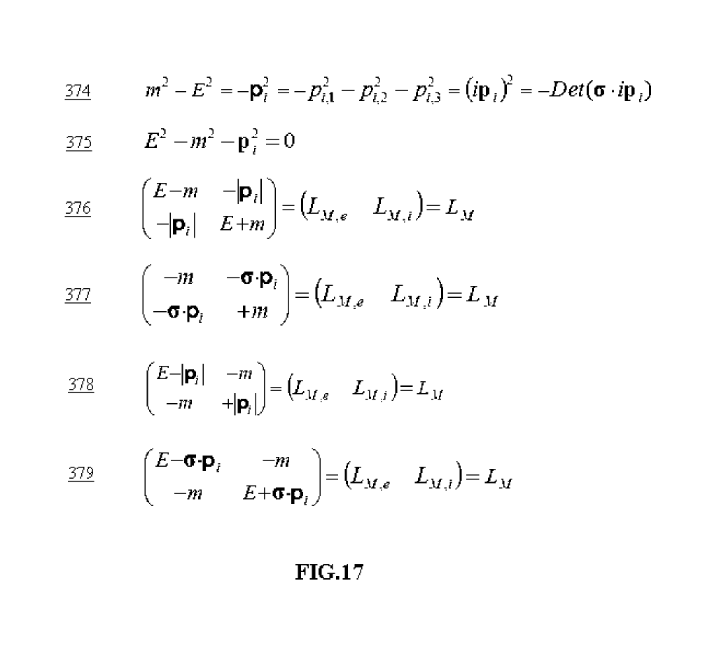

Yet a third kind of metamorphosis of mathematical expressions 303, 306 and 311 respectively is as 339, 340 and 341 of FIG. 12.

When m=0, mathematical expression 343, 343, 344 and 345 is respectively derived from 303, 306, 307 and 308. 343 governs massless particle with unobservable spin (spinless) in Dirac form. After a fermionic spinization 346, the unspinized form 343 of the Matrix Rule becomes a spinized form 347 of the Matrix Rule which governs a massless fermion in Dirac form. After a bosonic spinization 348, the unspinized form 343 of the Matrix Rule 343 becomes a spinized form 349 of the Matrix Rule which governs a massless boson in Dirac form.

In the spinized form 349, S=(S₁, S₂, S₃) as defined in 350 are spin operators for spin 1 particle. If a second form of the determinant view is defined by 351, a result shown in 352 is derived. To satisfy the fundamental relationship 301 in the form 351 of the determinant view, the last term in 352 acting on the external and internal wave functions respectively needs to produce null result (zero) in a source-free zone as discussed later.

Also when m=0, mathematical expression 353, 354 and 355 is respectively derived from 317, 319 and 320. 354 governs massless particle with unobservable spin (spinless) in Weyl form. After the fermionic spinization 346, the unspinized form 354 of the Matrix Rule becomes a spinized form 355 of the Matrix Rule which governs a massless fermion in Weyl form. After the bosonic spinization 348, the unspinized form 354 of the Matrix Rule becomes a spinized form 356 of the Matrix Rule which governs a massless boson in Weyl form.

If a third form of the determinant view is defined by 357, a result shown in 358 is derived. To satisfy the fundamental relationship 301 in the form 357 of the determinant view, the last term in 358 acting on the external and internal wave functions respectively needs to produce null result (zero) in the source-free zone as discussed later.

When E=0, 359 results from the fundamental relation 301. Thus if timeless forms of Matrix Rule are allowed in the prespacetime, 360 and 361 is respectively derived from 306 and 317. Both 360 and 361 further degenerate when m=0. Further, when |p|=0, 362 results from the fundamental relation 301. Thus if spaceless forms of Matrix Rule are allowed in the prespacetime, 363 and 364 is respectively derived from 306 and 317. The significance of the forms of Matrix Rule in this Paragraph shall be made clear later. At this moment, it is suggested that the timeless forms of Matrix Rule govern the external and internal wave functions (self-fields) which play roles of timeless gravitons, that is, they mediate time-independent interactions through space (momentum) quantum entanglement. On the other hand, the spaceless forms of Matrix rules govern the external and internal wave functions (self-fields) which play roles of spaceless gravitons, that is, they mediate space (distance) independent interactions through proper time (mass) entanglement.

The above various forms of the self-acting and self-referential Matrix Rule are derived from one-tier matrixization (self-reference) and two-tier matrixization (self-reference) based on the fundamental relationship 301. The first-tier matrixization makes distinctions in time (energy), proper time (mass) and undifferentiated space (total momentum) which involve scalar unit 1 and imaginary unit (spin) i. Then the second-tier matrixization makes distinction in three-dimensional space (three-dimensional momentum) based on spin σ, s or other spin structure if it exists.

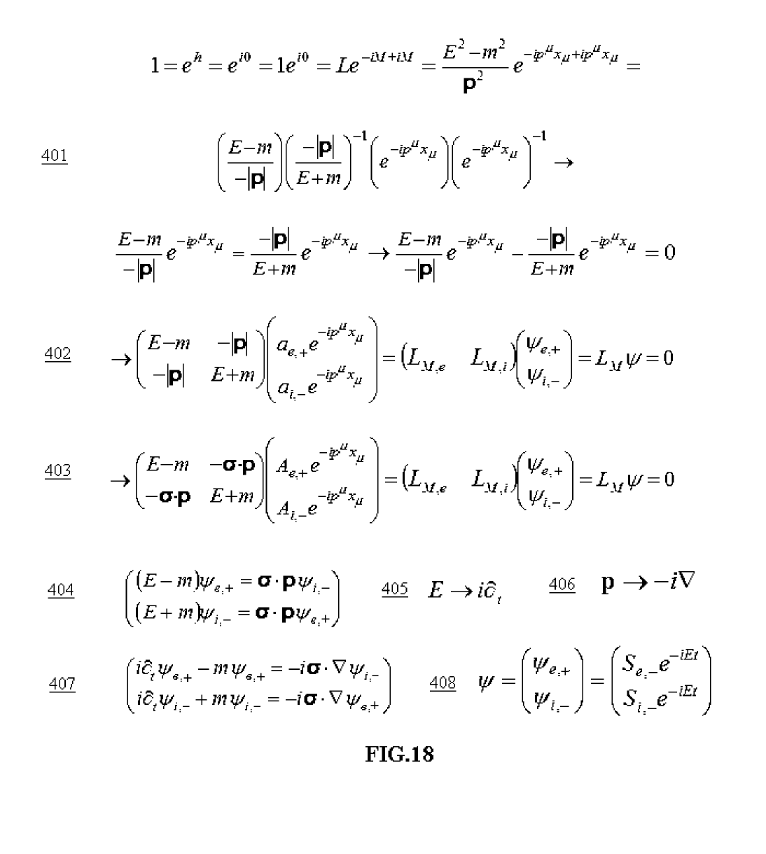

If partial distinction within the first-tier self-referential matrixization is allowed in the prespacetime, additional forms of Matrix Rule shown as 365 to 373 of FIG. 16 are derived, for example.

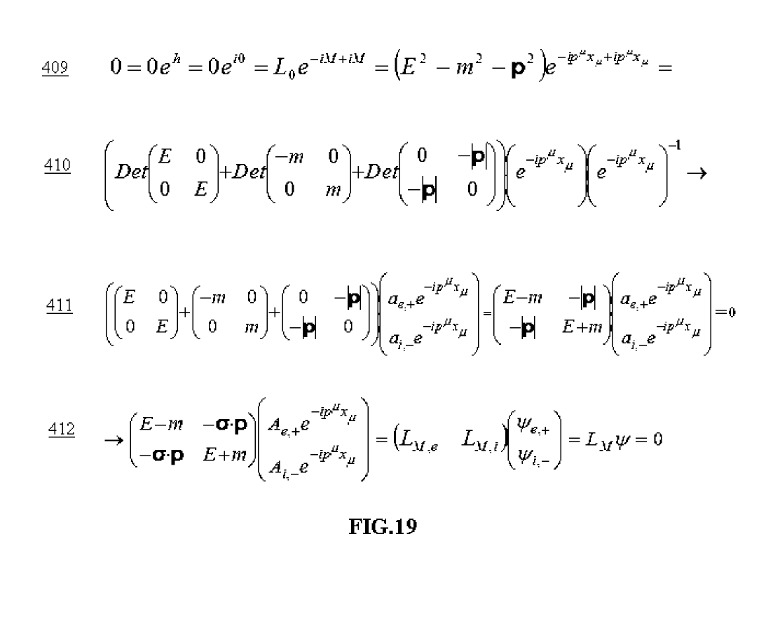

If a spatial self-confinement of an elementary entity/particle through imaginary momentum pᵢ (downward self-reference) such that m²>E² is allowed in the prespacetime, a new fundamental relationship 374 or 375 of FIG. 17 is derived from the fundamental relationship 301 of FIG. 7. Therefore, allowing the imaginary momentum (downward self-reference) in the prespacement for the elementary entity, new Dirac-like forms of Matrix Rule shown in 376 and 377 and new Weyl-like forms of Matrix Rule shown in 378 and 379 are derived. Bosonic versions of 377 and 379 are obtained by replacing σ with s.

It is likely that the above additional forms of self-referential Matrix Rule 365 to 373 and 376 to 379 govern different particles in the particle zoo as discussed later.

### VI. Genesis of Elementary Entities/Particles

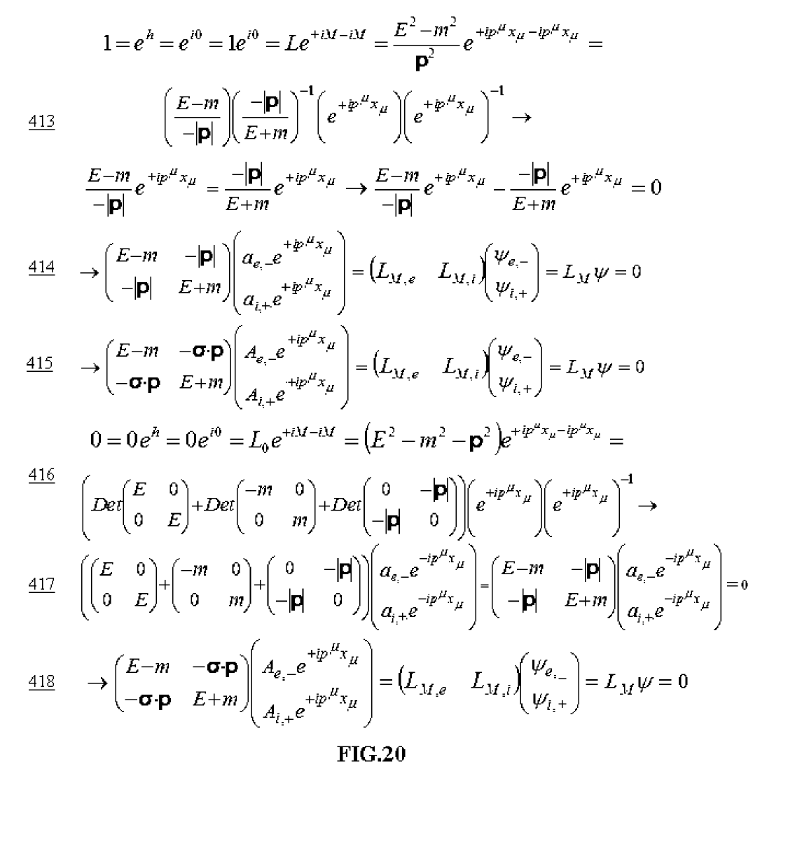

In one embodiment, a free plane-wave fermion such as an electron in Dirac form is created, sustained and caused to evolve in the prespacetime as shown mathematical expressions 401, 402 and 403 of FIG. 18. A different expression of 403 is shown in 404. After substitutions 405 and 406 such that actions of each element in the Matrix Rule on the external and internal wave functions can be explicitly shown, yet a third expression of 403 is derived as shown in 407. Equation 403 also has a free spherical wave solution in the form shown in 408.

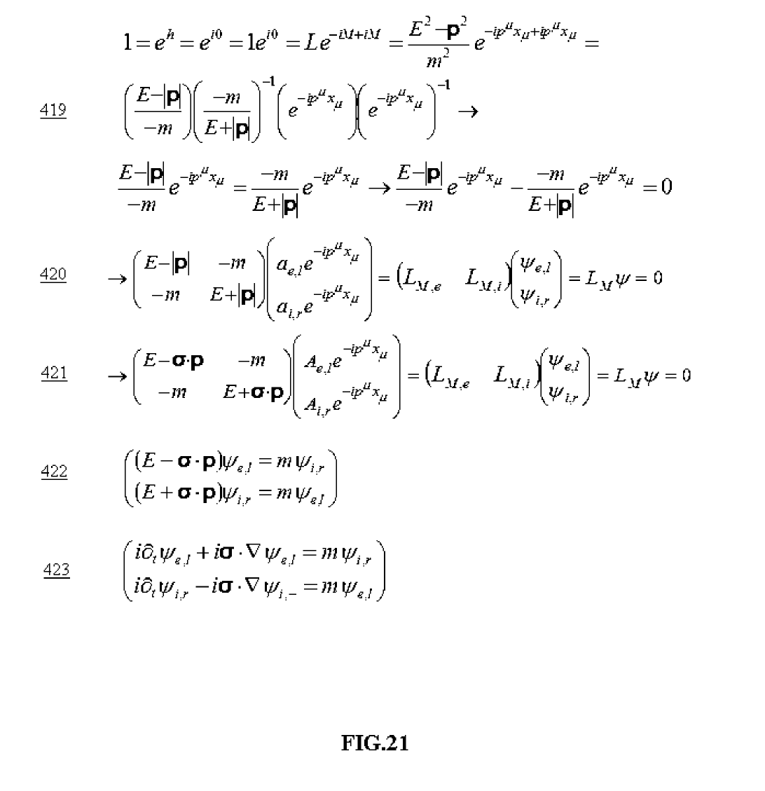

In another embodiment, the free plane-wave fermion such as the electron in Dirac form is created, sustained and caused to evolve in the prespacetime as shown in mathematical expressions 409, 410, 411 and 412 of FIG. 19.

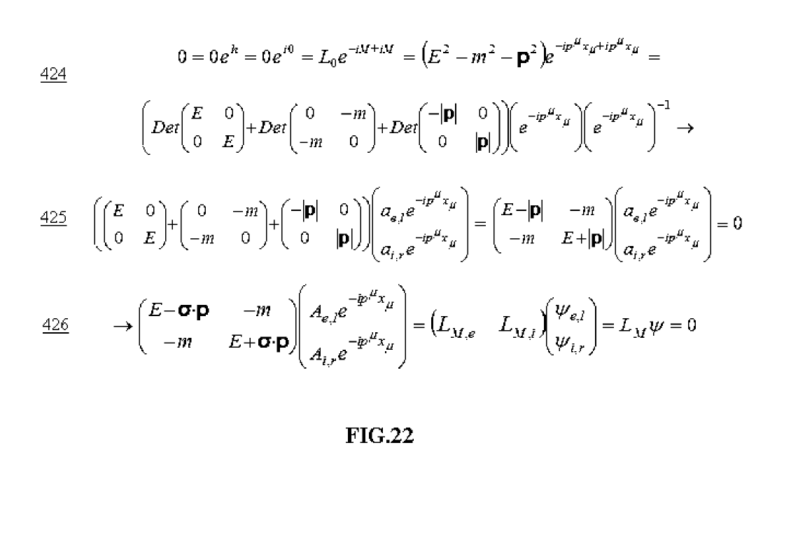

In a 3^{rd} embodiment, a free plane-wave antifermion such as a positron in Dirac form is created, sustained and caused to evolve in the prespacetime as shown mathematical expressions 413, 414 and 415 of FIG. 20.

In a 4^{th} embodiment, the free plane-wave antifermion such as the positron in Dirac form is created, sustained and caused to evolve in the prespacetime as shown in mathematical expressions 416, 417 and 418 of FIG. 20.

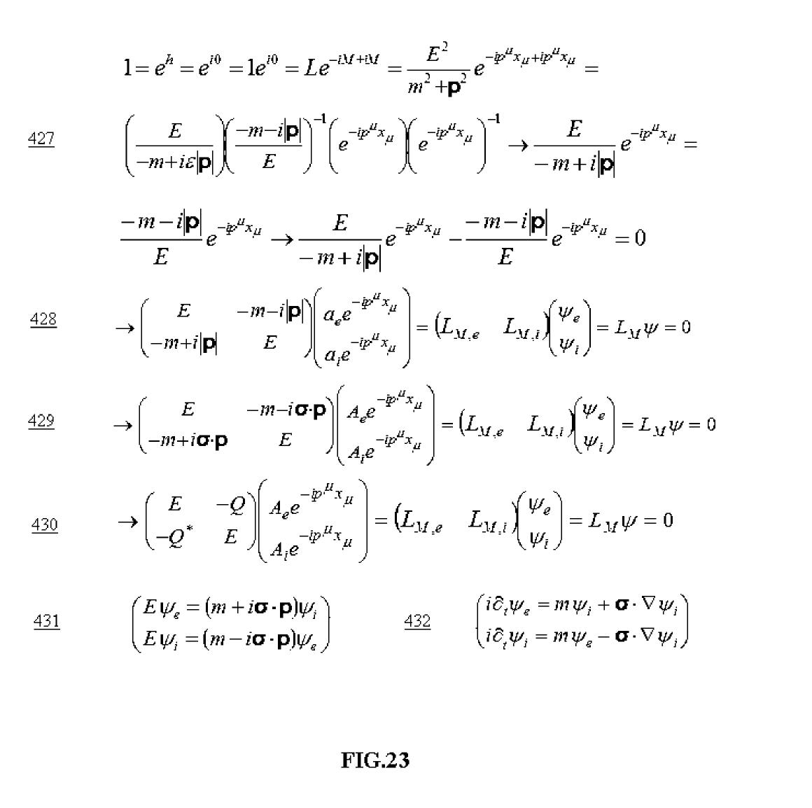

In a 5^{th} embodiment, a free plane-wave fermion such as an electron in Weyl (chiral) form is created, sustained and caused to evolve in the prespacetime as shown mathematical expressions 419, 420 and 421 of FIG. 21. A different expression of 421 is shown in 422. After substitutions 405 and 406 such that actions of each element in the Matrix Rule on the external and internal wave functions can be explicitly shown, yet a third expression of 421 is derived as shown in 423. Equation 421 also has a free spherical wave solution.

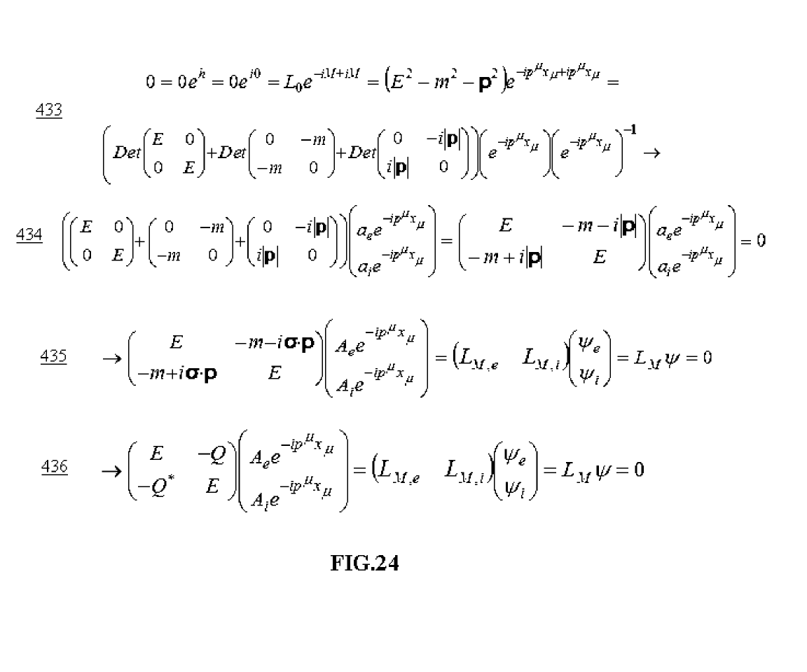

In a 6^{th} embodiment, the free plane-wave fermion such as the electron in Weyl (chiral) form is created, sustained and caused to evolve in the prespacetime as shown in mathematical expressions 424, 425 and 426 of FIG. 22.

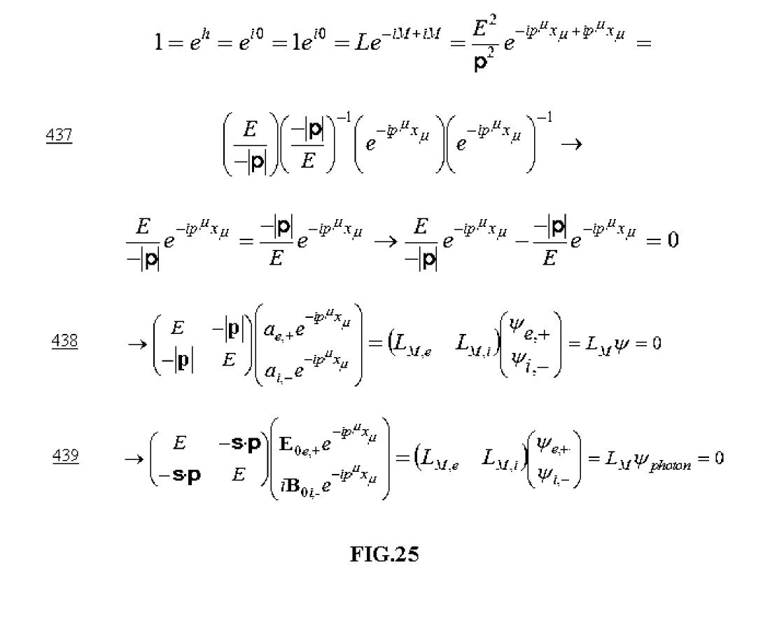

In a 7^{th} embodiment, a free plane-wave fermion such as an electron in a 3^{rd} form is created, sustained and caused to evolve in the prespacetime as shown mathematical expressions 427, 428, 430 and 429 of FIG. 23. A different expression of 429 is shown in 431. After substitutions 405 and 406 such that actions of each element in the Matrix Rule on the external and internal wave functions can be explicitly shown, yet a third expression of 429 is derived as shown in 432.

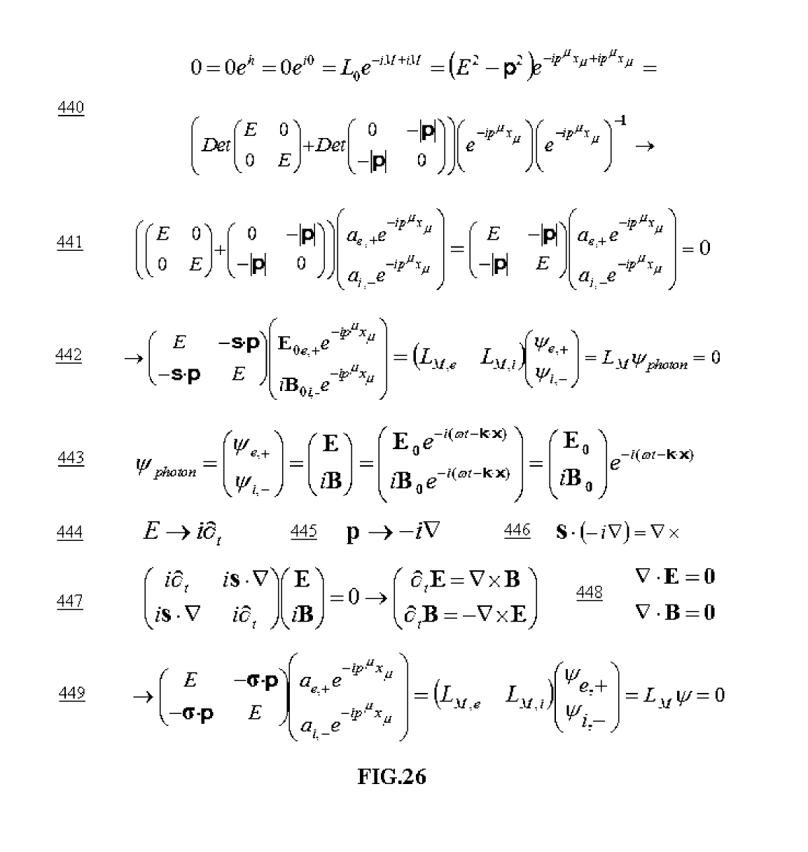

In a 8^{th} embodiment, the free plane-wave fermion such as the electron in the third form is created, sustained and caused to evolve in the prespacetime as shown in mathematical expressions 433, 434, 435 and 436 of FIG. 24.

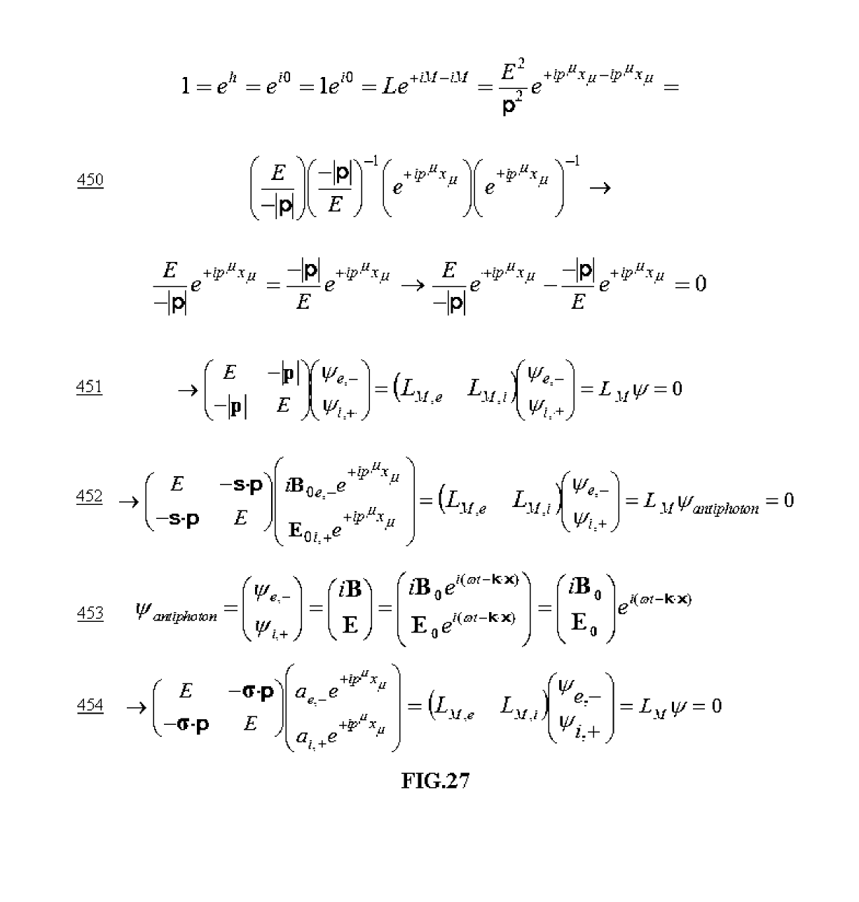

In a 9^{th} embodiment, a linear plane-wave photon is created, sustained and caused to evolve in the prespacetime as shown mathematical expressions 437, 438 and 439 of FIG. 25.

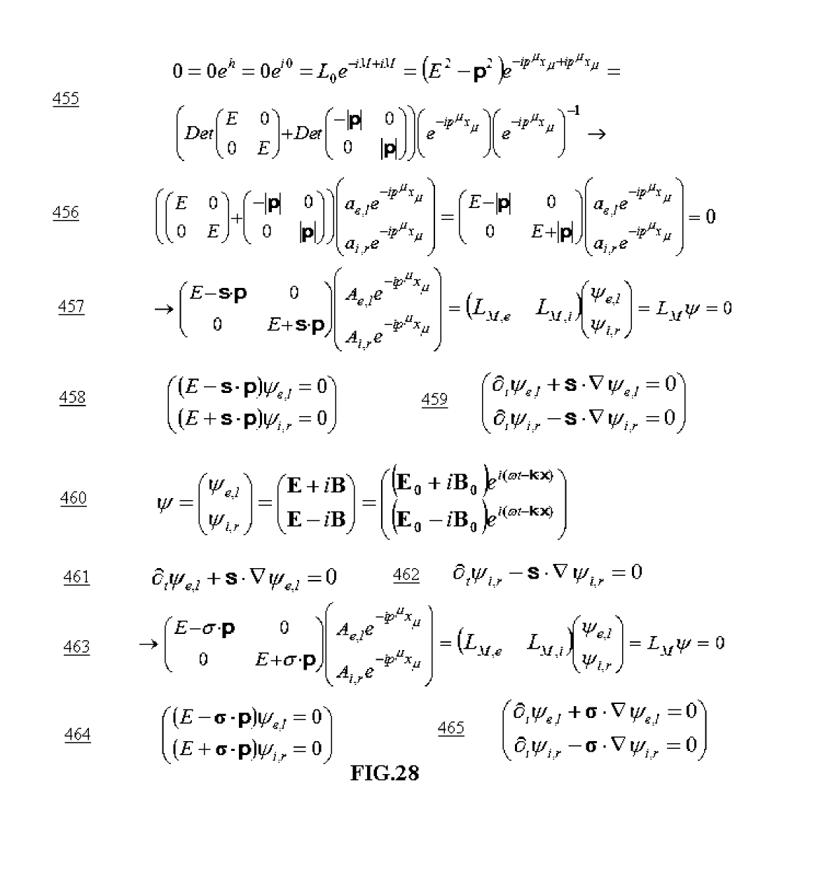

In a 10^{th} embodiment, the linear plane-wave photon is created, sustained and caused to evolve in the prespacetime as shown in mathematical expressions 440, 441 and 442 of FIG. 26. The linear plane-wave photon has a wave function as shown in 443. After substitutions 444 and 445 such that actions of each element in the Matrix Rule on the external and internal wave functions can be explicitly shown, two of the Maxwell equations in a vacuum are derived as shown in 447 by utilizing a relation shown in 446. These two equations together with equations (or source-free conditions) in 448 form a complete set of the Maxwell equations in the source-free zone.

In a 11^{th} embodiment, a free plane-wave massless neutrino in Dirac form is created, sustained and caused to evolve in the prespacetime by replacing the bosonic spinization shown in 439 or 442 with the fermionic spinization shown in 449.

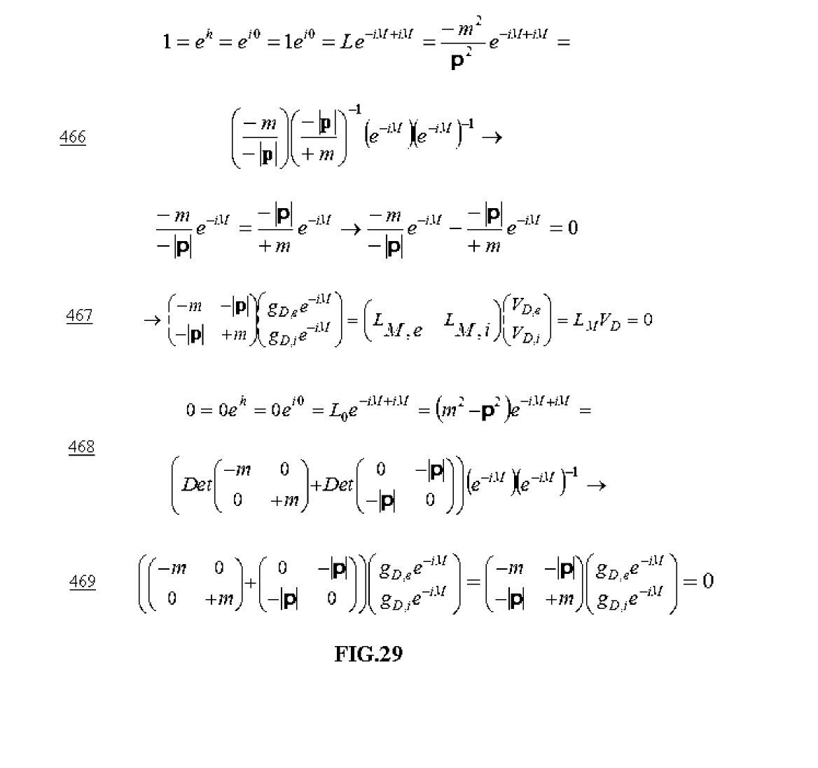

In a 12^{th} embodiment, a linear plane-wave antiphoton is created, sustained and caused to evolve in the prespacetime as shown mathematical expressions 450, 451 and 452 of FIG. 27. The linear plane-wave antiphoton has a wave function as shown in 453.

In a 13^{th} embodiment, a free plane-wave massless antineutrino in Dirac form is created, sustained and caused to evolve in the prespacetime by replacing the bosonic spinization shown in 452 with the fermionic spinization shown in 454.

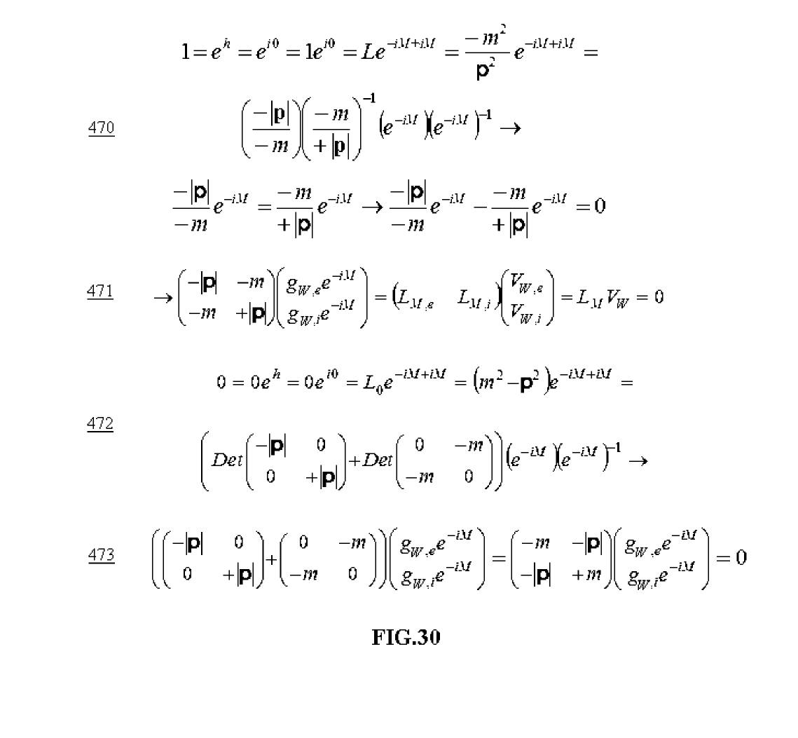

In a 14^{th} embodiment, chiral plane-wave photons are created, sustained and caused to evolve in the prespacetime as shown mathematical expressions 455, 456 and 457 of FIG. 28. Thus, left-handed external wave function ψ_{e,l} is decoupled from right-handed internal wave function ψ_{i,r}. A different expression of 457 is shown in 458. After substitutions 444 and 445 such that actions of each element in the Matrix Rule on the external and internal wave functions can be explicitly shown, yet a third expression of 457 is derived as shown in 459 which is comprised of two equations with one governing the left-handed external photon wave function and another governing the right-handed internal photon wave function as shown in 461 and 462 respectively. Equation 459 has a decoupled left- and right-handed plane wave solutions shown in 460. The Maxwell equations in 447 can be derived from either 461 or 462.

In a 15^{th} embodiment, chiral plane-wave massless neutrinos are created, sustained and caused to evolve in the prespacetime by replacing the bosonic spinization shown in 457 with the fermionic spinization shown in 463. A different expression of 463 is given in 464. After substitutions 444 and 445 such that actions of each element in the Matrix Rule on the external and internal wave functions can be explicitly shown, yet a third expression of 463 is derived as shown in 465 which is comprised of two equations with one governing the left-handed external neutrino wave function and another governing the right-handed internal neutrino wave function.

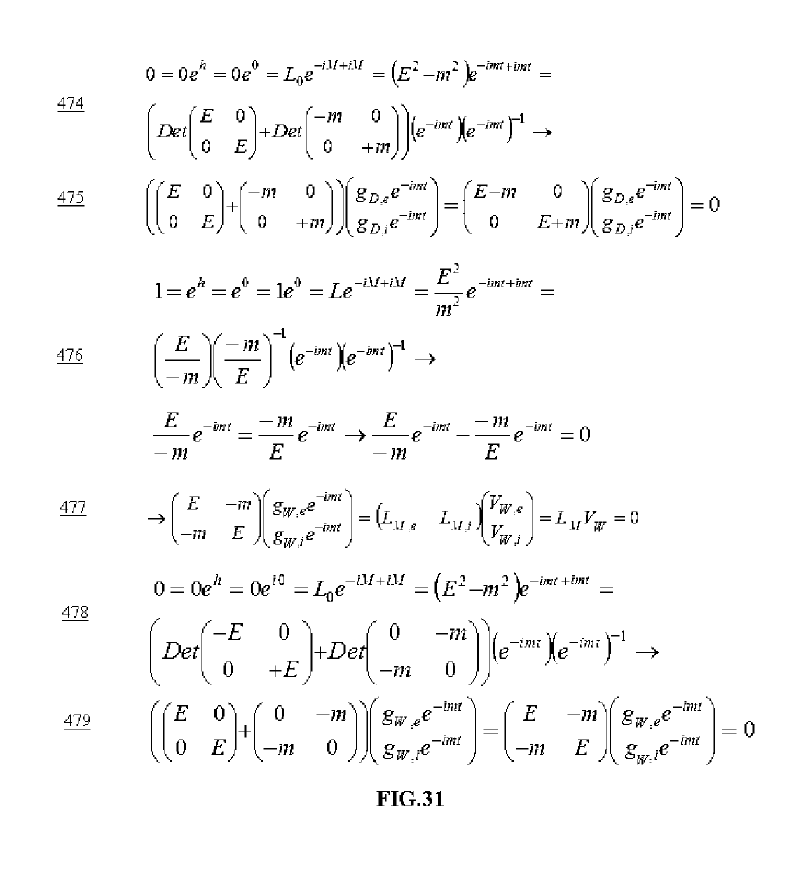

In a 16^{th} embodiment, a timeless wave function (instantaneous graviton) of a mass m in Dirac form is created, sustained and caused to evolve in the prespacetime as shown in mathematical expressions 466 and 467 of FIG. 29. Detail of imaginary content M in expression 467 will be determined later in this application.

In a 17^{th} embodiment, the timeless wave function (instantaneous graviton) of a mass m in Dirac form is created, sustained and caused to evolve in the prespacetime as shown in mathematical expressions 468 and 469 of FIG. 29.

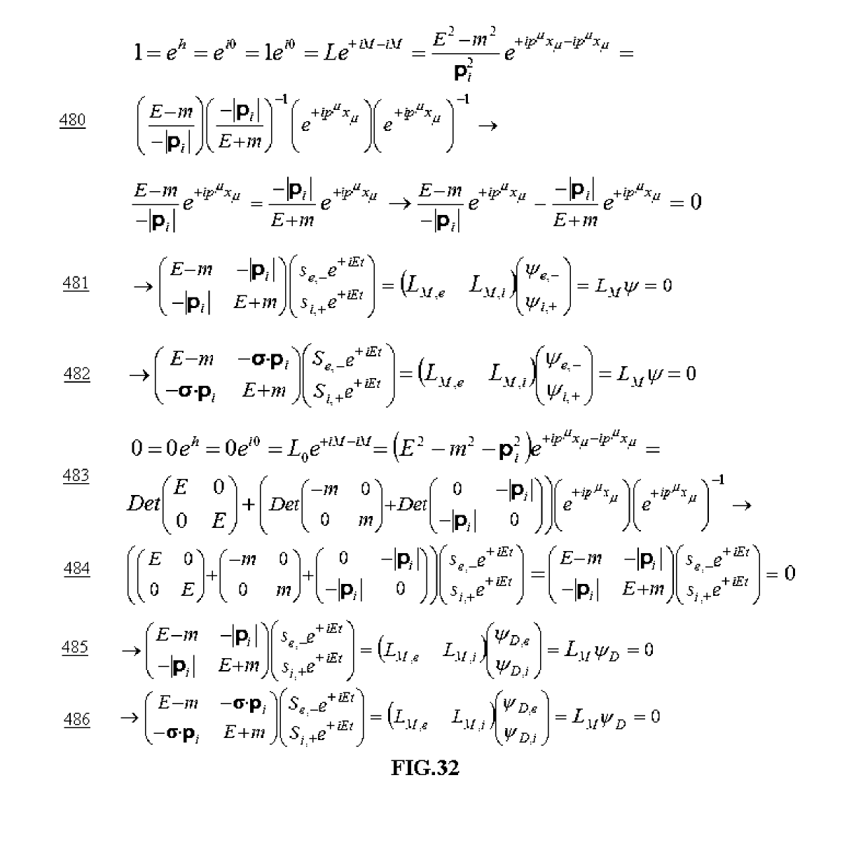

In a 18^{th} embodiment, a timeless wave function (instantaneous graviton) of a mass m in Weyl form is created, sustained and caused to evolve in the prespacetime as shown in mathematical expressions 470 and 471 of FIG. 30. Again, detail of imaginary content Min expression 471 will be determined later in this application.

In a 19^{th} embodiment, the timeless wave function (instantaneous graviton) of a mass m in Weyl form is created, sustained and caused to evolve in the prespacetime as shown mathematical expressions 472 and 473 of FIG. 30.

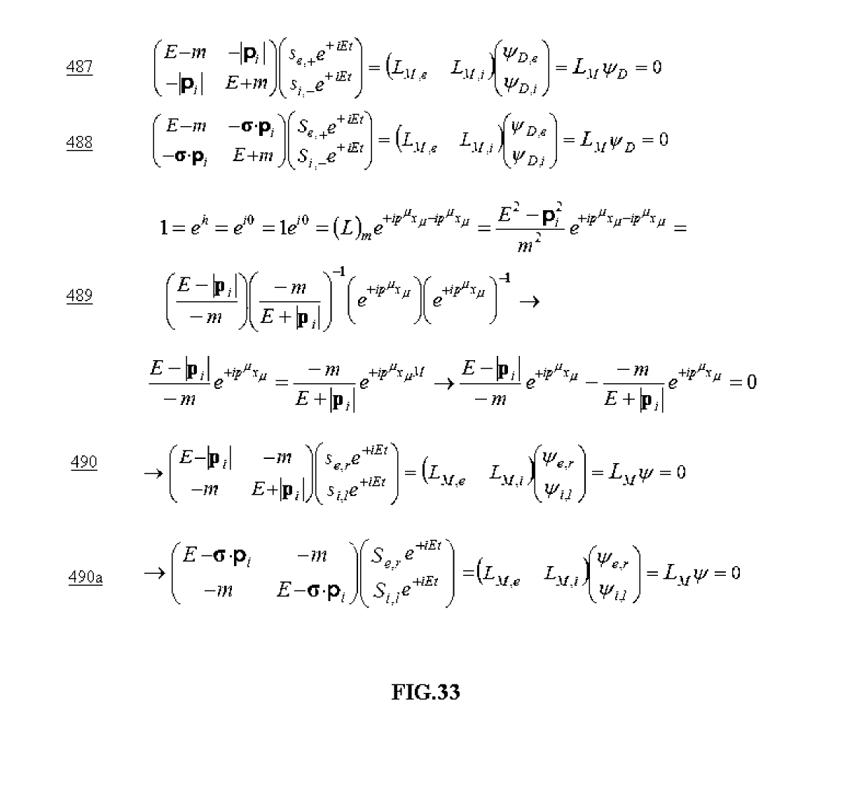

In a 20^{th} embodiment, a spaceless (distance independent) wave function (spaceless graviton) of a mass m in Dirac form is created, sustained and caused to evolve in the prespacetime as shown in mathematical expressions 474 and 475 of FIG. 31.

In a 21^{th} embodiment, a spaceless (distance independent) wave function (spaceless graviton) of a mass m in Weyl form is created, sustained and caused to evolve in the prespacetime as shown in mathematical expressions 476 and 477 of FIG. 31.

In a 22^{th} embodiment, the spaceless (distance independent) wave function (spaceless graviton) of the mass m in Weyl form is created, sustained and caused to evolution in the prespacetime as in shown mathematical expressions 478 and 479 of FIG. 31.

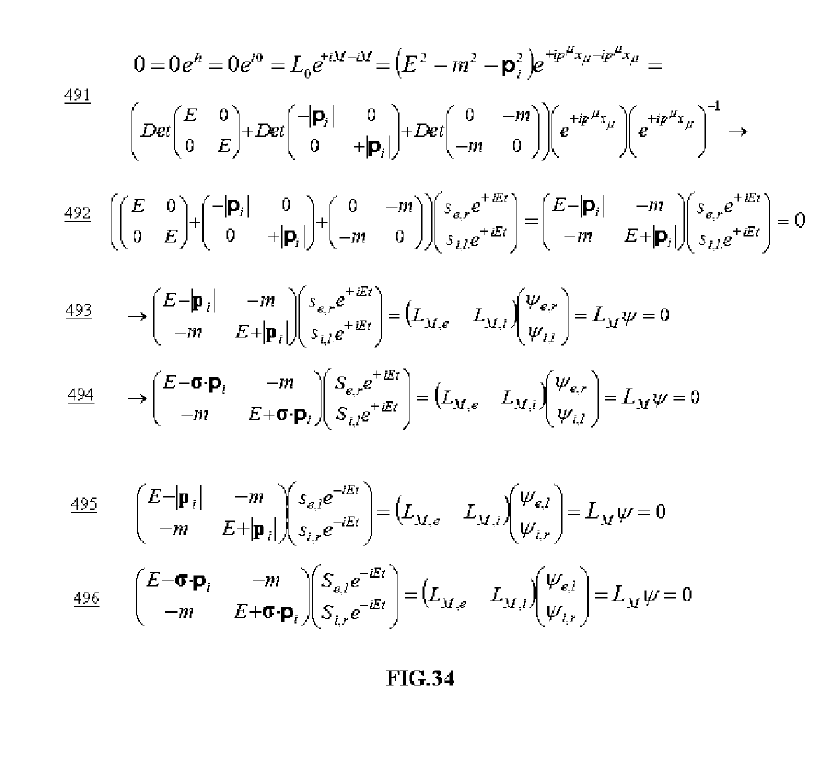

In a 23^{rd} embodiment, a spatially self-confined entity such as a proton in Dirac form is created, sustained and caused to evolve in the prespacetime through imaginary momentum pᵢ (downward self-reference) such that m²>E² as shown in mathematical expressions 480, 481 and 482 of FIG. 32. In the present model, equation 481 governs the spatial self-confinement of an unspinized proton in Dirac form through the imaginary momentum pᵢ and, on the other hand, equation 482 governs the spatial self-confinement of the spinized proton in Dirac form through the imaginary momentum pᵢ.

In a 24^{th} embodiment, the spatially self-confined entity such as the proton in Dirac form is created, sustained and caused to evolve in the prespacetime through the imaginary momentum pᵢ (downward self-reference) such that m²>E² as shown in mathematical expressions 483, 484, 485 and 486 of FIG. 32.

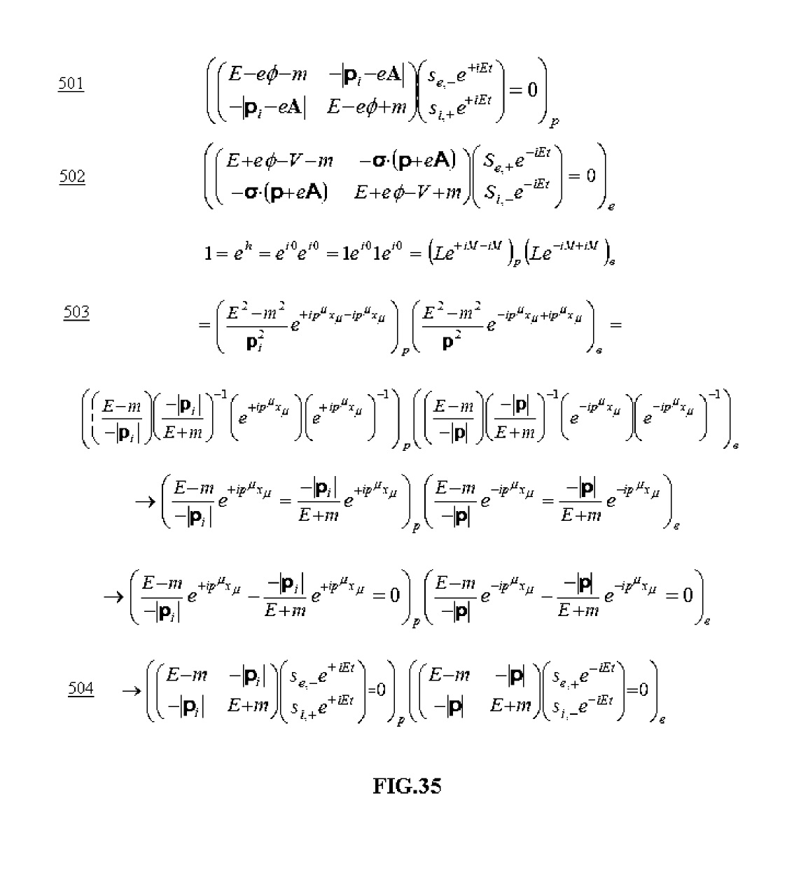

Thus, according to the present model, an unspinized antiproton and a spinized antiproton in Dirac form are respectively governed by equation 487 and 488 of FIG. 33.

In a 25^{th} embodiment, a spatially self-confined entity such as a proton in Weyl form is created, sustained and caused to evolve in the prespacetime through the imaginary momentum pᵢ (downward self-reference) such that m²>E² as shown in mathematical expressions 489, 490 and 490a of FIG. 33. In the present model, equation 490 governs the spatial self-confinement of an unspinized proton in Weyl form through the imaginary momentum pᵢ and, on the other hand, equation 490a governs the spatial self-confinement of the spinized proton in Weyl form through the imaginary momentum pᵢ.

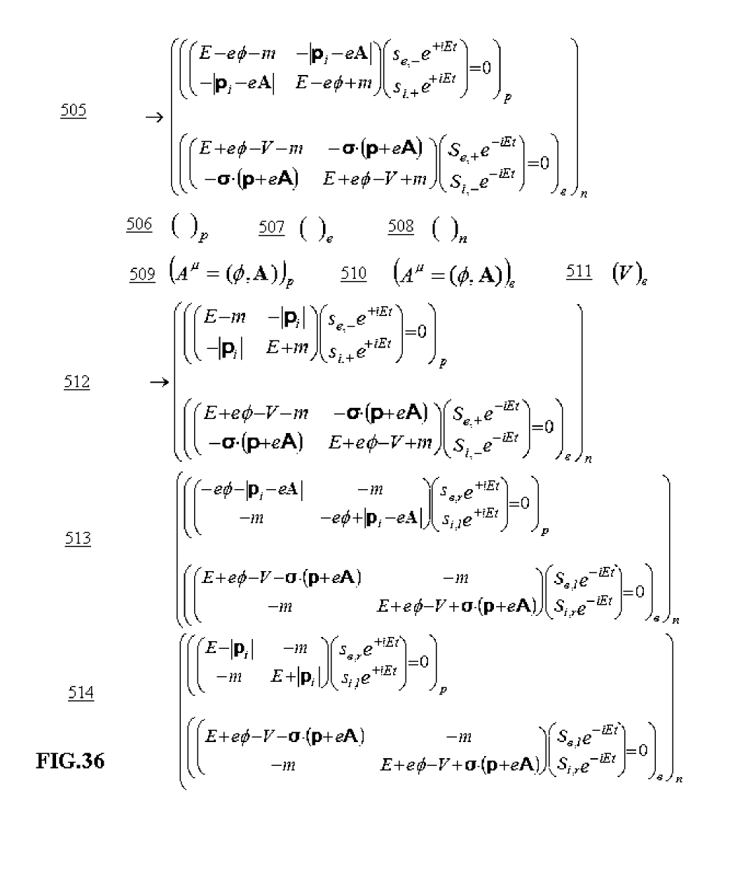

In a 26^{th} embodiment, the spatially self-confined entity such as the proton in Weyl form is created, sustained and caused to evolve in the prespacetime through the imaginary momentum pᵢ (downward self-reference) such that m²>E² as shown in mathematical expressions 491, 492, 493 and 494 of FIG. 34.

Thus, according to the present model, an unspinized antiproton and a spinized antiproton in Weyl form are respectively governed by equation 495 and 496 of FIG. 34.

### V. Examples of Genesis of Composite Entities/Particles

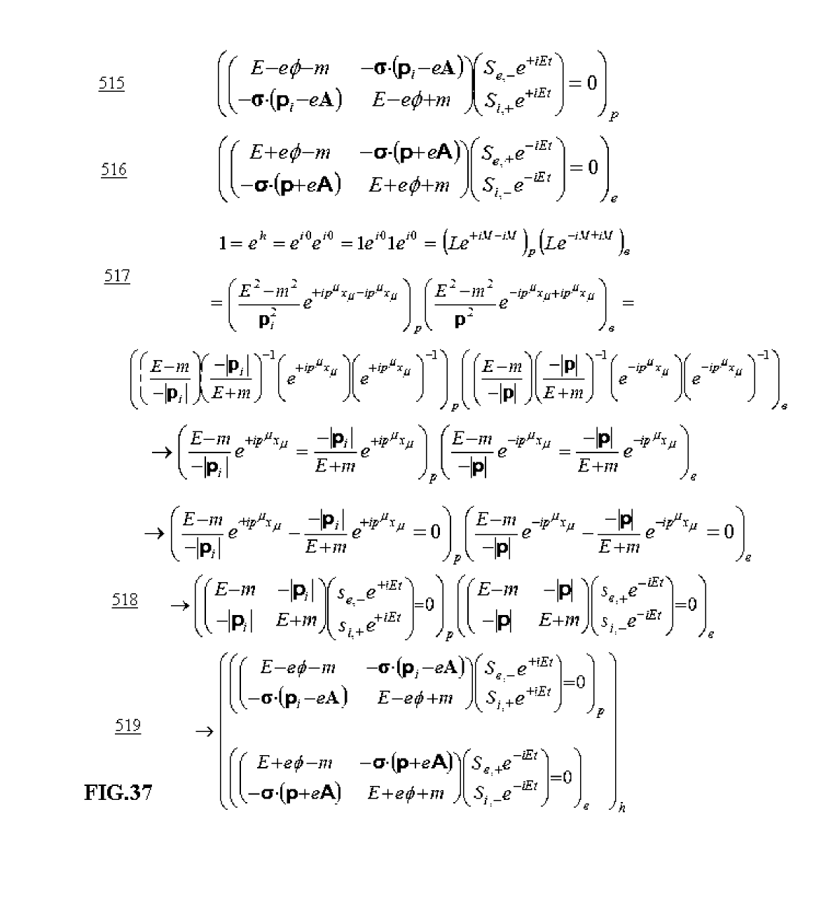

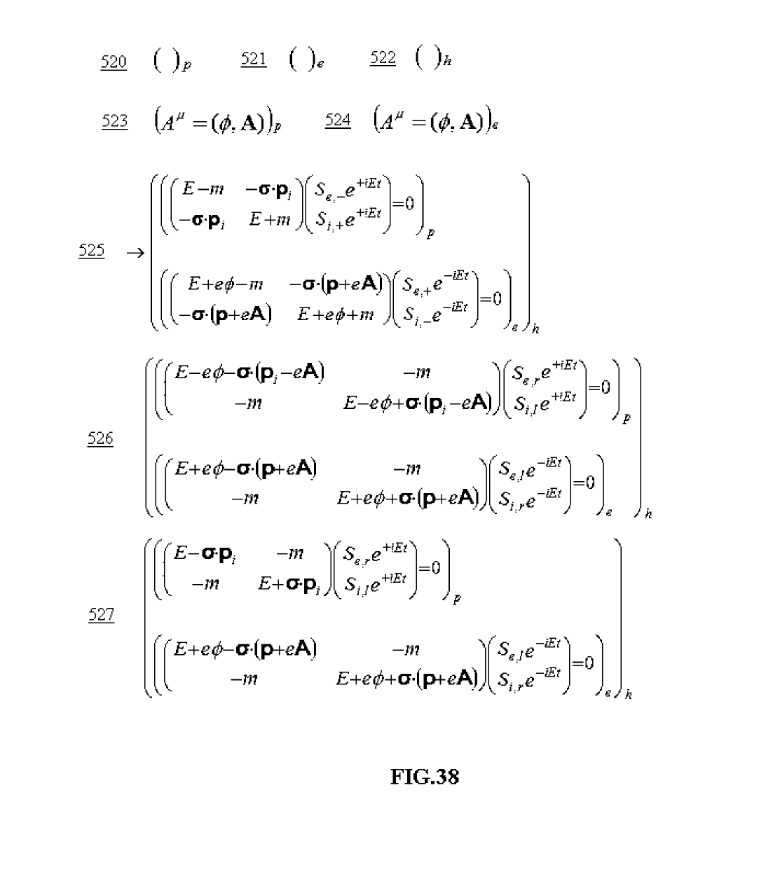

In a first embodiment, a neutron comprised of an unspinized proton in Dirac form shown in 501 and a spinized electron in Dirac form shown in 502 is created, sustained and caused to evolve in the prespacetime as shown in mathematical expressions 503 and 504 of FIGS. 35 and 505 of FIG. 36 in which 506, 507 and 508 indicate proton, electron and neutron respectively. Further, the unspinized proton has electric charge e, the spinized electron has charge −e; 509 and 510 are respectively electromagnetic potential acting on the unspinized proton and the tightly bound spinized electron; and 511 is a binding potential from the unspinized proton acting on the spinized electron causing tight binding as discussed later in this application. If 509 is negligible due to fast motion of the tightly bound spinized electron, 512 is derived from 505. Experimental data on charge distribution and g-factor of the neutron support the neutron in the present model which is comprised of the unspinized proton and the tightly bound spinized electron. A Weyl form of 505 and 512 are respectively 513 and 514 of FIG. 36.

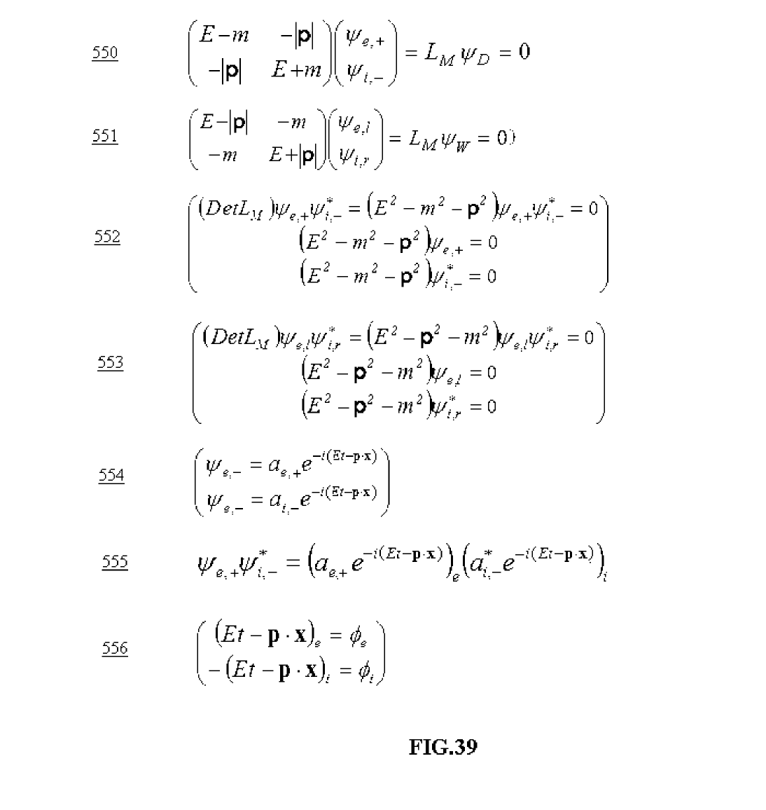

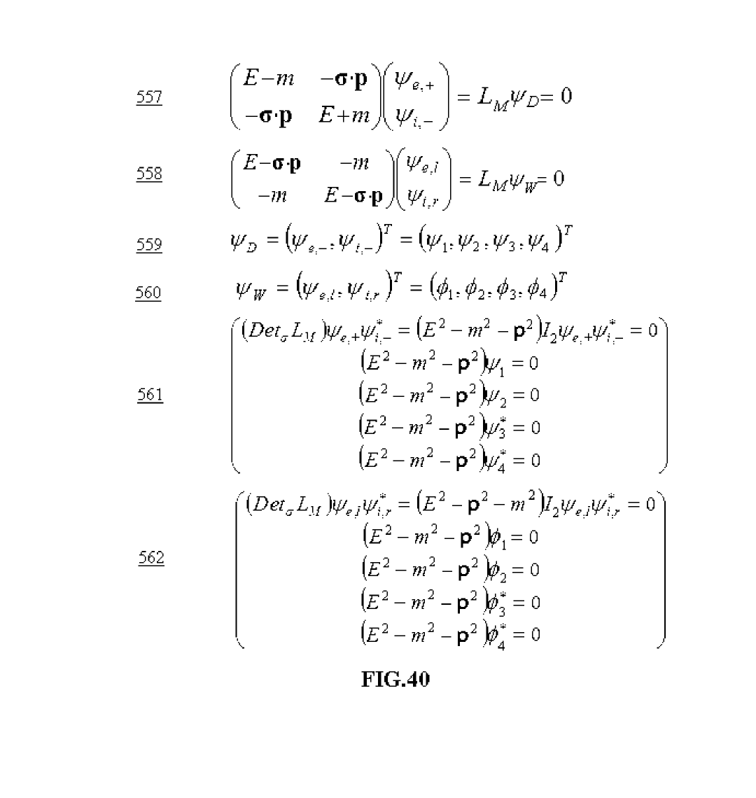

In a second embodiment, hydrogen comprised of an spinized proton in Dirac form shown in 515 and a spinized electron in Dirac form shown in 516 is created, sustained and caused to evolve in the prespacetime as shown in mathematical expressions 517, 518 and 519 of FIGS. 37. 520, 521 and 522 of FIG. 38 indicate proton, electron and hydrogen in FIG. 37 respectively. Further, the spinized proton has electric charge e, the spinized electron has charge −e; and 523 and 524 are respectively electromagnetic potential acting on the spinized proton and the spinized electron in FIG. 37. If 523 is negligible due to fast motion of the spinized electron in FIG. 37, 525 is derived from 519. A Weyl form of 519 and 525 are respectively 526 and 527 of FIG. 38.

### VI. Metamorphous View

The preceding disclosures make it clear that the prespacetime can have many different forms of primordial entities/particles and different manifestations of a single entity/particle as different wave functions and/or fields in different contexts. For example, the wave functions of an electron can take the Dirac, Weyl, quaternion or determinant form discussed below respectively in different contexts depending on questions asked and answers sought. However, a particular answer given is determined by free will of the prespacetime known as measurement problem in quantum mechanics and understood currently as a randomness of Nature. For another example, depending on a particular context, a manifestation of the entity/particle such as an electron can be a bi-spinor (ψ, ψ)^{T} in the spinized self-interaction or a bi-vector (E, iB)^{T} (or an electromagnetic potential) in an electromagnetic interaction. Further, these forms are self-contained through their respective forms of self-referential Matrix Rule.

If a first question is how a free fermion is created, several embodiments have shown in the preceding sections according to the present model. If a second is how an entity participates in weak interaction, an answer is through fermionic spinization and unspization according to the present model as shown later in this application. If a third question is how an entity participates in the strong interaction, an answer is through an imaginary momentum (downward self-reference) according to the present model as shown later in this application. If a fourth question is how an entity participates in electromagnetic interaction, an answer is through bosonic spinization and unspization according to the present model as shown later in this application. If a fifth question is how an entity participates in gravitational interaction, an answer is through timeless, spaceless and/or massless external and internal wave functions according to the present model as shown later in this application.

Further, the present model also makes it clear that the primordial self-referential spin in the prespacetime is hierarchical and is the cause of the primordial distinction for creating the elementary entities/particles in the dual world. Indeed, according to the present model and as shown in preceding sections, there are several levels of self-referential spin: (1) spin in the mind of the prespacetime for making the primordial external and internal phase distinctions of the external and internal wave functions; (2) spin of the body (ether) of the prespacetime for making the primordial external and internal wave functions which accompanies the primordial phase distinctions; (3) self-referential mixing of these wave functions through various forms of the Matrix Rule producing self-interaction, quantum entanglement or gravity; (4) unconfining spatial spin through fermionic or bosonic spinization (electromagnetic and weak interactions) for creating bosonic and fermionic entities; and (5) confining spatial spin (strong interactions) creating appearance of quarks through the imaginary momentum (downward self-reference).

As shown in the preceding sections, in the determinant view, a particular form of the Matrix Rule transforms into a particular Klein-Gordon form. As one embodiment of the present model, the transformation is accompanied by external and internal wave functions of an entity/particle governed by the particular form of the Matrix Rule forming a special product state ψₑψᵢ* with ψᵢ* containing hidden variables, a quantum potential or self-gravity as shown below, visa versa. In the present model, the Klein-Gordon form and the special product state together form a equation in the determinant form illustrated below.

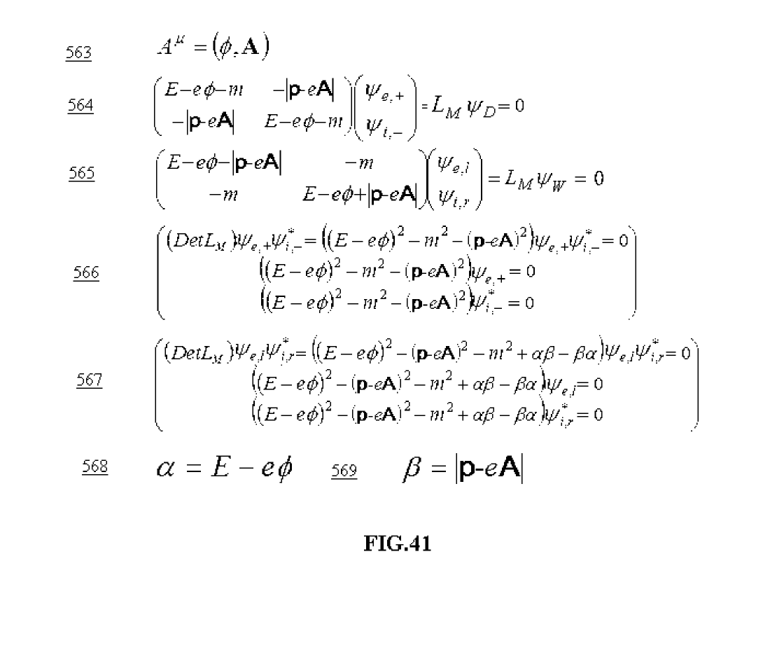

By way of an example, from 550 and 551 of FIG. 39 which respectively described an unspinized free particle in Dirac and Weyl form, two sets of equations in the determinant form are respectively derived as shown in 552 and 553 of FIG. 39. Equation 550 has a plane-wave solution shown in 554 from which the special product state is derived and shown in 555. φₑ and φᵢ in 556 are respectively an external and internal phase in the determinant view. Variables in ψ*_{i,-} play roles of the hidden variables to ψ_{e,+} which would be annihilated, if ψ*_{i,-} is allowed to merged with ψ_{e,+}. Indeed, if relativistic mass in the external wave function ψ_{e,+} is treated as inertial mass, relativistic mass in the conjugate internal wave function ψ*_{i,-} plays role of gravitational mass. We will discuss quantum potential below.

By way of another example, from 557 and 558 of FIG. 40 which respectively described a spinized free particle in Dirac and Weyl form, two sets of equations in the determinant form are respectively derived as shown in 561 and 562 of FIG. 40.

By way of a third example, in the presence of a electromagnetic potential 563, equations 550 and 551 respectively transform into 564 and 565 of FIG. 41 from which two sets of equations in the determinant form are respectively derived as shown in 566 and 567 of FIG. 41. In 567 α and β are respectively given 568 and 569 of FIG. 41.

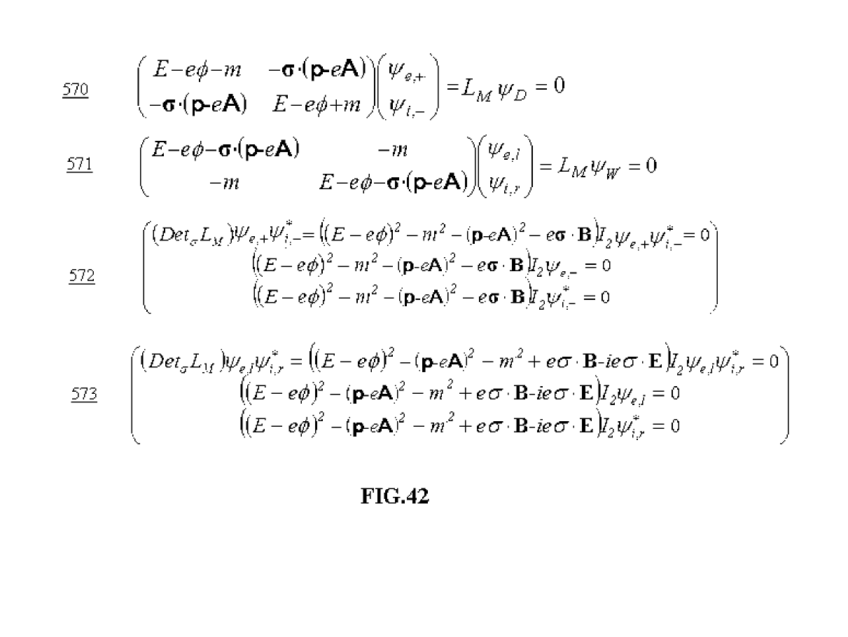

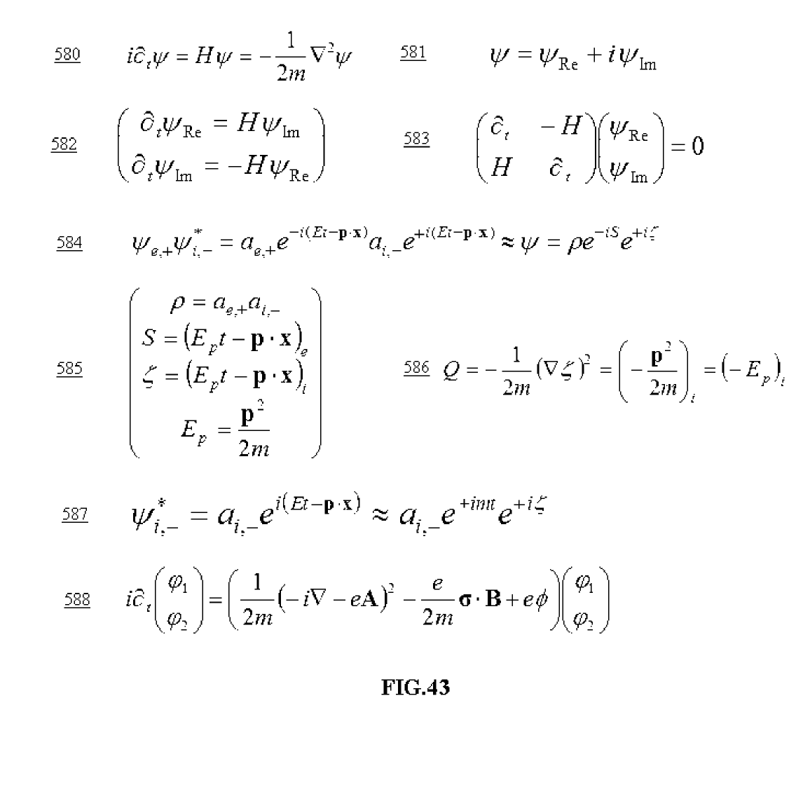

By way of a fourth example, in the presence of the electromagnetic potential 563, equations 557 and 558 respectively transform into 570 and 571 of FIG. 42 from which two sets of equations in the determinant form are respectively derived as shown in 572 and 573 of FIG. 42. In 570 and 571, couplings of E and B with spin o are implicit or hidden. However, in the determinant view, the couplings are made explicit as shown in equations 572 and 573 respectively. In the present model, the couplings are due to self-referential Matrix Rule L_{M} which mixes the external and internal wave functions.

Schrodinger Equation shown in 580 is a non-relativistic approximation of equation 552 or 553. The wave function in 580 has a form shown in 581. Thus, equation 580 can be written as two coupled equations shown in 582 or 583 which describes non-relativistic self-reference of the wave components ψ_{Re} and ψₗₘ due to spin i. If ψ_{Re} is designate as an external object, ψₗₘ is an internal object in relation to ψ_{Re}. Therefore, Schrodinger Equation in 580 is the non-relativistic approximation of the equation 552 or 553 which is the determinant form of the unspinized particle 550 or 551 with self-referential Matrix Rule reduced to spin i in time operator.

From the wave function 581 a quantum potential Q can be extracted. By way of an example, for a special product in 584 parameters of which are given in 585, a quantum potential 586 is derived. Q in 586 originates from spin i in 587. Q would negate non-relativistic kinetic energy of the external wave function if the external wave function and the conjugate internal wave function would merge.

Further, Pauli Equation 588 is a non-relativistic approximation of equation 570 which is the determinant view of a fermion in an electromagnetic field in Dirac form. 588 contains non-relativistic self-reference due to both spin i and σ.

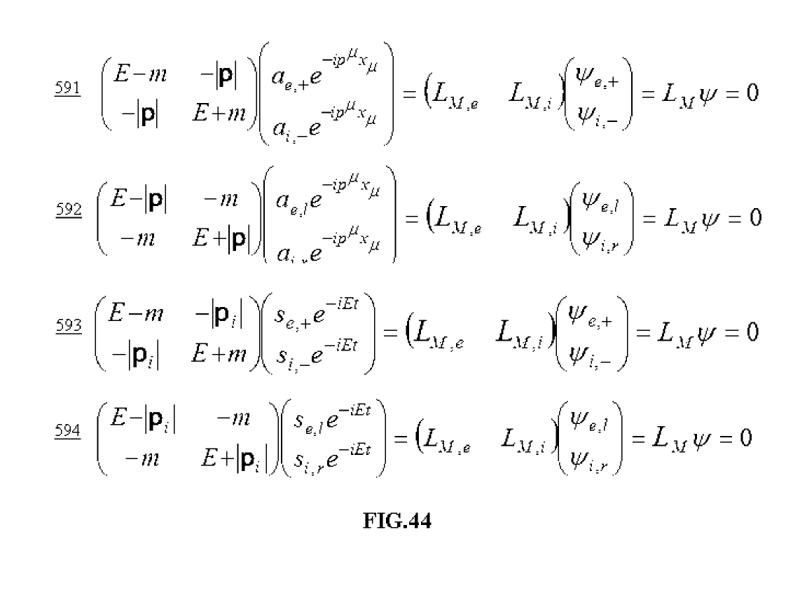

Conventionally, a scalar (spinless) particle is presumed to be described by Klein-Gordon equation and is classified as a boson. However, in the present model, the Klein-Gordon equation is an equation in the determinant form of a fermion, boson or an unspinized entity in which the external and internal wave functions (objects) form a special product state ψₑψᵢ* with ψᵢ* as origins of hidden variables, quantum potential and self-gravity. Further, in the present model, the unspinized entity is neither a boson nor a fermion but classified as a third state of matter described by the unspinized equation in Dirac or Weyl (chiral) form shown respectively in 591 and 592 of FIG. 44. Hadronized versions of 591 and 592 in which momentum becomes imaginary are respectively as shown in 593 and 594.

In the present model, the third state of matter does not subject to statistical behavior of either bosons or fermions. Wave function of a fermion or a boson is respectively a bispinor and bi-vector but the wave function of the third state is a two-component complex scalar field. In the present model, the third state of matter is precursor of both fermionic and bosonic matters/fields before fermionic or bosonic spinization. Thus, in the present model, the third state of matter steps into roles played by Higgs field in the Standard Model which so far has not been found. Further, in the present model, mass is created by self-referential spin.

### VII. Weak Interaction

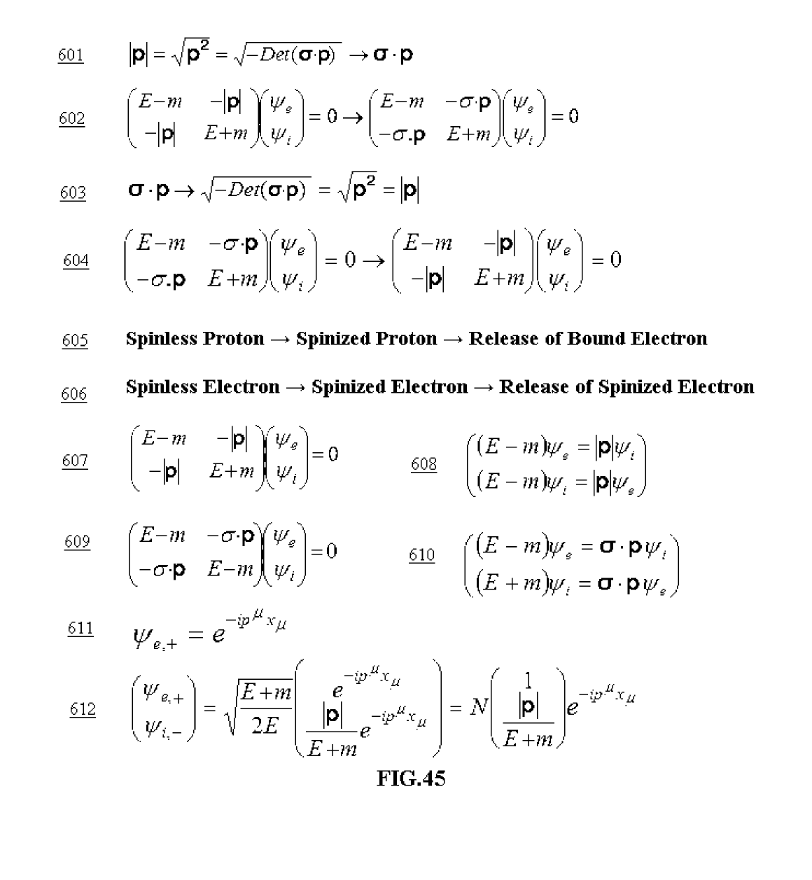

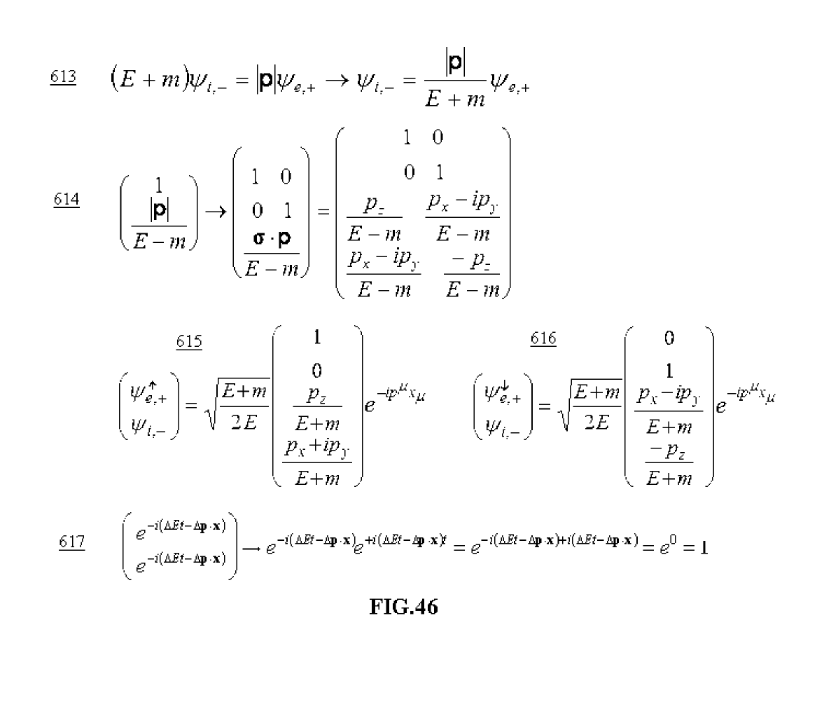

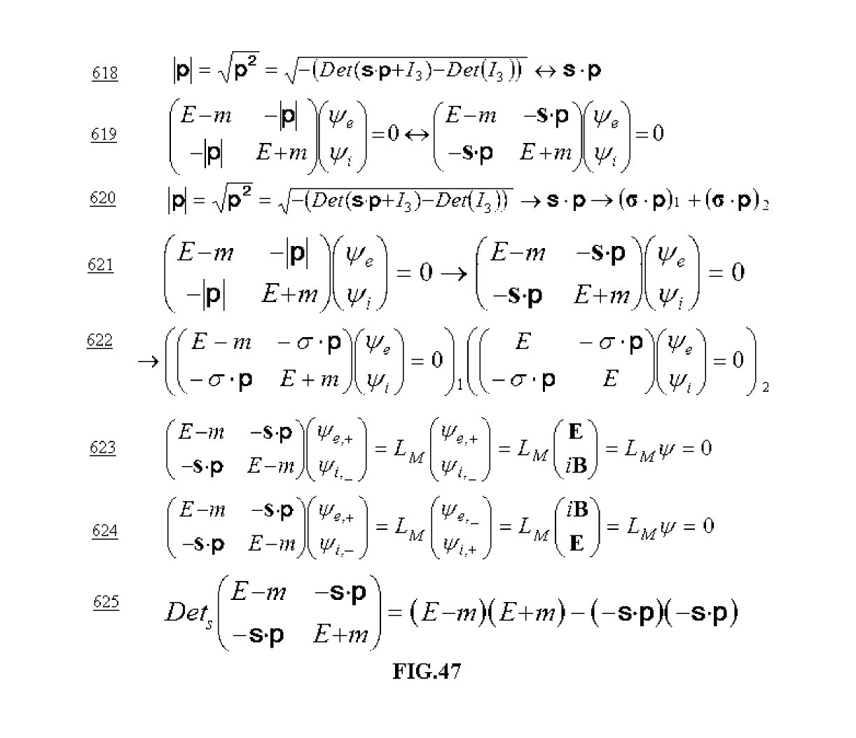

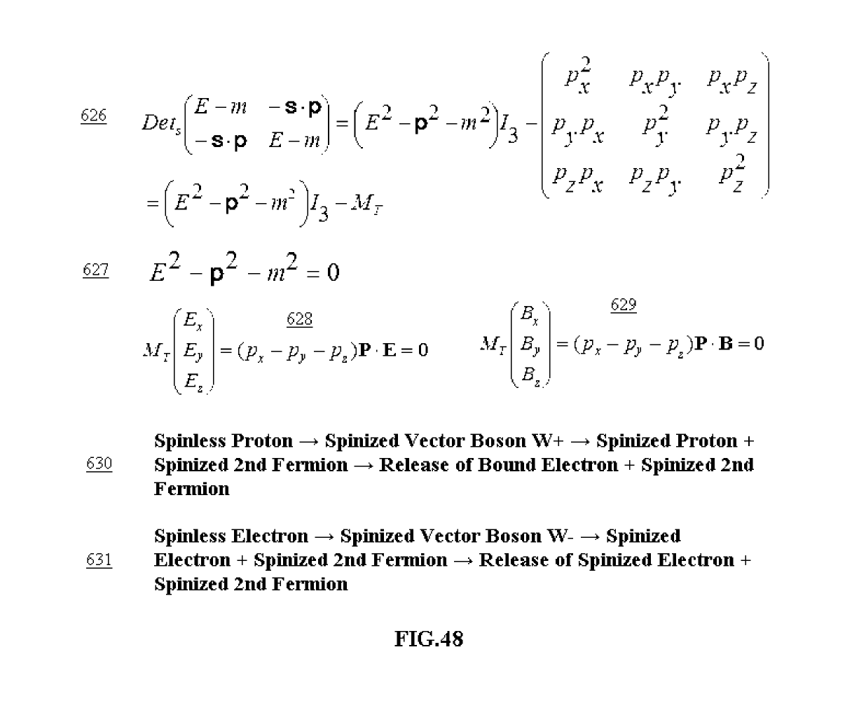

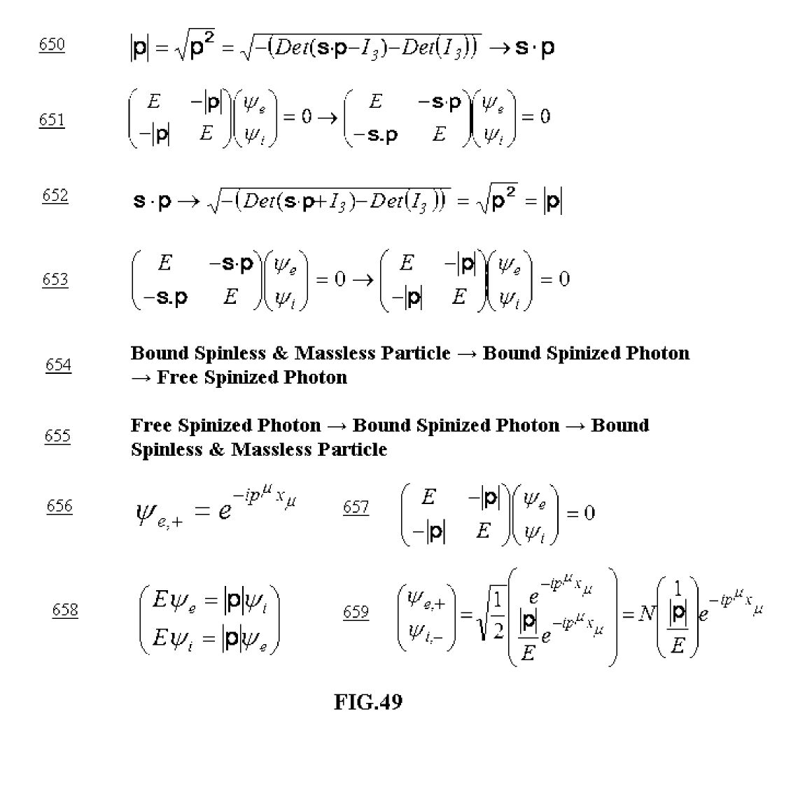

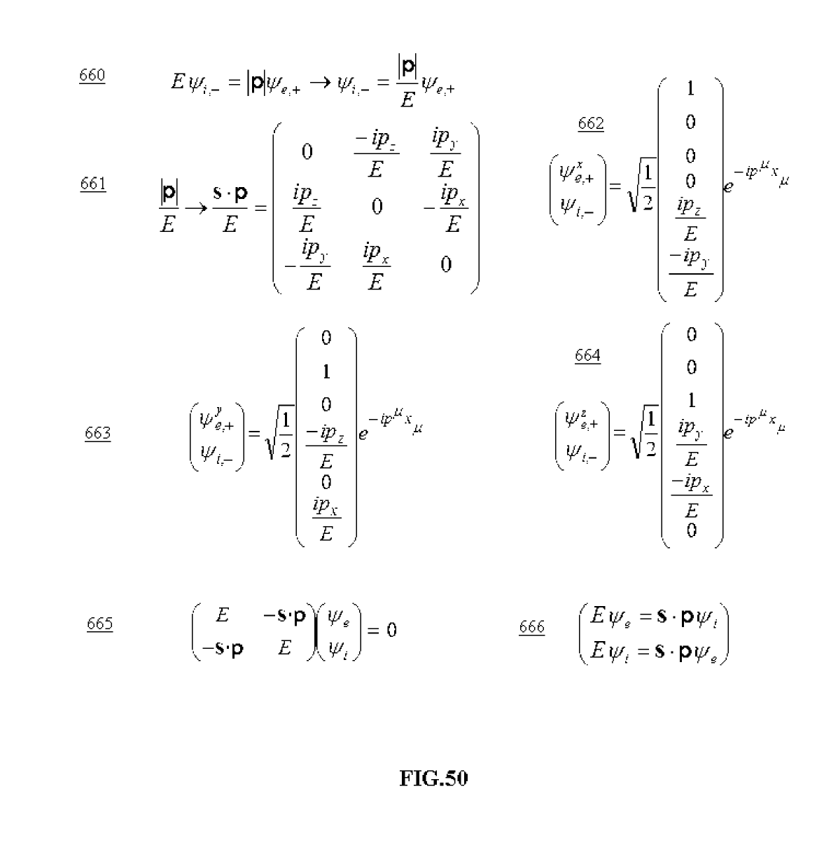

In the present model, weak interaction is an expressive process (emission or radiation) through fermionic spinization with or without intermediary bosonic spinization and associated reverse process (capture or absorption). There are two kinds of mechanisms at play in the present model. The first kind is direct fermionic spinization of an unspinized massive particle as shown 601 of FIG. 45, an example of which is shown in 602, and the reverse process shown in 603, an example of which is shown in 604. Processes 601 and 603 only conserve spin in the dual world as a whole. If they hold in reality, neutrino may not be needed in the weak interaction as currently understood or assumed.

Thus, according to the present model, beta decay of a neutron may involve the spinizing process 601 during which an unspinized proton or unspinized electron gains spin ½ and a bound spinized electron becomes free as shown in 605 and 606. Process 605 seems to be in closer agreement with experimental data on g-factor and charge density of neutron. There is no exchange particle involved in process 605 or 606. Further, in a neutron synthesis from proton and electron, if the said synthesis exists in Nature, the reverse process 603 occurs during which a spinized proton (or spinized electron) loses spin ½ and a free electron becomes tightly bound to the proton.

In the present model, equation 607 which can also be written as 608 governs a free unspinized particle having mass m and electric charge e respectively, that is, the unspinized particle is pion-like particle or a pion particle. After fermionc spinization of 607 or 608 through 601, a spinized equation 609 or 610 is derived. Giving a plane-wave solution 611 for the external wave function of 607 or 608, a complete solution for 607 or 608 is derived as shown in 612 in which N is a normalization factor and in deriving which 613 for an energy eigenstate is utilized.

After fermionic spinization of solution 612 as shown in 614, two solutions 615 and 616 are obtained respectively for external spin up and down. In these two solutions, external spin ½ is balanced by internal spin components which may be deemed as an antineutrino such that total spin of the spinized entity in the dual world is conserved to zero. Therefore, in the present model, the external spin up or down is allowed to be created without need of a separate antineutrino in beta decay and any excessive energy ΔE and or momentum Δp are allowed to cancel each other as shown in 617.

The second kind involves intermediary bosonic spinization 618 or 620 of an unspinized massive particle, examples of which are respectively shown in 619, and 621-622, during which transitory states known as vector bosons W⁻, W⁺ and/or Z⁰ appear and disappear. In the present model, only process 620 mediates the weak interaction since in process 618 vector bosons W⁻, W⁺ and/or Z⁰ are just transitory states which do not decay into fermions.

The bosonic spinized equation in 619 for free massive spin 1 particle can have a form shown in 623 or 624. Calculating the determinant defined in 625 results in 626. As shown in preceding sections, last term M_{T} in 626 makes the fundamental relationship 627 not to hold in the determinant view 625 unless action of M_{T} on the external and internal components of the wave function produces null result as shown in 628 and 629. In the present model, violations of 628 and/or 629 are allowed to exist transitorily, equations 623 or 624 describe respectively free vector bosons W⁻ and W⁺, and combination of wave functions in equations 623 or 624 describe free vector boson Z⁰, and M_{T} is treated as a transitory mass (or mass operator).

In contrast to process 605 or 606, vector bosons W⁻ and W⁺ respectively mediate spinization of an unspinzed proton or unspinized electron respectively as shown in 630 and 631. It is expected that the various forms of Matrix Rule shown herein and their further metamorphoses together with the various forms of wave functions that these forms of the Matrix Rule govern will be able to accommodate all known particles in the particle zoo.

Importantly, according to the present model, there maybe no parity violations in weak interactions such as beta decay as the apparent parity violation in the experiment may simply be explained as a spin polarization effect in which the spin polarization influences the dynamics and directions of the emitted electron in an external magnetic field. Also, there is no need for Higgs field for generating mass since mass is generated by self-referential spin within the prespacetime.

### VII. Electromagnetic Interaction

In the present model, electromagnetic interaction is an expressive process (radiation or emission) through bosonic spinization of a massless and spinless entity and associated reverse process (absorption). There are two kinds of mechanisms at play. The first kind is direct bosonic spinization (spinizing radiation) shown in 650, an example of which is shown in 651, and the reverse process shown in 652, an example of which is shown in 653. So, in the present model, radiation and absorption of a photon during acceleration of a charge particle is bosonic spinizing and unspinizing process shown in 654 and 655 respectively. Processes 654 and 655 may also occur in nuclear decay and perhaps other processes.

Giving a plane-wave solution 656 for the external wave function of equation 657 or 658, a complete solution for 657 or 658 is derived as shown in 659 in which N is a normalization factor and in deriving which 660 for an energy eigenstate is utilized. After bosonic spinization of solution 659 as shown in 661, three solutions 662, 663 and 664 are obtained for spinized photon equation 665 or 666.

The second kind of electromagnetic interactions is release (radiation) or binding (absorption) of a spinized photon without unspinization as shown in 667 and 668 respectively. 667 and 668 occur at openings of an optical cavity or waveguide and may also occur in atomic photon excitation and emission and perhaps other processes.

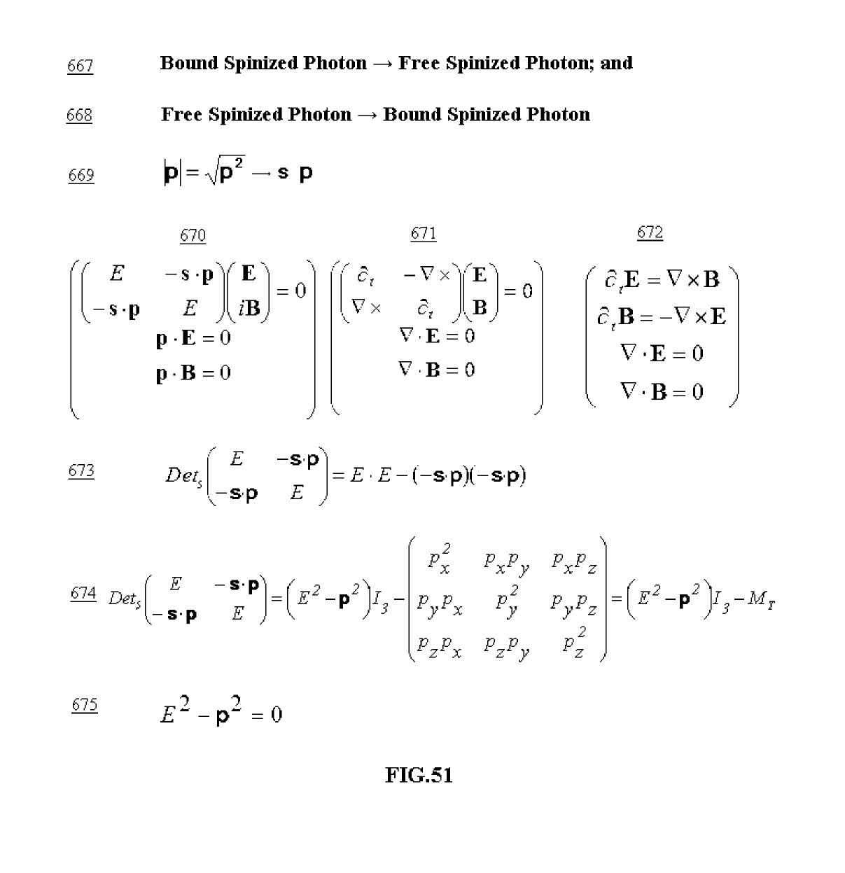

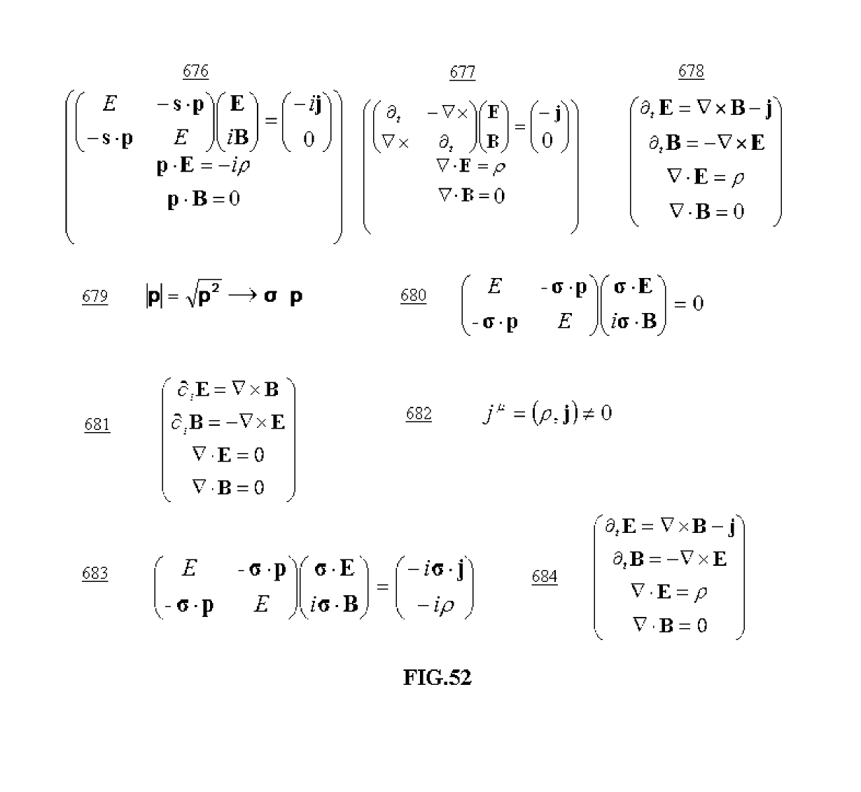

After bosonic spinization shown in 669, Maxwell equations in vacuum (c=1; ε₀=1) can be written as 670, 671 or 672 of FIG. 51. Calculating determinant defined in 673 results in 674 the last term M_{T} of which makes fundamental relationship 675 not to hold in the determinant view 673 unless action of M_{T} on E and iB produce null result because 628 and 628 only hold in a source-free region. Thus, at a location of a massive charged particle such as an electron or proton, equations 628 and 628 are also violated by a photon, so the photon appears to have mass M_{T} at the charged location which may result in particle pairs being created on collision of the photon with a massive charged particle such as the proton.

In the Maxwell equations, these violations are counter-balanced by adding a source shown in 628 to the said equations which then can be written as 676, 677 or 678. The Maxwell equations with source are, in turn, coupled to Dirac Equation of a charged fermion such as an electron or proton forming a Dirac-Maxwell system as further discussed later in this application.

Importantly, a fermionic spinization scheme 679 can also be use to describe the Maxwell equations as shown in 680 and 681 for the source-free vacuum and 683 and 684 for a zone containing source 682. Therefore, in the fermionic spinization scheme 679, the bi-vector wave function (E,iB)^{T} is replaced by a 4×4 tensor comprising of two bi-spinors generated by projecting the bi-vector (E,iB)^{T} to spin σ.

Further, in the present model, electric field E of a linear photon is the external wave function (external object) and magnetic field B of the linear photon is the internal wave function (internal object). These two fields are always self-entangled and their entanglement is their self-gravity. Therefore, in the present model, the relation between E and B in a propagating electromagnetic wave is not that a change in E induces a change in B visa versa but the change in E are always accompanied by the change in B visa versa due to their entanglement (self-gravity). That is, the relationship between E and B are gravitational and instantaneous.

### VIII. Strong Interaction

While weak and electromagnetic interactions in the present model are expressive processes involving fermionic and bosonic spinizations of spinless entities (the third state of matter) and their respective reverse processes, strong interaction in the present model does not involve spinization rather, strong force is a confining process. In the present model, spinless entities in general are unstable and decay through fermionic or bosonic spinization. Thus, in order to achieve confinement of a nucleon or stability of the nucleus, the present model suggests that strong interaction involve imaginary momentum in a confinement zone as illustrated below. There are two types of strong interaction at play. One is self-confinement of a nucleon such as a proton and the other is interaction among nucleons such a proton and a neutron.

In the Standard Model, proton is assumed to be a composite entity comprised of three quarks confined by massless gluons and the interaction among the nucleons is mediated by mesons comprised of pairs of a quark and an antiquark which in turn interact through gluons. However, since no free quark has been observed, there is good reason to consider other options. In the present model, a proton is treated as an elementary particle which accomplishes spatial self-confinement through imaginary momentum downward self-reference).

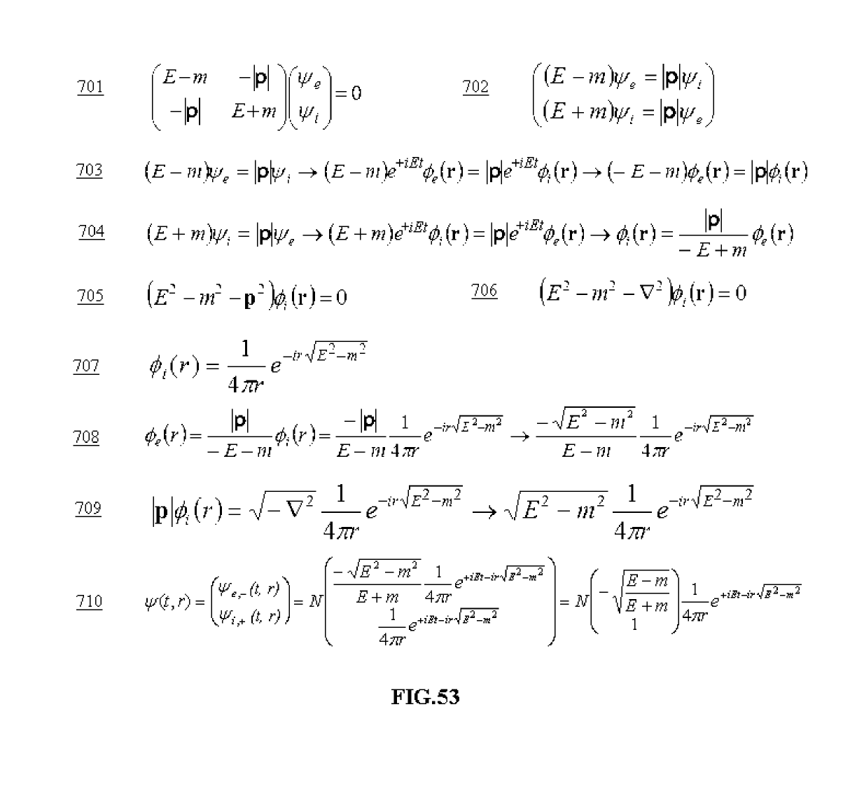

Condition for producing spatial self-confinement of the nucleon and a nuclear potential known as the Yukawa potential will be derived first. Equation for a massive but spinless entity in Dirac Form is as shown in 701 of FIG. 53 which can also be written as 702.

Taking the wave function 701 to have an energy eigenstate −E (that is, the external and internal wave functions respectively have energy eigenstate −E and +E in the determinant view), calculations in 703 and 704 can be carried out resulting in equation 705 which can also be written as 706. Equation 705 or 706 has radial solution shown in 707 which allows calculation in 708 be carried out by using a relationship in 709. Thus, a complete radial solution of equation 701 or 702 for the energy eigenstate −E in Dirac form is given in 710 where N is a normalization factor.

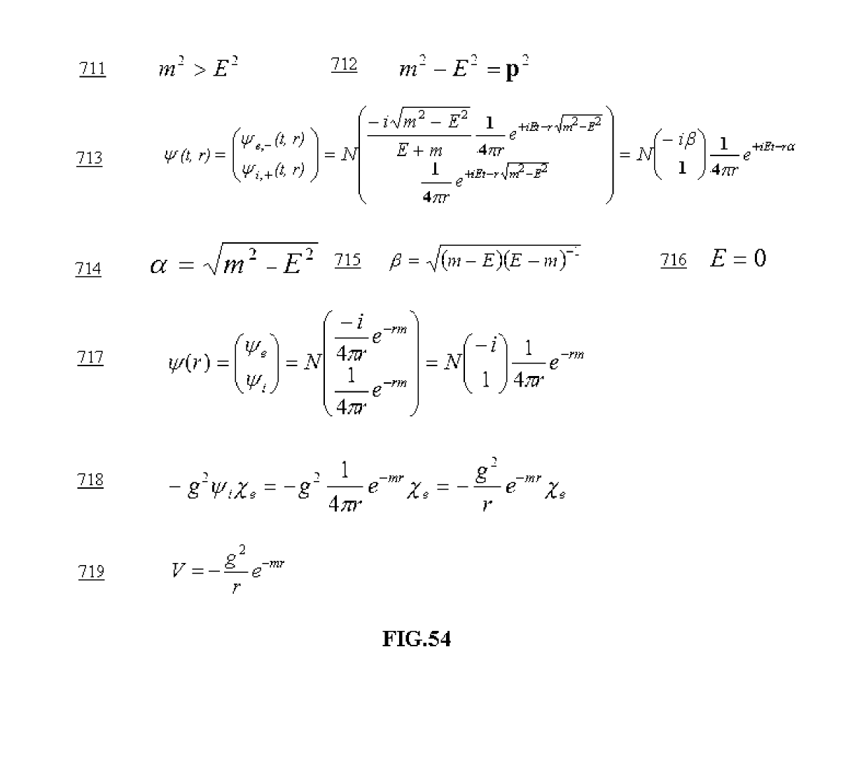

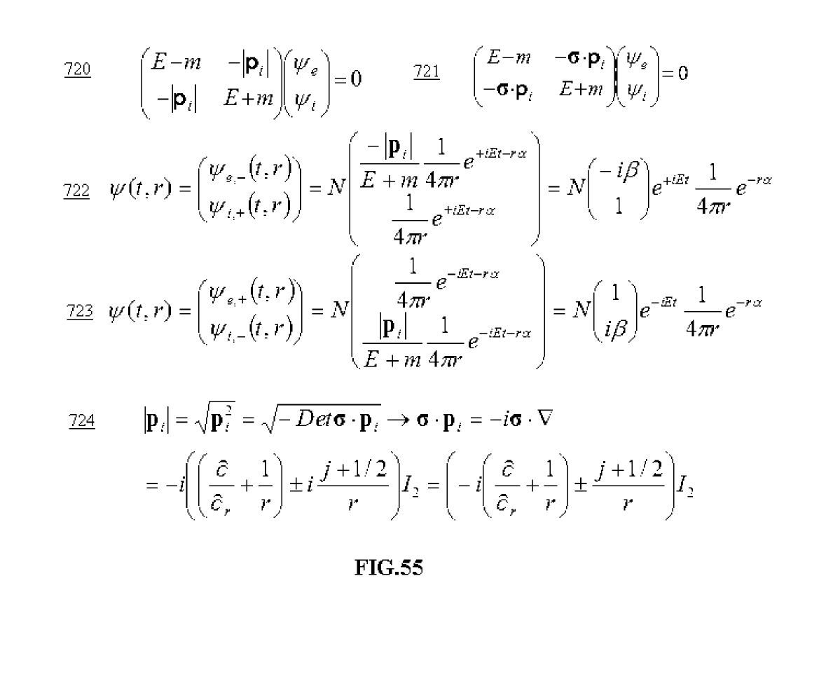

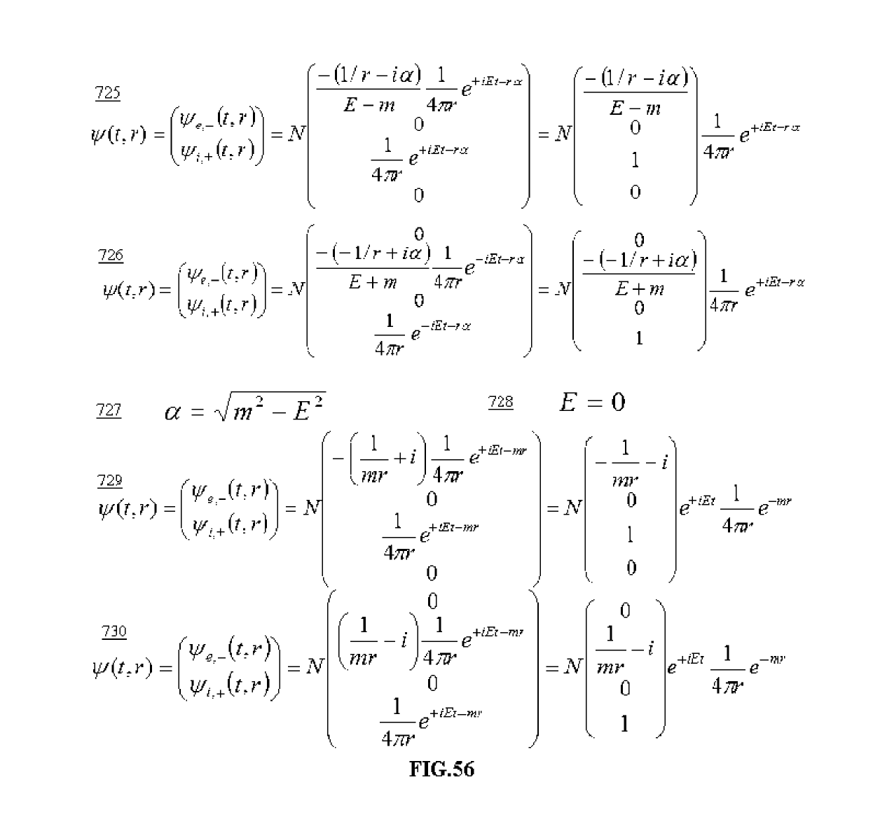

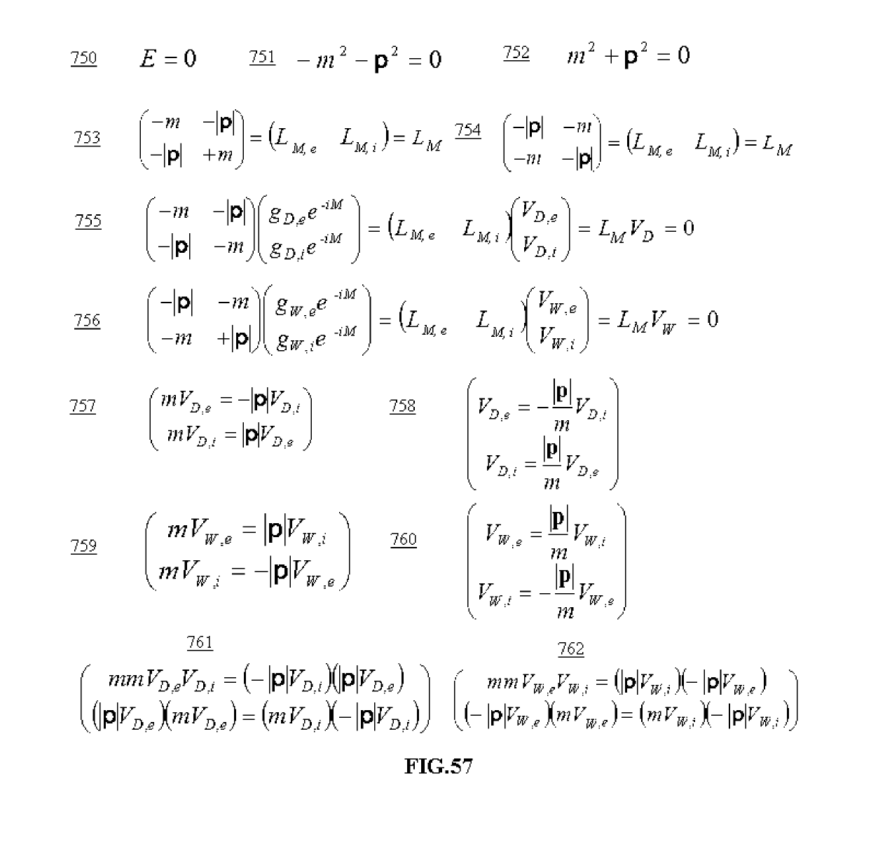

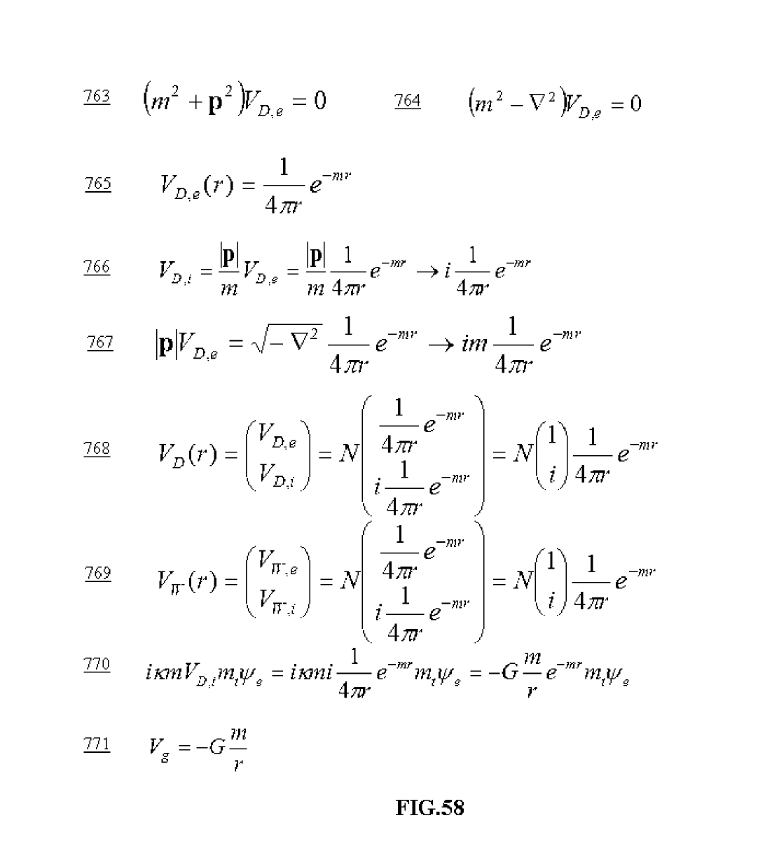

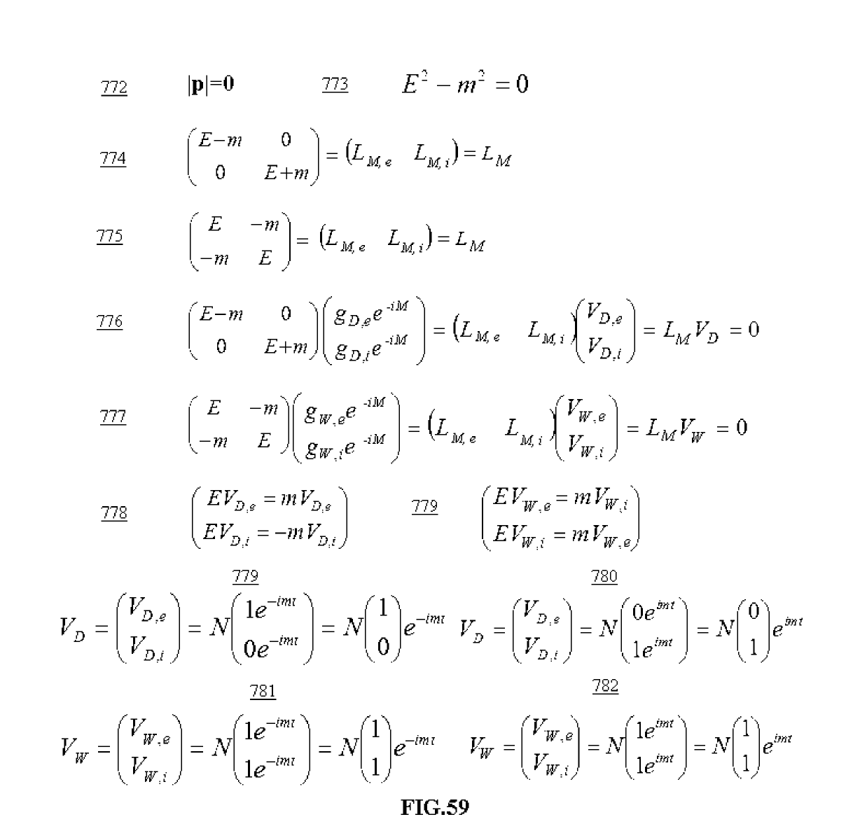

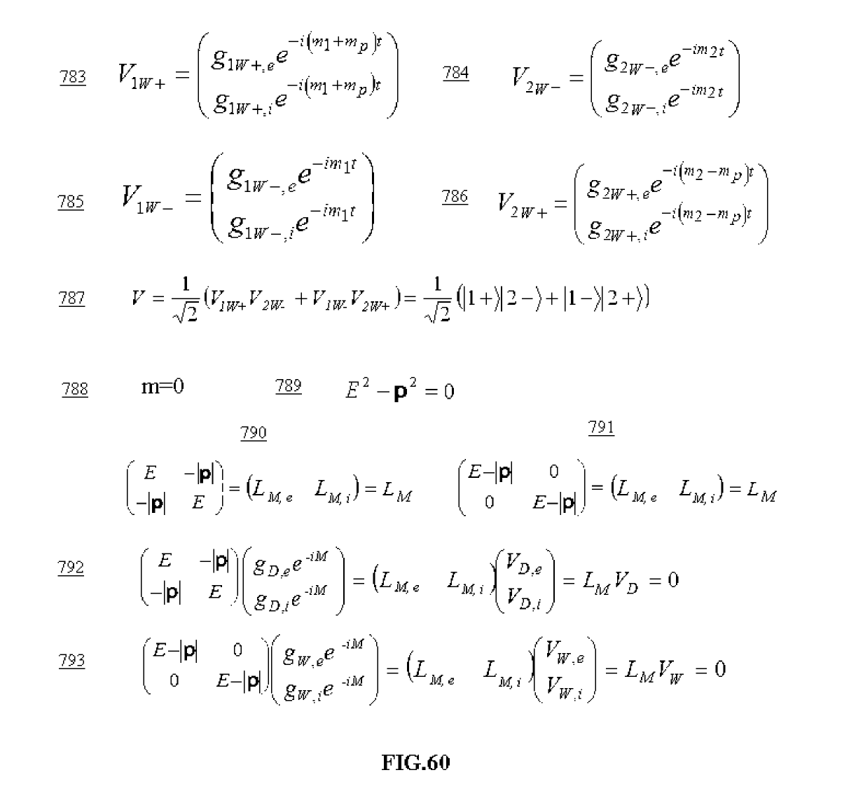

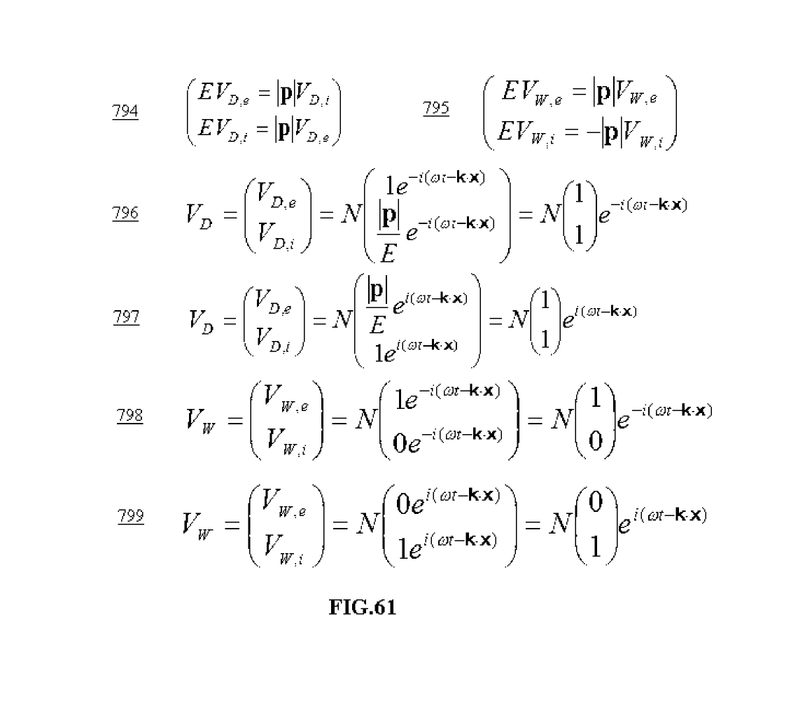

When condition shown in 711 of FIG. 54 occurs, that is, when momentum in relationship 712 is imaginary, a wave function shown in 713, in which α and β are respectively given in 714 and 715, is derived from the wave function shown in 710. Now, considering a special case of a timeless, spinless but massive entity for which condition in 716 holds, that is, rest mass of the massive entity is all comprised of imaginary momentum pᵢ, a wave function is 717 is derived. The internal and external wave functions in 717 respectively have a form of Yukawa potential and a negative imaginary projection of the Yukawa potential.

In the present model, interior (confinement zone) of an unspinized nucleon is describable by a wave function similar to expressions 713 or 717 and the confinement is achieved through the imaginary momentum pᵢ (downward self-reference) Therefore, in the present model three colors of the strong force are comprised of three-dimensional imaginary momentum. Further, a deep implication of the present model is that in a Machian quantum universe timeless edge or outside of the universe is connected to or simply is the timeless confinement zone of the nucleons.

Taking that the internal wave function ψᵢ (which is self-coupled to the external wave function ψₑ through equation 701 or 702) also couples with external wave function Xₑ of a second entity/particle (which is also self-coupled to its internal wave function Xᵢ) in a manner given in 718 in which −g² is a coupling constant, part of a nuclear potential of a nucleon has a form given in 719 which is in the form of Yukawa Potential. It is pointed out here that a person skilled in the art can write a suitable full Hamiltonian for two interacting nucleons based on what is disclosed in this application.

Considering an unspinized and a spinized form of proton in the present model, the equation for the free unspinized proton is given in 720 in Dirac form and the equation for the free spinized proton is given in 721 in Dirac form. In both 720 and 721, pᵢ represents the imaginary momentum. It is pointed out here that a proton with a spin is the commonly known form of proton and, in the present model, a proton without spin, the unspinized proton, is permitted to be a component of the neutron comprised of the unspinized proton and a spinized electron as illustrated in preceding sections.

From the preceding derivations in this section, the wave function of the unspinized proton with external and internal energy eigenstate −E and +E respectively can be written as shown in 722 (by convention, electron has positive external energy +E and internal energy −E). In contrast, an unspinized antiproton with external and internal energy eigenstate +E and −E respectively can have a wave function shown in 723. Therefore, according to the present model, nuclear spin of the neutron is solely due to a tightly bound spinized electron and a nuclear potential causing tight binding of the spinized electron in the neutron is permitted to have the form in 719. Indeed, experimental data on charge distribution and g-factor of the neutron support the herein model.

A wave function of the spinized proton described by 721 is derivable by spinizing the solution shown in 722 a step shown in 724 in which is total angular momentum number. Choosing j=½, two solutions as shown in 725 and 726, in which α is given in 727, are derived. In the case of a timeless proton, that is, when condition shown in 728 holds, two solutions as shown in 729 and 730 are derived from solutions 725 and 726 respectively. In the present model, the spinization of unspinized proton is permitted to cause loss of tight binding between the spinized electron and the unspinized proton.

### IX. Gravitational Interaction (Quantum Entanglement)

I have experimentally shown that gravity is instantaneous interaction mediated by quantum entanglement (Hu, H. P., & Wu, M. X. Evidence of non-local physical, chemical and biological effects supports quantum brain. Neuro-Quantology 4, 291-306 (2006); Hu, H. P., & Wu, M. X. Evidence of non-local chemical, thermal and gravitational effects. Progress in Physics v2, 17-21 (2007)).

In the present model, gravity is simply quantum entanglement across the dual-world. There are two types of gravity at play. The first type is self-gravity (self-interaction) between an external object (an external wave function) and an internal object (an internal wave function) of an entity (a wave function) governed by the various forms of Matrix Rule described in this application. The second type is the quantum entanglement (instantaneous interaction) between two entities/particles or one entity/particle and the dual-world as a whole which may be either attractive or repulsive. As further illustrated below, a gravitational field (a graviton) is just the wave function of the entities or particles which expresses intensity distribution and dynamics of self-quantum-entanglement (nonlocality) of the entity/particle. Indeed, the strong interaction actually is strong quantum entanglement (strong gravity).

Three particular forms of gravitational field are illustrated below. The first form is a timeless (zero energy) wave function comprised of a timeless external wave function and a timeless internal wave function which plays role of a timeless graviton, that is, the timeless wave function mediates time-independent interactions through space quantum entanglement. The second form is a spaceless wave function comprised of a spaceless external wave function and a spaceless internal wave function which plays role of a spaceless graviton, that is, the spacelss wave function mediates space (distance) independent interaction through proper time (mass) entanglement. The third form is a massless wave function comprised of a massless external wave function and a massless internal wave function which plays role of a massless graviton, that is, the massless wave function mediates mass (proper-time) independent interactions through massless energy entanglement.

A typical wave function contains all three (timeless, spaceless and massless) forms of gravitational field. In addition, the typical wave function also contains gravitational field originated from fermionic and/or bosonic spinization. As illustrated below, in the present model a timeless quantum entanglement between two entities accounts for Newton gravity. A spaceless and/or massless quantum entanglement between two entities is permitted to account for dark matter and Casimir effect. Importantly, in the present model a gravitational field originated from fermionic and/or bosonic spinization is permitted to account at least partially for dark energy.

When condition 750 occurs, 751, which can be written as 752, is derived from the fundamental relationship 301. In the present model, 751 or 752 is a relationship governing a Machian quantum universe in which total energy is zero as shown in 750. Classically, this may be seen as either rest mass m being comprised of imaginary momentum or the momentum being comprised of imaginary mass. A timeless form of the Matrix Rule in Dirac or Weyl form is respectively given in 753 and 754 which respectively govern equations in 755 and 756. The equation 755 can be rewritten as 757 or 758 and the equation 756 can be rewritten as 759 or 760. Considering couplings of external and internal wave functions from in another angle, 757 and 759 can be rewritten respectively as 761 and 762.

Equation 763, which can be rewritten as 764, is derived from 757 or 758 and has a radial solution in the form of Yukawa potential shown in 765. Thus, in equation 755, M=−imr, that is, the momentum is comprised of imaginary mass and, further, 765 is an external timeless wave function and has a form of Newton gravitational or Coulomb electric potential at large distance r→∞. Following steps shown in 766 and 767, a complete radial solution for equation 755 is derived as shown in 768 in which N is a normalization factor. Indeed, a similar solution as shown in 769 can be derived for equation 756.

Considering the internal timeless wave function V_{D,i} (which is self-coupled to the external timeless wave function V_{D,e} shown in 757 or 758) also couples through timeless quantum entanglement with an external wave function ψₑ of another entity of a test mass m (which is also self-coupled to its own internal wave function ψᵢ) as shown in 770, for example, in which where iκ is a coupling constant and G=κ/4π is Newton Gravitational Constant, a Newtonian gravitational potential shown in 771 is derived for a large distance r→∞. It is pointed out here that a person skilled in the art can write a suitable full Hamiltonian for timeless gravitational interaction of two interacting entities based on what is disclosed in this application.

When condition 772 occurs, equation 773 is derived from the fundamental relationship 301. In the present model, 773 is a relationship governing a spaceless quantum universe in which total space is zero as shown in 773. Classically, this may be seen as the rest mass m being comprised of time momentum (energy E). A spaceless form of the Matrix Rule in Dirac or Weyl form is respectively given in 774 and 775 which respectively govern equations in 776 and 777. The equation 776 can be rewritten as 778 and has solutions 779 and 780, and the equation 777 can be rewritten as 779 and has solutions 781 and 782.

As illustrated below, most quantum entanglements mentioned in quantum mechanics are spaceless quantum entanglement (gravity) between two entities, dark matter may be manifestation of this non-Newtonian gravity, and Casimir effect may be due to this type of spaceless quantum entanglement or, at least, may have contribution from spaceless quantum entanglement. For simplicity, considering two mass m₁+mₚ and m₂ respectively located at space point 1 and 2. Their respective spaceless wave functions can be written in Weyl form as shown in 783 and 784 which form a first product state V_{1W+} V_{2W-}. After mₚ leaves V_{1W+} as an emitted particle and get absorbed by V_{2W-}, two more spaceless wave functions in Weyl form are formed as respectively shown in 785 and 786 which form a second product state V_{1W-} V_{2W+}.

These two products then form a joint quantum state as shown in 787 in which m₁ and m₂ are quantum entangled due to interaction with and through mₚ. In the present model, this space (distance) independent quantum entanglement (non-Newtonian gravity) between two entities is permitted to be a cause of dark matter. It is further permitted to be a cause of or, at least, contribute to Casimir effect.

When condition 788 occurs, equation 789 is derived from the fundamental relationship 301. In the present model, 773 is a relationship governing a massless quantum universe in which total mass is zero as shown in 789. Classically, this is seen as the total energy being comprised of space momentum. A massless form of the Matrix Rule in Dirac or Weyl form is respectively given in 790 and 791 which respectively govern equations in 792 and 793. Equation 792 has solutions 796 and 797, and equation 793 has solutions 798 and 799. Equations 792 and 793 describe self-interaction of external and internal massless and spinless wave functions. Thus, quantum-entangled state of two massless and spinless entities similar to 787 for the two spaceless entities described above. In the present model, the mass-independent quantum entanglement (non-Newtonian gravity) between the two massless entities may contribute to dark matter.

### X. Consciousness and Brain Function

I have theorized that spin is a primordial self-referential process driving quantum mechanics, spacetime dynamics and consciousness (Hu, H. P. & Wu, M. X. Spin as primordial self-referential process driving quantum mechanics, spacetime dynamics and consciousness. NeuroQuantology, 2, 41-49 (2004); also see Cogprints ID2827 (2003)). I have also theorized that spin is a mind-pixel and the nuclear and/or electronic spins inside brain play important roles in certain aspects of brain functions such as perception (Hu, H. P., & Wu, M. X. Spin-mediated consciousness theory. Medical Hypotheses 63, 633-646 (2004); also see arXiv e-print quant-ph/0208068v1 (2002)).

Further, I have discovered the non-local effects of chemical substances on biological systems such as a human brain produced through quantum entanglement (Hu, H. P., & Wu, M. X. Photon induced non-local effect of general anesthetics on the brain. NeuroQuantology 4, 17-31 (2006), Hu, H. P., & Wu, M. X. Non-local effects of chemical substances on the brain produced through quantum entanglement. Progress in Physics v3, 20-26 (2006)). I have also discovered the evidence of non-local chemical, thermal and gravitational effects produced through quantum entanglement (Hu, H. P., & Wu, M. X. Evidence of non-local physical, chemical and biological effects supports quantum brain. NeuroQuantology 4, 291-306 (2006); Hu, H. P., & Wu, M. X. Evidence of non-local chemical, thermal and gravitational effects. Progress in Physics v2, 17-21 (2007)).

My experimental results referenced above indicate that consciousness is not located in a brain but associated with the prespacetime. Therefore, these results support consciousness (prespacetime) as the basis of reality. Indeed, in the present model, the reality is an interactive quantum reality centered on consciousness (prespacetime) and interaction between consciousness and reality is most fundamental self-reference. Further, consciousness (prespacetime) is both transcendent and immanent, that is, the transcendental aspect of consciousness produces and influences reality through self-referential spin as interactive output of consciousness and, in turn, reality produces and influences immanent aspect of consciousness as interactive input to consciousness also through self-referential spin.

In the present model, biological consciousness such as human consciousness is a limited or individualized version of the above dual-aspect consciousness such that a human has limited free will and limited observation/experience which is mostly classical at macroscopic levels but quantum at microscopic levels. By way of an example, as a limited transcendental consciousness, a human has through free will a choice of what measurement to do in a quantum experiment but not the ability to control the result of measurement. So, the result appears to the human as random. On the other hand, at the macroscopic level, a human also has a choice through free will of what to do but the outcome, depending on context, is sometimes certain and at other times uncertain. Further, as a limited immanent consciousness, a human can only observe measurement result in a quantum experiment which the human conducts and experiences macroscopic environment surrounding the human as the classical world.

The present model is also concerned with how human experience (as limited immanent consciousness) is produced through the brain and how human free will (as limited transcendental consciousness) may operate through the brain. As illustrated in FIG. 5, there are two kinds of interactions between an object (entity) outside the brain (body) and the brain (body). The first and commonly known kind is the direct physical and/or chemical interactions such as sensory input through the eyes. The second and less-known kind but experimentally proven to be true is the instantaneous interactions through quantum entanglement. The entire world outside the brain (body) is associated with the brain (body) through quantum entanglement thus influencing and/or generating not only the human's feelings, emotions and dreams but also the physical, chemical and physiological states of the human's brain and body.

By way of an example, in the present model quantum entanglement shown in FIG. 5 is permitted to participates in sensory experience such as vision in one embodiment as follows: (1) A light ray reflected and/or emitted from an object outside the brain enters the eye, gets absorbed, converted and amplified in the retina as propagating action potentials which travel to the central nervous system (CNS); (2) In the CNS, the action potentials drive and influence the mind pixels which according our theory is the nuclei such protons with net nuclear spins and/or electrons with unpaired spins; and (3) Either the driven or influenced dynamic patterns of the mind-pixels in the internal world form the experience of the object, or more likely our visual experience of the object is the direct experience of the object in the external world through quantum entanglement established by the physical interactions. In the latter case, there is no image of the outside world in the brain. Further, in the case that the object outside the brain is an image such as a photograph, there is also the possibility that the visual experience is not only the experience of the photograph as such through quantum entanglement but also experience of the object within the photograph through additional quantum entanglement.

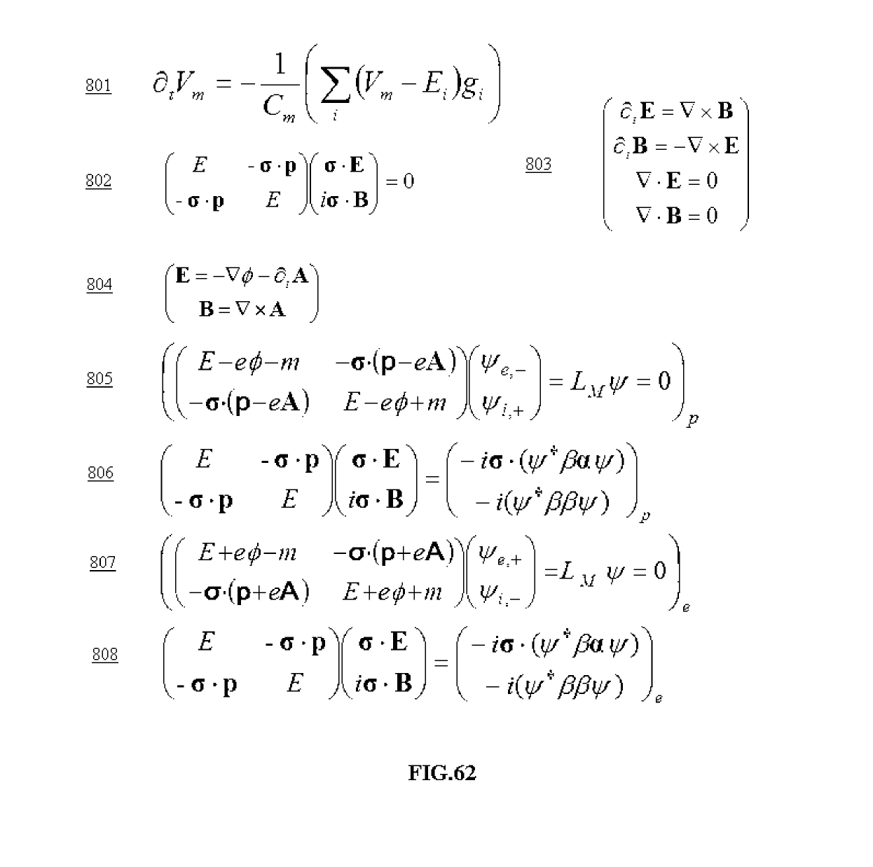

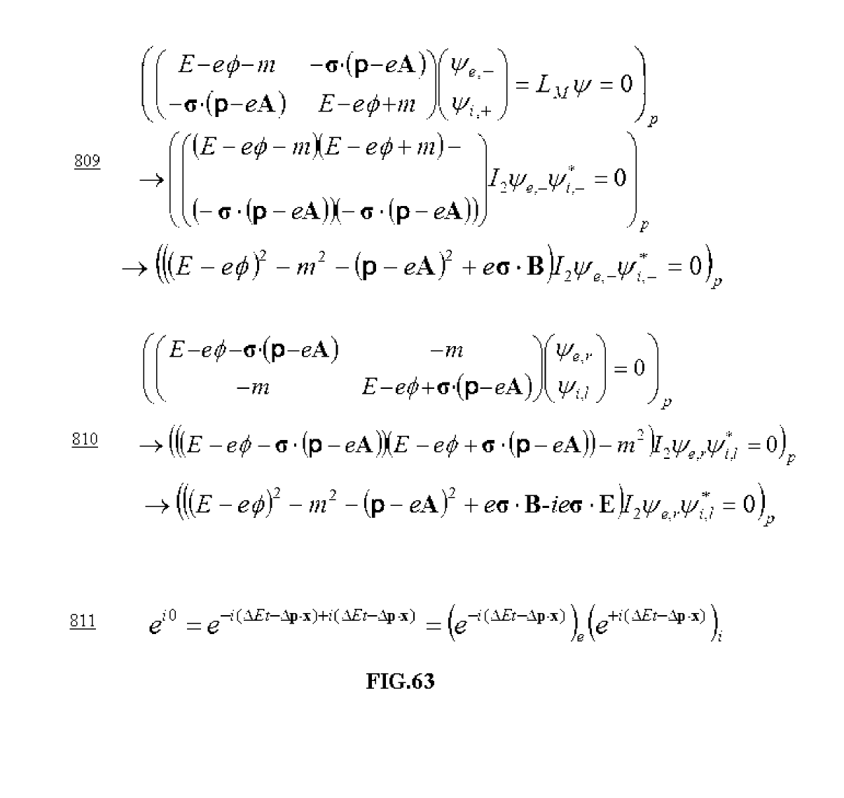

An action potential in a retina, a neural pathway or the CNS is driven by voltage-gated ion channels on neural membranes as embodied by Hodgkin-Huxley model shown in 801 of FIG. 62 in which Vₘ is electric potential across the neural membranes, Cₘ is capacitance of the membranes, gᵢ is ith voltage-gated or constant-leak ion channel. An overall effect of the action potentials and other surrounding factors, especially magnetic dipoles carried by oxygen molecules due to their two unpaired electrons, is that inside neural membranes and proteins, there exist varying strong electric field E and fluctuating magnetic field B which are also govern by the Maxwell equation shown in 802 which is traditionally written as 803 in which classical (macroscopic) electric density and current inside the neural membranes are set to zero.

Microscopically, electromagnetic field E and B and their electromagnetic potential A^{μ}=(φ, A) which is connected to E and B through equation 804 interact with a proton of electric charge e and an unpaired electron of charge −e respectively as two sets of Dirac-Maxwell systems 805 and 806 for the proton and 807 and 808 for the electron in which β and α are Dirac matrices. In equations 805 and 807, interactions (couplings) of E and/or B with the proton and electron's spin operator (σ)ₚ and (σ)ₑ respectively are hidden. These couplings are due to self-referential Matrix Rule which causes mixing of external and internal wave functions and can be made explicit in the determinant view as shown in 809 and 810 for the proton which is in Dirac and Weyl form respectively before the determinant view. A similar calculations as those in 809 and 810 can be carried out for the electron to show explicit couplings of (σ)ₑ with E and B.

In the present model, a first effect of the couplings is that the action potentials through E and B (or A^{μ}) input information into mind-pixels which are nuclear or electronic spin in the brain. Also, in the present model, the said information is likely carried in temporal and spatial variations of E and B (frequencies and timing of neural electric spikes and their spatial distribution in the CNS). A second effect of the couplings in the present model is that the couplings allow transcendental aspect of consciousness through wave functions of the proton and/or electron to back-influence E and B (or A^{μ}) which in turn back-affect the action potentials through the Hodgkin-Huxley neural circuits shown in 801 in the CNS.

Importantly, in the present model a human free-will as a macroscopic quality of limited transcendental consciousness is permitted to originate microscopically under particular high electric voltage environment inside the neural membranes. By way of an example, the present model permit the human free will as thought or imagination produces changes in the phase of external and internal wave functions through 811, where ( )ₑ and ( )ᵢ respectively indicate external and internal wave functions, which in turn back-affect E and B (or A^{μ}) in the high electric voltage neural membranes through the Dirac Maxwell systems illustrated shown in 805 and 806 for the proton and 807 and 808 for the electron.

It will be evident from the above that there are other embodiments which are clearly within the scope and spirit of the present invention, although they were not expressly set forth above. Therefore, the above disclosure is exemplary only, and the actual scope of my invention is to be determined by the claims.

What is claimed is:

1: A method of modeling creation, sustenance and evolution of an elementary particle, as a teaching and/or modeling tool, comprising the steps of:
generating a first representation of said creation, sustenance and evolution of said elementary particle comprising:
$$1 = {e}^{i 0} = 1 {e}^{i 0} = L {e}^{i M + i M} = {L}_{e} {L}_{i}^{- 1} ( {e}^{- i M} ) {( {e}^{- i M} )}^{- 1} -> ( \begin{matrix}{L}_{M , e} & {L}_{M , i}\end{matrix} ) ( \begin{matrix}{A}_{e} {e}^{- i M} \\ {A}_{i} {e}^{- i M}\end{matrix} ) = {L}_{m} ( \begin{matrix}{ψ}_{e} \\ {ψ}_{i}\end{matrix} ) = 0$$
where e is natural exponential base, i is imaginary unit, L represents rule of one, M is a phase, Aₑe^{-M}=ψₑ represents external object, Aᵢe^{-iM}=ψᵢ represents internal object, Lₑ represents external rule, Lᵢ represents internal rule, L_{M}=(L_{M,e} L_{M,i}) represents matrix rule, L_{M,e} represents external matrix rule and L_{M,i} represents internal matrix rule; and
presenting and/or modeling said first representation in a device for teaching and/or research.

2: A method as in claim 1 wherein said external object comprises of an external wave function; said internal object comprises of an internal wave function; said elementary particle comprises of a fermion, boson or unspinized particle; said matrix rule contains an energy operator E→i∂, momentum operator p→i∇, spin operator σ where σ=(σ₁, σ₂, σ₃) are Pauli matrices, spin operator S where S=(S₁, S₂, S₃) are spin 1 matrices, and/or mass; said matrix rule further has a determinant containing E²−p²−m²=0, E²−p²=0, E²−m²=0, or 0²−p²−m²=0; c=1 where c is speed of light; and =1 where is reduced Planck constant.

3: A method as in claim 2 wherein said first representation of said creation, sustenance and evolution of said elementary particle comprises:
$$\begin{matrix}\begin{matrix}1 = {e}^{i 0} \\ = 1 {e}^{i 0} \\ = L {e}^{+ i M - i M} \\ = \frac{{E}^{2} - {m}^{2}}{{p}^{2}} {e}^{+ i {p}^{μ} {x}_{μ} - i {p}^{μ} {x}_{μ}} \\ = ( \frac{E - m}{- \vert p \vert} ) {( \frac{- \vert p \vert}{E + m} )}^{- 1} ( {e}^{- i {p}^{{μ}_{{x}_{μ}}}} ) {( {e}^{- i {p}^{{μ}_{{x}_{μ}}}} )}^{- 1} -> \frac{E - m}{- \vert p \vert} {e}^{- i {p}^{{μ}_{{x}_{μ}}}} \\ = \frac{- \vert p \vert}{E + m} {e}^{- i {p}^{{μ}_{{x}_{μ}}}} -> \frac{E - m}{- \vert p \vert} {e}^{- i {p}^{{μ}_{{x}_{μ}}}} - \frac{- \vert p \vert}{E + m} {e}^{- i {p}^{{μ}_{{x}_{μ}}}} \\ = 0 -> ( \begin{matrix}E - m & - \vert p \vert \\ - \vert p \vert & E + m\end{matrix} ) ( \begin{matrix}{a}_{e , +} {e}^{- i {p}^{{μ}_{{x}_{μ}}}} \\ {a}_{i , -} {e}^{- i {p}^{{μ}_{{x}_{μ}}}}\end{matrix} ) \\ = 0 -> ( \begin{matrix}E - m & - σ \cdot p \\ - σ \cdot p & E + m\end{matrix} ) ( \begin{matrix}{A}_{e , +} {e}^{- i {p}^{{μ}_{{x}_{μ}}}} \\ {A}_{i , -} {e}^{- i {p}^{{μ}_{{x}_{μ}}}}\end{matrix} ) \\ = ( \begin{matrix}{L}_{M , e} & {L}_{M , i}\end{matrix} ) ( \begin{matrix}{ψ}_{e , +} \\ {ψ}_{i , -}\end{matrix} ) \\ = 0\end{matrix} & \\ or \\ ( \begin{matrix}E - m & - s \cdot p \\ - s \cdot p & E + m\end{matrix} ) ( \begin{matrix}{A}_{e , +} {e}^{- i {p}^{{μ}_{{x}_{μ}}}} \\ {A}_{i , -} {e}^{- i {p}^{{μ}_{{x}_{μ}}}}\end{matrix} ) = ( \begin{matrix}{L}_{M , e} & {L}_{M , i}\end{matrix} ) ( \begin{matrix}{ψ}_{e , +} \\ {ψ}_{i , -}\end{matrix} ) = 0 & \end{matrix}$$
where
$$( \begin{matrix}E - m & - \vert p \vert \\ - \vert p \vert & E + m\end{matrix} ) ( \begin{matrix}{a}_{e , +} {e}^{- i {p}^{{μ}_{{x}_{μ}}}} \\ {a}_{i , -} {e}^{- i {p}^{{μ}_{{x}_{μ}}}}\end{matrix} ) = 0$$
is a first equation for said unspinized particle,
$$( \begin{matrix}E - m & - σ \cdot p \\ - σ \cdot p & E + m\end{matrix} ) ( \begin{matrix}{A}_{e , +} {e}^{- i {p}^{{μ}_{{x}_{μ}}}} \\ {A}_{i , -} {e}^{- i {p}^{{μ}_{{x}_{μ}}}}\end{matrix} ) = 0$$
is Dirac equation in Dirac form for said fermion, and
$$( \begin{matrix}E - m & - s \cdot p \\ - s \cdot p & E + m\end{matrix} ) ( \begin{matrix}{A}_{e , +} {e}^{- i {p}^{{μ}_{{x}_{μ}}}} \\ {A}_{i , -} {e}^{- i {p}^{{μ}_{{x}_{μ}}}}\end{matrix} ) = 0$$
is a first equation for said boson;
$$1 = {e}^{i0} = 1 {e}^{i 0} = {L}_{1} {e}^{+ i M - i M} = \frac{{E}^{2} - {p}^{2}}{{m}^{2}} {e}^{+ i {p}^{μ} {x}_{μ} - i {p}^{μ} {x}_{μ}} = ( \frac{E - \vert p \vert}{- m} ) {( \frac{- m}{E + \vert p \vert} )}^{- 1} ( {e}^{- i {p}^{μ} {x}_{μ}} ) {( {e}^{- i {p}^{μ} {x}_{μ}} )}^{- 1} -> \frac{E - \vert p \vert}{- m} {e}^{- i {p}^{μ} {x}_{μ}} = \frac{- m}{E + \vert p \vert} {e}^{- i {p}^{μ} {x}_{μ}} -> \frac{E - \vert p \vert}{- m} {e}^{- i {p}^{μ} {x}_{μ}} - \frac{- m}{E + \vert p \vert} {e}^{- i {p}^{μ} {x}_{μ}} = 0 -> ( \begin{matrix}E - \vert p \vert & - m \\ - m & E + \vert p \vert\end{matrix} ) ( \begin{matrix}{a}_{e , l} {e}^{- i {p}^{μ} {x}_{μ}} \\ {a}_{i , r} {e}^{- i {p}^{μ} {x}_{μ}}\end{matrix} ) = 0 -> ( \begin{matrix}E - σ \cdot p & - m \\ - m & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = ( {L}_{M , e} {L}_{M , i} ) ( \begin{matrix}{ψ}_{e , l} \\ {ψ}_{i , r}\end{matrix} ) = 0$$
$$or \\ ( \begin{matrix}E - s \cdot p & - m \\ - m & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = ( {L}_{M , e} {L}_{M , i} ) ( \begin{matrix}{ψ}_{e , l} \\ {ψ}_{i , r}\end{matrix} ) = 0$$
where
$$( \begin{matrix}E - \vert p \vert & - m \\ - m & E + \vert p \vert\end{matrix} ) ( \begin{matrix}{a}_{e , l} {e}^{- i {p}^{μ} {x}_{μ}} \\ {a}_{i , r} {e}^{- i {p}^{μ} {x}_{μ}}\end{matrix} ) = 0$$
is a second equation for said unspinized particle,
$$( \begin{matrix}E - σ \cdot p & - m \\ - m & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
Dirac equation in Weyl form for said fermion, and
$$( \begin{matrix}E - s \cdot p & - m \\ - m & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
is a second equation for said boson;
$$1 = {e}^{i0} = 1 {e}^{i 0} = L {e}^{+ i M - i M} = \frac{{E}^{2}}{{m}^{2} + {p}^{2}} {e}^{+ i {p}^{μ} {x}_{μ} - i {p}^{μ} {x}_{μ}} = ( \frac{E}{- m + i \vert p \vert} ) {( \frac{- m - i \vert p \vert}{E} )}^{- 1} ( {e}^{- i {p}^{μ} {x}_{μ}} ) {( {e}^{- i {p}^{μ} {x}_{μ}} )}^{- 1} -> \frac{E}{- m + i \vert p \vert} {e}^{- i {p}^{μ} {x}_{μ}} = \frac{- m - i \vert p \vert}{E} {e}^{- i {p}^{μ} {x}_{μ}} -> \frac{E}{- m - i \vert p \vert} {e}^{- i {p}^{μ} {x}_{μ}} - \frac{- m - i \vert p \vert}{E} {e}^{- i {p}^{μ} {x}_{μ}} = 0 -> ( \begin{matrix}E & - m - i \vert p \vert \\ - m + i \vert p \vert & E\end{matrix} ) ( \begin{matrix}{a}_{e} {e}^{- i {p}^{μ} {x}_{μ}} \\ {a}_{i} {e}^{- i {p}^{μ} {x}_{μ}}\end{matrix} ) = 0 -> ( \begin{matrix}E & - m - i σ \cdot p \\ - m + i σ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = ( {L}_{M , e} {L}_{M , i} ) ( \begin{matrix}{ψ}_{e} \\ {ψ}_{i}\end{matrix} ) = 0$$
$$or \\ ( \begin{matrix}E & - m - is \cdot p \\ - m + i s \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = ( {L}_{M , e} {L}_{M , i} ) ( \begin{matrix}{ψ}_{e} \\ {ψ}_{i}\end{matrix} ) = 0$$
where
$$( \begin{matrix}E & - m - i \vert p \vert \\ - m + i \vert p \vert & E\end{matrix} ) ( \begin{matrix}{a}_{e} {e}^{- i {p}^{μ} {x}_{μ}} \\ {a}_{i} {e}^{- i {p}^{μ} {x}_{μ}}\end{matrix} ) = 0$$
is a third equation for said unspinized particle,
$$( \begin{matrix}E & - m - i σ \cdot p \\ - m + i σ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0$$
is Dirac equation in a third form for said fermion, and
$$( \begin{matrix}E & - m - is \cdot p \\ - m + is \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0$$
is a third equation for said boson; or
$$1 = {e}^{i0} = 1 {e}^{i 0} = L {e}^{+ i M - i M} = \frac{{E}^{2} - {m}^{2}}{{p}_{i}^{2}} {e}^{+ i {p}^{μ} {x}_{μ} - i {p}^{μ} {x}_{μ}} = ( \frac{E - m}{- \vert {p}_{i} \vert} ) {( \frac{- \vert {p}_{i} \vert}{E + m} )}^{- 1} ( {e}^{- i {p}^{μ} {x}_{μ}} ) {( {e}^{- i {p}^{μ} {x}_{μ}} )}^{- 1} -> \frac{E - m}{- \vert {p}_{i} \vert} {e}^{- i {p}^{μ} {x}_{μ}} = \frac{- \vert {p}_{i} \vert}{E + m} {e}^{- i {p}^{μ} {x}_{μ}} -> \frac{E - m}{- {p}_{i}} {e}^{- i {p}^{μ} {x}_{μ}} - \frac{- \vert {p}_{i} \vert}{E + m} {e}^{- i {p}^{μ} {x}_{μ}} = 0 -> ( \begin{matrix}E - m & - \vert {p}_{i} \vert \\ - \vert {p}_{i} \vert & E + m\end{matrix} ) ( \begin{matrix}{s}_{e , +} {e}^{- i Et} \\ {s}_{i , -} {e}^{- i Et}\end{matrix} ) = 0 -> ( \begin{matrix}E - m & - σ \cdot {p}_{i} \\ - σ \cdot {p}_{i} & E + m\end{matrix} ) ( \begin{matrix}{S}_{e , +} {e}^{- i Et} \\ {S}_{i , -} {e}^{- i Et}\end{matrix} ) = ( {L}_{M , e} {L}_{M , i} ) ( \begin{matrix}{ψ}_{e , +} \\ {ψ}_{i , -}\end{matrix} ) = 0$$
$$or \\ ( \begin{matrix}E - m & - s \cdot {p}_{i} \\ - s \cdot {p}_{i} & E + m\end{matrix} ) ( \begin{matrix}{S}_{e , +} {e}^{- i Et} \\ {S}_{i , -} {e}^{- i Et}\end{matrix} ) = ( {L}_{M , e} {L}_{M , i} ) ( \begin{matrix}{ψ}_{e , +} \\ {ψ}_{i , -}\end{matrix} ) = 0$$
where
$$( \begin{matrix}E - m & - \vert {p}_{i} \vert \\ - \vert {p}_{i} \vert & E + m\end{matrix} ) ( \begin{matrix}{s}_{e , +} {e}^{- i Et} \\ {s}_{i , -} {e}^{- i Et}\end{matrix} ) = 0$$
is a first equation for said unspinized particle with said imaginary momentum
$${p}_{i} , ( \begin{matrix}E - m & - σ \cdot {p}_{i} \\ - σ \cdot {p}_{i} & E + m\end{matrix} ) ( \begin{matrix}{S}_{e , +} {e}^{- i Et} \\ {S}_{i , -} {e}^{- i Et}\end{matrix} ) = 0$$
is Dirac equation in Dirac form for said fermion with said imaginary momentum pᵢ, and
$$( \begin{matrix}E - m & - s \cdot {p}_{i} \\ - s \cdot {p}_{i} & E + m\end{matrix} ) ( \begin{matrix}{S}_{e , +} {e}^{- i Et} \\ {S}_{i , -} {e}^{- i Et}\end{matrix} ) = 0$$
is a first equation for said boson with said imaginary momentum pᵢ.

4: A method as in claim 3 wherein said elementary particle comprises of:
an electron, equation of said electron being modeled as:
$$( \begin{matrix}E - m & - σ \cdot p \\ - σ \cdot p & E + m\end{matrix} ) ( \begin{matrix}{A}_{e , +} {e}^{i {p}^{μ} {x}_{μ}} \\ {A}_{i , -} {e}^{- i {p}^{μ} {x}_{μ}}\end{matrix} ) = 0 , \\ ( \begin{matrix}E - σ \cdot p & - m \\ - m & E + σ \cdot p\end{matrix} ) ( \begin{matrix}{A}_{e , l} {e}^{- i {p}^{μ} {x}_{μ}} \\ {A}_{i , r} {e}^{- {ip}^{μ} {x}_{μ}}\end{matrix} ) = 0$$
$$or \\ ( \begin{matrix}E & - m - i σ \cdot p \\ - m + i σ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0 ;$$
a positron, equation of said positron being modeled as:
$$( \begin{matrix}E - m & - σ \cdot p \\ - σ \cdot p & E + m\end{matrix} ) ( \begin{matrix}{A}_{e , -} {e}^{+ i {p}^{μ} {x}_{μ}} \\ {A}_{i , +} {e}^{+ i {p}^{μ} {x}_{μ}}\end{matrix} ) = 0 , \\ ( \begin{matrix}E - σ \cdot p & - m \\ - m & E + σ \cdot p\end{matrix} ) ( \begin{matrix}{A}_{e , r} {e}^{+ i {p}^{μ} {x}_{μ}} \\ {A}_{i , l} {e}^{+ i {p}^{μ} {x}_{μ}}\end{matrix} ) = 0$$
$$or \\ ( \begin{matrix}E & - m - i σ \cdot p \\ - m + i σ \cdot p & E\end{matrix} ) ( \begin{matrix}{A}_{e} {e}^{+ i {p}^{μ} {x}_{μ}} \\ {A}_{i} {e}^{+ i {p}^{μ} {x}_{μ}}\end{matrix} ) = 0 ;$$
a massless neutrino, equation of said neutrino being modeled as:
$$( \begin{matrix}E & - σ \cdot p \\ - σ \cdot p & E\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0 , \\ ( \begin{matrix}E - σ \cdot p & \\ & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
$$or \\ ( \begin{matrix}E & - i σ \cdot p \\ + i σ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0 ;$$
A massless antineutrino, equation of said antineutrino being modeled as:
$$( \begin{matrix}E & - σ \cdot p \\ - σ \cdot p & E\end{matrix} ) ( \begin{matrix}{A}_{e , -} {e}^{+ i {p}^{μ} {x}_{μ}} \\ {A}_{i , +} {e}^{+ i {p}^{μ} {x}_{μ}}\end{matrix} ) = 0 , \\ ( \begin{matrix}E - σ \cdot p & \\ & E + σ \cdot p\end{matrix} ) ( \begin{matrix}{A}_{e , r} {e}^{+ i {p}^{μ} {x}_{μ}} \\ {A}_{i , l} {e}^{+ i {p}^{μ} {x}_{μ}}\end{matrix} ) = 0 or \\ ( \begin{matrix}E & - iσ \cdot p \\ + iσ \cdot p & E\end{matrix} ) ( \begin{matrix}{A}_{e} {e}^{+ i {p}^{μ} {x}_{μ}} \\ {A}_{i} {e}^{+ i {p}^{μ} {x}_{μ}}\end{matrix} ) = 0 ;$$
a massive spin 1 boson, equation of said massive spin 1 boson being modeled as:
$$( \begin{matrix}E - m & - s \cdot p \\ - s \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0 , \\ ( \begin{matrix}E - s \cdot p & - m \\ - m & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0 or \\ ( \begin{matrix}E & - m - i s \cdot p \\ - m + i s \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0 ;$$
a massive spin 1 antiboson, equation of said massive spin 1 antiboson being modeled as:
$$( \begin{matrix}E - m & - s \cdot p \\ - s \cdot p & E + m\end{matrix} ) ( \begin{matrix}{A}_{e , -} {e}^{+ i {p}^{μ} {x}_{μ}} \\ {A}_{i , +} {e}^{+ i {p}^{μ} {x}_{μ}}\end{matrix} ) = 0 , \\ ( \begin{matrix}E - s \cdot p & - m \\ - m & E + s \cdot p\end{matrix} ) ( \begin{matrix}{A}_{e , r} {e}^{+ i {p}^{μ} {x}_{μ}} \\ {A}_{i , l} {e}^{+ i {p}^{μ} {x}_{μ}}\end{matrix} ) = 0 or \\ ( \begin{matrix}E & - m - i s \cdot p \\ - m + i s \cdot p & E\end{matrix} ) ( \begin{matrix}{A}_{e} {e}^{+ i {p}^{μ} {x}_{μ}} \\ {A}_{i} {e}^{+ i {p}^{μ} {x}_{μ}}\end{matrix} ) = 0 ;$$
a massless spin 1 boson, equation of said massless spin 1 boson being modeled as:
$$( \begin{matrix}E & - s \cdot p \\ - s \cdot p & E\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = ( \begin{matrix}E & - s \cdot p \\ - s \cdot p & E\end{matrix} ) ( \begin{matrix}E \\ i B\end{matrix} ) = 0 , \\ ( \begin{matrix}E - s \cdot p & \\ & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0 or \\ ( \begin{matrix}E & - i s \cdot p \\ + i s \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0$$
where
$$( \begin{matrix}E & - s \cdot p \\ - s \cdot p & E\end{matrix} ) ( \begin{matrix}E \\ i B\end{matrix} ) = 0$$
is equivalent to Maxwell equation
$$( \begin{matrix}{\partial }_{t} E = ∇ \times B \\ {\partial }_{t} B = - ∇ \times E\end{matrix} ) ;$$
a massless spin 1 antiboson, equation of said massless spin 1 antiboson being modeled as:
$$( \begin{matrix}E & - s \cdot p \\ - s \cdot p & E\end{matrix} ) ( \begin{matrix}{A}_{e , -} {e}^{+ i {p}^{μ} {x}_{μ}} \\ {A}_{i , +} {e}^{+ i {p}^{μ} {x}_{μ}}\end{matrix} ) = 0 , \\ ( \begin{matrix}E - s \cdot p & \\ & E + s \cdot p\end{matrix} ) ( \begin{matrix}{A}_{e , r} {e}^{+ i {p}^{μ} {x}_{μ}} \\ {A}_{i , l} {e}^{+ i {p}^{μ} {x}_{μ}}\end{matrix} ) = 0 or \\ ( \begin{matrix}E & - i s \cdot p \\ - m + i s \cdot p & E\end{matrix} ) ( \begin{matrix}{A}_{e} {e}^{+ i {p}^{μ} {x}_{μ}} \\ {A}_{i} {e}^{+ i {p}^{μ} {x}_{μ}}\end{matrix} ) = 0 ;$$
an antiproton, equation of said antiproton being modeled as:
$$( \begin{matrix}E - m & - σ \cdot {p}_{i} \\ - σ \cdot {p}_{i} & E + m\end{matrix} ) ( \begin{matrix}{S}_{e , +} {e}^{- i Et} \\ {S}_{i , -} {e}^{- i Et}\end{matrix} ) = 0 , \\ ( \begin{matrix}E - σ \cdot {p}_{i} & - m \\ - m & E + σ \cdot {p}_{i}\end{matrix} ) ( \begin{matrix}{S}_{e , l} {e}^{- i Et} \\ {S}_{i , r} {e}^{- i Et}\end{matrix} ) = 0 or \\ ( \begin{matrix}E & - m - i σ \cdot {p}_{i} \\ - m + i σ \cdot {p}_{i} & E\end{matrix} ) ( \begin{matrix}{S}_{e} {e}^{- i Et} \\ {S}_{i} {e}^{- i Et}\end{matrix} ) = 0 ; or$$
a proton, equation of said proton being modeled as:
$$( \begin{matrix}E - m & - σ \cdot {p}_{i} \\ - σ \cdot {p}_{i} & E + m\end{matrix} ) ( \begin{matrix}{S}_{e , -} {e}^{+ i Et} \\ {S}_{i , +} {e}^{+ i Et}\end{matrix} ) = 0 , \\ ( \begin{matrix}E - σ \cdot {p}_{i} & - m \\ - m & E + σ \cdot {p}_{i}\end{matrix} ) ( \begin{matrix}{S}_{e , r} {e}^{+ i Et} \\ {S}_{i , l} {e}^{+ i Et}\end{matrix} ) = 0 or \\ ( \begin{matrix}E & - m - i σ \cdot {p}_{i} \\ - m + i σ \cdot {p}_{i} & E\end{matrix} ) ( \begin{matrix}{S}_{e} {e}^{+ i Et} \\ {S}_{i} {e}^{+ i Et}\end{matrix} ) = 0.$$

5: A method as in claim 3 wherein said elementary particle comprises an electron and said first representation is modified to include a proton, said proton being modeled as a second elementary particle, and interaction fields of said electron and said proton, said modified first representation comprising:
$$1 = {e}^{i 0} = 1 {e}^{i 0} 1 {e}^{i 0} = {( L {e}^{+ i M - i M} )}_{p} {( L {e}^{+ i M - i M} )}_{e} = {( \frac{{E}^{2} - {m}^{2}}{{p}_{i}^{2}} {e}^{+ i {p}^{μ} {x}_{μ} - i {p}^{μ} {x}_{μ}} )}_{p} {( \frac{{E}^{2} - {m}^{2}}{{p}^{2}} {e}^{- i {p}^{μ} {x}_{μ} + i {p}^{μ} {x}_{μ}} )}_{e} = {( ( \frac{E - m}{- \vert {p}_{i} \vert} ) {( \frac{- \vert {p}_{i} \vert}{E + m} )}^{- 1} ( {e}^{+ i {p}^{μ} {x}_{μ}} ) {( {e}^{+ i {p}^{μ} {x}_{μ}} )}^{- 1} )}_{p} {( ( \frac{E - m}{- \vert p \vert} ) {( \frac{- \vert p \vert}{E + m} )}^{- 1} ( {e}^{- i {p}^{μ} {x}_{μ}} ) {( {e}^{- i {p}^{μ} {x}_{μ}} )}^{- 1} )}_{e} -> {( ( \begin{matrix}E - m & - \vert {p}_{i} \vert \\ - \vert {p}_{i} \vert & E + m\end{matrix} ) ( \begin{matrix}{s}_{e , -} {e}^{+ i Et} \\ {s}_{i , +} {e}^{+ i Et}\end{matrix} ) = 0 )}_{p} {( ( \begin{matrix}E - m & - \vert p \vert \\ - \vert p \vert & E + m\end{matrix} ) ( \begin{matrix}{s}_{e , +} {e}^{- i Et} \\ {s}_{i , -} {e}^{- i Et}\end{matrix} ) = 0 )}_{e} -> ( \begin{matrix}{( ( \begin{matrix}E - e φ - m & - σ \cdot ( {p}_{i} - e A ) \\ - σ \cdot ( {p}_{i} - e A ) & E + e φ - m\end{matrix} ) ( \begin{matrix}{S}_{e , -} {e}^{+ i Et} \\ {S}_{i , +} {e}^{+ i Et}\end{matrix} ) = 0 )}_{p} \\ {( ( \begin{matrix}E + e φ - m & - σ \cdot ( p + e A ) \\ - σ \cdot ( p + e A ) & E + e φ + m\end{matrix} ) ( \begin{matrix}{S}_{e , +} {e}^{- i Et} \\ {S}_{i , -} {e}^{- i Et}\end{matrix} ) = 0 )}_{e}\end{matrix} )$$
where ( )ₑ denotes electron, ( )ₚ denotes proton and (( )ₑ( )ₚ) denotes an electron-proton system.

6: A method as in claim 3 wherein said elementary particle comprises of an electron and said first representation is modified to include an unspinized proton, said unspinized proton being modeled as a second elementary particle, and interaction fields of said electron and said unspinized proton, said modified first representation comprising:
$$1 = {e}^{i 0} = 1 {e}^{i 0} 1 {e}^{i 0} = {( L {e}^{+ i M - i M} )}_{p} {( L {e}^{+ i M - i M} )}_{e} = {( \frac{{E}^{2} - {m}^{2}}{{p}_{i}^{2}} {e}^{+ i {p}^{μ} {x}_{μ} - i {p}^{μ} {x}_{μ}} )}_{p} {( \frac{{E}^{2} - {m}^{2}}{{p}^{2}} {e}^{- i {p}^{μ} {x}_{μ} + i {p}^{μ} {x}_{μ}} )}_{e} = {( ( \frac{E - m}{- \vert {p}_{i} \vert} ) {( \frac{- \vert {p}_{i} \vert}{E + m} )}^{- 1} ( {e}^{+ i {p}^{μ} {x}_{μ}} ) {( {e}^{+ i {p}^{μ} {x}_{μ}} )}^{- 1} )}_{p} {( ( \frac{E - m}{- \vert p \vert} ) {( \frac{- \vert p \vert}{E + m} )}^{- 1} ( {e}^{- i {p}^{μ} {x}_{μ}} ) {( {e}^{- i {p}^{μ} {x}_{μ}} )}^{- 1} )}_{e} -> {( ( \begin{matrix}E - m & - \vert {p}_{i} \vert \\ - \vert {p}_{i} \vert & E + m\end{matrix} ) ( \begin{matrix}{s}_{e , -} {e}^{+ i Et} \\ {s}_{i , +} {e}^{+ i Et}\end{matrix} ) = 0 )}_{p} {( ( \begin{matrix}E - m & - \vert p \vert \\ - \vert p \vert & E + m\end{matrix} ) ( \begin{matrix}{s}_{e , +} {e}^{- i Et} \\ {s}_{i , -} {e}^{- i Et}\end{matrix} ) = 0 )}_{e} -> ( \begin{matrix}{( ( \begin{matrix}E - e φ - m & - \vert {p}_{i} - e A \vert \\ - \vert {p}_{i} - e A \vert & E - e φ + m\end{matrix} ) ( \begin{matrix}{s}_{e , -} {e}^{+ i Et} \\ {s}_{i , +} {e}^{+ i Et}\end{matrix} ) = 0 )}_{p} \\ {( ( \begin{matrix}E + e φ - V - m & - σ \cdot ( p + e A ) \\ - σ \cdot ( p + e A ) & E + e φ - V + m\end{matrix} ) ( \begin{matrix}{S}_{e , +} {e}^{- i Et} \\ {S}_{i , -} {e}^{- i Et}\end{matrix} ) = 0 )}_{e}\end{matrix} )$$
where ( )ₑ denotes electron, ( )ₚ denotes unspinized proton and (( )ₑ( )ₚ) denotes an electron-unspinized proton system.

7: A method as in claim 2 wherein:
$$\to 1 = L = \frac{{E}^{2} - {m}^{2}}{{p}^{2}} = ( \frac{E - m}{- \vert p \vert} ) {( \frac{- \vert p \vert}{E + m} )}^{- 1} \to \frac{E - m}{- \vert p \vert} = \frac{- \vert p \vert}{E + m} \to \frac{E - m}{- \vert p \vert} - \frac{- \vert p \vert}{E + m} = 0 \to ( \begin{matrix}E - m & - \vert p \vert \\ - \vert p \vert & E + m\end{matrix} ) \to ( \begin{matrix}E - m & - σ \cdot p \\ - σ \cdot p & E + m\end{matrix} ) or ( \begin{matrix}E - m & - s \cdot p \\ - s \cdot p & E + m\end{matrix} ) , \to 1 = L = \frac{{E}^{2} - {p}^{2}}{{m}^{2}} = ( \frac{E - \vert p \vert}{- m} ) {( \frac{- m}{E + \vert p \vert} )}^{- 1} \to \frac{E - \vert p \vert}{- m} = \frac{- m}{E + \vert p \vert} \to \frac{E - \vert p \vert}{- m} - \frac{- m}{E + \vert p \vert} = 0 \to ( \begin{matrix}E - \vert p \vert & - m \\ - m & E + \vert p \vert\end{matrix} ) \to ( \begin{matrix}E - σ \cdot p & - m \\ - m & E + σ \cdot p\end{matrix} ) or ( \begin{matrix}E - s \cdot p & - m \\ - m & E + s \cdot p\end{matrix} ) , \to 1 = L = \frac{{m}^{2} + {p}^{2}}{{E}^{2}} = {( \frac{E}{- m + i \vert p \vert} )}^{- 1} ( \frac{- m - i \vert p \vert}{E} ) \to \frac{E}{- m + i \vert p \vert} = \frac{- m - i \vert p \vert}{E} \to \frac{E}{- m + i \vert p \vert} - \frac{- m - i \vert p \vert}{E} = 0 \to ( \begin{matrix}E & - m - i \vert p \vert \\ - m + i \vert p \vert & E\end{matrix} ) \to ( \begin{matrix}E & - m - iσ \cdot p \\ - m + iσ \cdot p & E\end{matrix} ) or ( \begin{matrix}E & - m - i s \cdot p \\ - m + i s \cdot p & E\end{matrix} ) , or \to 1 = L = \frac{{E}^{2} + {p}_{i}^{2}}{{m}^{2}} = ( \frac{E - \vert {p}_{i} \vert}{- m} ) {( \frac{- m}{E + \vert {p}_{i} \vert} )}^{- 1} \to \frac{E - \vert {p}_{i} \vert}{- m} = \frac{- m}{E + \vert {p}_{i} \vert} \to \frac{E - \vert {p}_{i} \vert}{- m} - \frac{- m}{E + \vert {p}_{i} \vert} = 0 \to ( \begin{matrix}E - \vert {p}_{i} \vert & - m \\ - m & E + \vert {p}_{i} \vert\end{matrix} ) \to ( \begin{matrix}E - σ \cdot {p}_{i} & - m \\ - m & E + σ \cdot {p}_{i}\end{matrix} ) or ( \begin{matrix}E - s \cdot {p}_{i} & - m \\ - m & E + s \cdot {p}_{i}\end{matrix} ) ,$$
where σ=(σ₁, σ₂, σ₃) are Pauli matrices, |p|=\sqrt{p²}=\sqrt{−Det(σ·p)}→σ·p represents fermionic spinization of |p|, S=(S₁, S₂, S₃) are spin operators for spin 1 particle, |p|=\sqrt{p²}={square root over (−(Det(s·p+I₃)−Det(I₃)))}→s·p represents bosonic spinization of |p|, pᵢ represents imaginary momentum, |pᵢ|=\sqrt{pᵢ²}=\sqrt{−Det(σ·pᵢ)}→σ·pᵢ represents fermionic spinization of |pᵢ|, and |pᵢ|=\sqrt{pᵢ²}={square root over (−(Det(s·pᵢ+I₃)−Det(I₃)))}→s·pᵢ represents bosonic spinization of |pᵢ|.

8: A method as in claim 7 wherein
said external object interacting with said internal object through said matrix rule is modeled as self-gravity or self-quantum entanglement;
fermionic spinization |p|=\sqrt{p²}=\sqrt{−Det(σ·p)}→σ·p and/or reversal of said fermionic spinization σ·p→\sqrt{−Det(σ·p)}=\sqrt{p²}=|p| is modeled as a first form of weak interaction;
bosonic spinization |p|=\sqrt{p²}={square root over (−(Det(s·p+I₃)−Det(I₃)))}→s·p of said elementary particle with rest mass and/or decay of said massive boson is modeled as a second form of weak interaction;
said bosonic spinization of said elementary particle with no rest mass and/or reversal of said bosonic spinization s·p→{square root over (−Det(s·p+I₃)−Det(I₃)))}=\sqrt{p²}=|p| of said massless boson is modeled as a form of electromagnetic interaction;
a process involving imaginary momentum pᵢ is modeled as strong interaction; and
a second interaction between said external object of said elementary particle and a second internal object of a second elementary particle or between said internal object of said elementary particle and an second external object of said second elementary particle is modeled as gravity or quantum entanglement.

9: A method of modeling an interaction inside brain, as a teaching and/or modeling tool, comprising the steps of:
generating a first representation of said interaction comprising:
$${( ( \begin{matrix}E - eφ - m & - σ \cdot ( {p}_{i} - e A ) \\ - σ \cdot ( {p}_{i} - e A ) & E - eφ + m\end{matrix} ) ( \begin{matrix}{ψ}_{e , -} \\ {ψ}_{i , +}\end{matrix} ) = 0 )}_{p} ( \begin{matrix}E & - σ \cdot p \\ - σ \cdot p & E\end{matrix} ) ( \begin{matrix}σ \cdot E \\ iσ \cdot B\end{matrix} ) = {( \begin{matrix}- iσ \cdot ( {ψ}^{†} βα ψ ) \\ - i ( {ψ}^{†} ββψ )\end{matrix} )}_{p} , and \text{/} or {( ( \begin{matrix}E + eφ - m & - σ \cdot ( p - e A ) \\ - σ \cdot ( p + e A ) & E - eφ + m\end{matrix} ) ( \begin{matrix}{ψ}_{e , +} \\ {ψ}_{i , -}\end{matrix} ) = 0 )}_{e} ( \begin{matrix}E & - σ \cdot p \\ - σ \cdot p & E\end{matrix} ) ( \begin{matrix}σ \cdot E \\ iσ \cdot B\end{matrix} ) = {( \begin{matrix}- iσ \cdot ( {ψ}^{†} βα ψ ) \\ - i ( {ψ}^{†} ββ ψ )\end{matrix} )}_{e} ,$$
where ( )ₚ( )ₚ denotes a proton-photon system, ( )ₑ( )ₑ denotes an electron-photon system, (A,φ) denotes electromagnetic potential, E denotes electric field, B denotes magnetic field, σ=(σ₁, σ₂, σ₃) denote Pauli matrices, (α, β) denote Dirac matrices, ψ denotes wave function, and ψ^{†} denotes conjugate transpose of ψ; and
presenting and/or modeling said first representation in a device for teaching and/or research.

10: A model for presenting and/or modeling creation, sustenance and evolution of an elementary particle, as a teaching and/or modeling tool, comprising:
a drawing representing said creation, sustenance and evolution of said elementary particle, said drawing comprising:
$$1 = {e}^{i 0} = 1 {e}^{i 0} = L {e}^{- i M + i M} = {L}_{e} {L}_{i}^{- 1} ( {e}^{- i M} ) {( {e}^{- i M} )}^{- 1} \to ( \begin{matrix}{L}_{M , e} & {L}_{M , i}\end{matrix} ) ( \begin{matrix}{A}_{e} {e}^{- i M} \\ {A}_{i} {e}^{- i M}\end{matrix} ) = {L}_{M} ( \begin{matrix}{ψ}_{e} \\ {ψ}_{i}\end{matrix} ) = 0$$
where e is natural exponential base, i is imaginary unit, L_{M} represents rule of one, M is a phase, Aₑe^{-iM}=ψₑ represents external object, Aᵢe^{-iM}=ψᵢ represents internal object, Lₑ represents external rule, Lᵢ represents internal rule, L=(L_{M,e} L_{M,i}) represents matrix rule, L_{M,e} represents external matrix rule and L_{M,i} represents internal matrix rule; and
a device for presenting and/or modeling said drawing.

11: A model as in claim 10 wherein said external object comprises of an external wave function; said internal object comprises of an internal wave function; said elementary particle comprises of a fermion, boson or unspinized particle; said matrix rule contains an energy operator E→i∂, momentum operator p→−i∇, spin operator σ where σ=(σ₁, σ₂ σ₃) are Pauli matrices, spin operator S where S=(S₁, S₂, S₃) are spin 1 matrices, and/or mass; said matrix rule further has a determinant containing E²−p²−m²=0, E²−p²=0, E²−m²=0, or 0²−p²−m²=0; c=1 where c is speed of light; and =1 where is reduced Planck constant.

12: A model as in claim 11 wherein said drawing of said creation, sustenance and evolution of said elementary particle comprises:
$$1 = {e}^{i 0} = 1 {e}^{i 0} = L {e}^{+ i M - i M} = \frac{{E}^{2} - {m}^{2}}{{p}^{2}} {e}^{+ i {p}^{μ} {x}_{μ} - i {p}^{μ} {x}_{μ}} = ( \frac{E - m}{- \vert p \vert} ) {( \frac{- \vert p \vert}{E + m} )}^{- 1} ( {e}^{- i {p}^{μ} {x}_{μ}} ) {( {e}^{- i {p}^{μ} {x}_{μ}} )}^{- 1} \to \frac{E - m}{- \vert p \vert} {e}^{- i {p}^{μ} {x}_{μ}} = \frac{- \vert p \vert}{E + m} {e}^{- i {p}^{μ} {x}_{μ}} \to \frac{E - m}{- \vert p \vert} {e}^{- i {p}^{μ} {x}_{μ}} - \frac{- \vert p \vert}{E + m} {e}^{- i {p}^{μ} {x}_{μ}} = 0 \to ( \begin{matrix}E - m & - \vert p \vert \\ - \vert p \vert & E + m\end{matrix} ) ( \begin{matrix}{a}_{e , +} {e}^{- i {p}^{μ} {x}_{μ}} \\ {a}_{i , -} {e}^{- i {p}^{μ} {x}_{μ}}\end{matrix} ) = 0 \to ( \begin{matrix}E - m & - σ \cdot p \\ - σ \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = ( \begin{matrix}{L}_{M , e} & {L}_{M , i}\end{matrix} ) ( \begin{matrix}{ψ}_{e , +} \\ {ψ}_{i , -}\end{matrix} ) = 0 or ( \begin{matrix}E - m & - s \cdot p \\ - s \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = ( \begin{matrix}{L}_{M , e} & {L}_{M , i}\end{matrix} ) ( \begin{matrix}{ψ}_{e , +} \\ {ψ}_{i , -}\end{matrix} ) = 0$$
where
$$( \begin{matrix}E - m & - \vert p \vert \\ - \vert p \vert & E + m\end{matrix} ) ( \begin{matrix}{a}_{e , +} {e}^{- i {p}^{μ} {x}_{μ}} \\ {a}_{i , -} {e}^{- i {p}^{μ} {x}_{μ}}\end{matrix} ) = 0$$
is a first equation for said unspinized particle,
$$( \begin{matrix}E - m & - σ \cdot p \\ - σ \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0$$
is Dirac equation in Dirac form for said fermion, and
$$( \begin{matrix}E - m & - s \cdot p \\ - s \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0$$
is a first equation for said boson;
$$1 = {e}^{i0} = 1 {e}^{i 0} = {L}_{1} {e}^{+ i M - i M} = \frac{{E}^{2} - {p}^{2}}{{m}^{2}} {e}^{+ i {p}^{μ} {x}_{μ} - i {p}^{μ} {x}_{μ}} = ( \frac{E - \vert p \vert}{- m} ) {( \frac{- m}{E + \vert p \vert} )}^{- 1} ( {e}^{- i {p}^{μ} {x}_{μ}} ) {( {e}^{- i {p}^{μ} {x}_{μ}} )}^{- 1} \to \frac{E - \vert p \vert}{- m} {e}^{- i {p}^{μ} {x}_{μ}} = \frac{- m}{E + \vert p \vert} {e}^{- i {p}^{μ} {x}_{μ}} \to \frac{E - \vert p \vert}{- m} {e}^{- i {p}^{μ} {x}_{μ}} - \frac{- m}{E + \vert p \vert} {e}^{- i {p}^{μ} {x}_{μ}} = 0 \to ( \begin{matrix}E - \vert p \vert & - m \\ - m & E + \vert p \vert\end{matrix} ) ( \begin{matrix}{a}_{e , l} {e}^{- i {p}^{μ} {x}_{μ}} \\ {a}_{i , r} {e}^{- i {p}^{μ} {x}_{μ}}\end{matrix} ) = 0 \to ( \begin{matrix}E - σ \cdot p & - m \\ - m & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = \begin{matrix}( {L}_{M , e} & {L}_{M , i} ) ( \begin{matrix}{ψ}_{e , l} \\ {ψ}_{i , r}\end{matrix} ) = 0\end{matrix} or ( \begin{matrix}E - s \cdot p & - m \\ - m & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = \begin{matrix}( {L}_{M , e} & {L}_{M , i} ) ( \begin{matrix}{ψ}_{e , l} \\ {ψ}_{i , r}\end{matrix} ) = 0\end{matrix}$$
where
$$( \begin{matrix}E - \vert p \vert & - m \\ - m & E + \vert p \vert\end{matrix} ) ( \begin{matrix}{a}_{e , l} {e}^{- i {p}^{μ} {x}_{μ}} \\ {a}_{i , r} {e}^{- i {p}^{μ} {x}_{μ}}\end{matrix} ) = 0$$
is a second equation for said unspinized particle,
$$( \begin{matrix}E - σ \cdot p & - m \\ - m & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
is Dirac equation in Weyl form for said fermion, and
$$( \begin{matrix}E - s \cdot p & - m \\ - m & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0$$
is a second equation for said boson;
$$1 = {e}^{i0} = 1 {e}^{i 0} = L {e}^{+ i M - i M} = \frac{{E}^{2}}{{m}^{2} + {p}^{2}} {e}^{+ i {p}^{μ} {x}_{μ} - i {p}^{μ} {x}_{μ}} = ( \frac{E}{- m + i \vert p \vert} ) {( \frac{- m - i \vert p \vert}{E} )}^{- 1} ( {e}^{- i {p}^{μ} {x}_{μ}} ) {( {e}^{- i {p}^{μ} {x}_{μ}} )}^{- 1} \to \frac{E}{- m + i \vert p \vert} {e}^{- i {p}^{μ} {x}_{μ}} = \frac{- m - i \vert p \vert}{E} {e}^{- i {p}^{μ} {x}_{μ}} \to \frac{E}{- m + i \vert p \vert} {e}^{- i {p}^{μ} {x}_{μ}} - \frac{- m - i \vert p \vert}{E} {e}^{- i {p}^{μ} {x}_{μ}} = 0 \to ( \begin{matrix}E & - m - i \vert p \vert \\ - m + i \vert p \vert & E\end{matrix} ) ( \begin{matrix}{a}_{e} {e}^{- i {p}^{μ} {x}_{μ}} \\ {a}_{i} {e}^{- i {p}^{μ} {x}_{μ}}\end{matrix} ) = 0 \to ( \begin{matrix}E & - m - iσ \cdot p \\ - m + iσ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = \begin{matrix}( {L}_{M , e} & {L}_{M , i} ) ( \begin{matrix}{ψ}_{e} \\ {ψ}_{i}\end{matrix} ) = 0\end{matrix} or ( \begin{matrix}E & - m - i s \cdot p \\ - m + i s \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = \begin{matrix}( {L}_{M , e} & {L}_{M , i} ) ( \begin{matrix}{ψ}_{e} \\ {ψ}_{i}\end{matrix} ) = 0\end{matrix}$$
where
$$( \begin{matrix}E & - m - i \vert p \vert \\ - m + i \vert p \vert & E\end{matrix} ) ( \begin{matrix}{a}_{e} {e}^{- i {p}^{μ} {x}_{μ}} \\ {a}_{i} {e}^{- i {p}^{μ} {x}_{μ}}\end{matrix} ) = 0$$
is a third equation for said unspinized particle,
$$( \begin{matrix}E & - m - iσ \cdot p \\ - m + iσ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0$$
is Dirac equation in a third form for said fermion, and
$$( \begin{matrix}E & - m - i s \cdot p \\ - m + i s \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0$$
is a third equation for said boson; or
$$1 = {e}^{i0} = 1 {e}^{i 0} = L {e}^{+ i M - i M} = \frac{{E}^{2} - {m}^{2}}{{p}_{i}^{2}} {e}^{+ i {p}^{μ} {x}_{μ} - i {p}^{μ} {x}_{μ}} = ( \frac{E - m}{- \vert {p}_{i} \vert} ) {( \frac{- \vert {p}_{i} \vert}{E + m} )}^{- 1} ( {e}^{- i {p}^{μ} {x}_{μ}} ) {( {e}^{- i {p}^{μ} {x}_{μ}} )}^{- 1} \to \frac{E - m}{- \vert {p}_{i} \vert} {e}^{- i {p}^{μ} {x}_{μ}} = \frac{- \vert {p}_{i} \vert}{E + m} {e}^{- i {p}^{μ} {x}_{μ}} \to \frac{E - m}{- \vert {p}_{i} \vert} {e}^{- i {p}^{μ} {x}_{μ}} - \frac{- \vert {p}_{i} \vert}{E + m} {e}^{- i {p}^{μ} {x}_{μ}} = 0 \to ( \begin{matrix}E - m & - \vert {p}_{i} \vert \\ - \vert {p}_{i} \vert & E + m\end{matrix} ) ( \begin{matrix}{s}_{e , +} {e}^{- i Et} \\ {s}_{i , -} {e}^{- i Et}\end{matrix} ) = 0 \to ( \begin{matrix}E - m & - σ \cdot {p}_{i} \\ - σ \cdot {p}_{i} & E + m\end{matrix} ) ( \begin{matrix}{S}_{e , +} {e}^{- i Et} \\ {S}_{i , -} {e}^{- i Et}\end{matrix} ) = \begin{matrix}( {L}_{M , e} & {L}_{M , i} ) ( \begin{matrix}{ψ}_{e , +} \\ {ψ}_{i , -}\end{matrix} ) = 0\end{matrix} or ( \begin{matrix}E - m & - s \cdot {p}_{i} \\ - s \cdot {p}_{i} & E + m\end{matrix} ) ( \begin{matrix}{S}_{e , +} {e}^{- i Et} \\ {S}_{i , -} {e}^{- i Et}\end{matrix} ) = \begin{matrix}( {L}_{M , e} & {L}_{M , i} ) ( \begin{matrix}{ψ}_{e , +} \\ {ψ}_{i , -}\end{matrix} ) = 0\end{matrix}$$
where
$$( \begin{matrix}E - m & - \vert {p}_{i} \vert \\ - \vert {p}_{i} \vert & E + m\end{matrix} ) ( \begin{matrix}{s}_{e , +} {e}^{- i Et} \\ {s}_{i , -} {e}^{- i Et}\end{matrix} ) = 0$$
is a first equation for said unspinized particle with said imaginary momentum pᵢ,
$$( \begin{matrix}E - m & - σ \cdot {p}_{i} \\ - σ \cdot {p}_{i} & E + m\end{matrix} ) ( \begin{matrix}{S}_{e , +} {e}^{- i Et} \\ {S}_{i , -} {e}^{- i Et}\end{matrix} ) = 0$$
is Dirac equation in Dirac form for said fermion with said imaginary momentum pᵢ, and
$$( \begin{matrix}E - m & - s \cdot {p}_{i} \\ - s \cdot {p}_{i} & E + m\end{matrix} ) ( \begin{matrix}{S}_{e , +} {e}^{- i Et} \\ {S}_{i , -} {e}^{- i Et}\end{matrix} ) = 0$$
is a first equation for said boson with said imaginary momentum pᵢ.

13: A model as in claim 12 wherein said elementary particle comprises of:
an electron, equation of said electron being modeled as:
$$( \begin{matrix}E - m & - σ \cdot p \\ - σ \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0 , \\ ( \begin{matrix}E - σ \cdot p & - m \\ - m & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0 or \\ ( \begin{matrix}E & - m - i σ \cdot p \\ - m + i σ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0 ;$$
a positron, equation of said positron being modeled as:
$$( \begin{matrix}E - m & - σ \cdot p \\ - σ \cdot p & E + m\end{matrix} ) ( \begin{matrix}{A}_{e , -} {e}^{+ i {p}^{μ} {x}_{μ}} \\ {A}_{i , +} {e}^{+ i {p}^{μ} {x}_{μ}}\end{matrix} ) = 0 , \\ ( \begin{matrix}E - σ \cdot p & - m \\ - m & E + σ \cdot p\end{matrix} ) ( \begin{matrix}{A}_{e , r} {e}^{+ i {p}^{μ} {x}_{μ}} \\ {A}_{i , l} {e}^{+ i {p}^{μ} {x}_{μ}}\end{matrix} ) = 0 or \\ ( \begin{matrix}E & - m - i σ \cdot p \\ - m + i σ \cdot p & E\end{matrix} ) ( \begin{matrix}{A}_{e} {e}^{+ i {p}^{μ} {x}_{μ}} \\ {A}_{i} {e}^{+ i {p}^{μ} {x}_{μ}}\end{matrix} ) = 0 ;$$
a massless neutrino, equation of said neutrino being modeled as:
$$( \begin{matrix}E & - σ \cdot p \\ - σ \cdot p & E\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0 , \\ ( \begin{matrix}E - σ \cdot p & \\ & E + σ \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0 or \\ ( \begin{matrix}E & - i σ \cdot p \\ + i σ \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0 ;$$
A massless antineutrino, equation of said antineutrino being modeled as:
$$( \begin{matrix}E & - σ \cdot p \\ - σ \cdot p & E\end{matrix} ) ( \begin{matrix}{A}_{e , -} {e}^{+ i {p}^{μ} {x}_{μ}} \\ {A}_{i , +} {e}^{+ i {p}^{μ} {x}_{μ}}\end{matrix} ) = 0 , \\ ( \begin{matrix}E - σ \cdot p & \\ & E + σ \cdot p\end{matrix} ) ( \begin{matrix}{A}_{e , r} {e}^{+ i {p}^{μ} {x}_{μ}} \\ {A}_{i , l} {e}^{+ i {p}^{μ} {x}_{μ}}\end{matrix} ) = 0 or \\ ( \begin{matrix}E & - i σ \cdot p \\ + i σ \cdot p & E\end{matrix} ) ( \begin{matrix}{A}_{e} {e}^{+ i {p}^{μ} {x}_{μ}} \\ {A}_{i} {e}^{+ i {p}^{μ} {x}_{μ}}\end{matrix} ) = 0 ;$$
a massive spin 1 boson, equation of said massive spin 1 boson being modeled as:
$$( \begin{matrix}E - m & - s \cdot p \\ - s \cdot p & E + m\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = 0 , \\ ( \begin{matrix}E - s \cdot p & - m \\ - m & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0 or \\ ( \begin{matrix}E & - m - i s \cdot p \\ - m + i s \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0 ;$$
a massive spin 1 antiboson equation of said massive spin 1 antiboson being modeled as:
$$( \begin{matrix}E - m & - s \cdot p \\ - s \cdot p & E + m\end{matrix} ) ( \begin{matrix}{A}_{e , -} {e}^{+ i {p}^{μ} {x}_{μ}} \\ {A}_{i , +} {e}^{+ i {p}^{μ} {x}_{μ}}\end{matrix} ) = 0 , \\ ( \begin{matrix}E - s \cdot p & - m \\ - m & E + s \cdot p\end{matrix} ) ( \begin{matrix}{A}_{e , r} {e}^{+ i {p}^{μ} {x}_{μ}} \\ {A}_{i , l} {e}^{+ i {p}^{μ} {x}_{μ}}\end{matrix} ) = 0 or \\ ( \begin{matrix}E & - m - i s \cdot p \\ - m + i s \cdot p & E\end{matrix} ) ( \begin{matrix}{A}_{e} {e}^{+ i {p}^{μ} {x}_{μ}} \\ {A}_{i} {e}^{+ i {p}^{μ} {x}_{μ}}\end{matrix} ) = 0 ;$$
a massless spin 1 boson, equation of said massless spin 1 boson being modeled as:
$$( \begin{matrix}E & - s \cdot p \\ - s \cdot p & E\end{matrix} ) ( \begin{matrix}{A}_{e , +} {e}^{- i {p}^{μ} {x}_{μ}} \\ {A}_{i , -} {e}^{- i {p}^{μ} {x}_{μ}}\end{matrix} ) = ( \begin{matrix}E & - s \cdot p \\ - s \cdot p & E\end{matrix} ) ( \begin{matrix}E \\ i B\end{matrix} ) = 0 , \\ ( \begin{matrix}E - s \cdot p & \\ & E + s \cdot p\end{matrix} ) ( \begin{matrix}{A}_{e , l} {e}^{- i {p}^{μ} {x}_{μ}} \\ {A}_{i , r} {e}^{- i {p}^{μ} {x}_{μ}}\end{matrix} ) = 0 or \\ ( \begin{matrix}E & - i s \cdot p \\ + i s \cdot p & E\end{matrix} ) ( \begin{matrix}{A}_{e} {e}^{- i {p}^{μ} {x}_{μ}} \\ {A}_{i} {e}^{- i {p}^{μ} {x}_{μ}}\end{matrix} ) = 0$$
where
$$( \begin{matrix}E & - s \cdot p \\ - s \cdot p & E\end{matrix} ) ( \begin{matrix}E \\ i B\end{matrix} ) = 0$$
is equivalent to Maxwell equation
$$( \begin{matrix}{\partial }_{t} E = ∇ \times B \\ {\partial }_{t} B = - ∇ \times E\end{matrix} ) ;$$
a massless spin 1 antiboson, equation of said massless spin 1 antiboson being modeled as:
$$( \begin{matrix}E & - s \cdot p \\ - s \cdot p & E\end{matrix} ) ( \begin{matrix}{A}_{e , -} {e}^{+ i {p}^{μ} {x}_{μ}} \\ {A}_{i , +} {e}^{+ i {p}^{μ} {x}_{μ}}\end{matrix} ) = 0 , \\ ( \begin{matrix}E - s \cdot p & \\ & E + s \cdot p\end{matrix} ) ( \begin{matrix}{A}_{e , r} {e}^{+ i {p}^{μ} {x}_{μ}} \\ {A}_{i , l} {e}^{+ i {p}^{μ} {x}_{μ}}\end{matrix} ) = 0 or \\ ( \begin{matrix}E & - i s \cdot p \\ - m + i s \cdot p & E\end{matrix} ) ( \begin{matrix}{A}_{e} {e}^{+ i {p}^{μ} {x}_{μ}} \\ {A}_{i} {e}^{+ i {p}^{μ} {x}_{μ}}\end{matrix} ) = 0 ;$$
an antiproton, equation of said antiproton being modeled as:
$$( \begin{matrix}E - m & - σ \cdot {p}_{i} \\ - σ \cdot {p}_{i} & E + m\end{matrix} ) ( \begin{matrix}{S}_{e , +} {e}^{- i Et} \\ {S}_{i , -} {e}^{- i Et}\end{matrix} ) = 0 , \\ ( \begin{matrix}E - σ \cdot {p}_{i} & - m \\ - m & E + σ \cdot {p}_{i}\end{matrix} ) ( \begin{matrix}{S}_{e , l} {e}^{- i Et} \\ {S}_{i , r} {e}^{- i Et}\end{matrix} ) = 0 or \\ ( \begin{matrix}E & - m - i σ \cdot {p}_{i} \\ - m + i σ \cdot {p}_{i} & E\end{matrix} ) ( \begin{matrix}{S}_{e} {e}^{- i Et} \\ {S}_{i} {e}^{- i Et}\end{matrix} ) = 0 ; or$$
a proton, equation of said proton being modeled as:
$$( \begin{matrix}E - m & - σ \cdot {p}_{i} \\ - σ \cdot {p}_{i} & E + m\end{matrix} ) ( \begin{matrix}{S}_{e , -} {e}^{+ i Et} \\ {S}_{i , +} {e}^{+ i Et}\end{matrix} ) = 0 , \\ ( \begin{matrix}E - σ \cdot {p}_{i} & - m \\ - m & E + σ \cdot {p}_{i}\end{matrix} ) ( \begin{matrix}{S}_{e , r} {e}^{+ i Et} \\ {S}_{i , l} {e}^{+ i Et}\end{matrix} ) = 0 or \\ ( \begin{matrix}E & - m - i σ \cdot {p}_{i} \\ - m + i σ \cdot {p}_{i} & E\end{matrix} ) ( \begin{matrix}{S}_{e} {e}^{+ i Et} \\ {S}_{i} {e}^{+ i Et}\end{matrix} ) = 0.$$

14: A model as in claim 12 wherein said elementary particle comprises an electron and said drawing is modified to include a proton, said proton being modeled as a second elementary particle, and interaction fields of said electron and said proton, said modified drawing comprising:
$$1 = {e}^{i 0} = 1 {e}^{i 0} 1 {e}^{i 0} = {( L {e}^{+ i M - i M} )}_{p} {( L {e}^{+ i M - i M} )}_{e} = {( \frac{{E}^{2} - {m}^{2}}{{p}_{i}^{2}} {e}^{+ i {p}^{μ} {x}_{μ} - i {p}^{μ} {x}_{μ}} )}_{p} {( \frac{{E}^{2} - {m}^{2}}{{p}^{2}} {e}^{- i {p}^{μ} {x}_{μ} + i {p}^{μ} {x}_{μ}} )}_{e} = \\ {( ( \frac{E - m}{- \vert {p}_{i} \vert} ) {( \frac{- \vert {p}_{i} \vert}{E + m} )}^{- 1} ( {e}^{+ i {p}^{μ} {x}_{μ}} ) {( {e}^{+ i {p}^{μ} {x}_{μ}} )}^{- 1} )}_{p} {( ( \frac{E - m}{- \vert p \vert} ) {( \frac{- \vert p \vert}{E + m} )}^{- 1} ( {e}^{- i {p}^{μ} {x}_{μ}} ) {( {e}^{- i {p}^{μ} {x}_{μ}} )}^{- 1} )}_{e} \\ -> {( ( \begin{matrix}E - m & - \vert {p}_{i} \vert \\ - \vert {p}_{i} \vert & E + m\end{matrix} ) ( \begin{matrix}{S}_{e , -} {e}^{+ i Et} \\ {S}_{i , +} {e}^{+ i Et}\end{matrix} ) = 0 )}_{p} {( ( \begin{matrix}E - m & - \vert p \vert \\ - \vert p \vert & E + m\end{matrix} ) ( \begin{matrix}{S}_{e , +} {e}^{- i Et} \\ {S}_{i , -} {e}^{- i Et}\end{matrix} ) = 0 )}_{e} \\ -> ( \begin{matrix}{( ( \begin{matrix}E - e φ - m & - σ \cdot ( {p}_{i} - e A ) \\ - σ \cdot ( {p}_{i} - e A ) & E - e φ + m\end{matrix} ) ( \begin{matrix}{S}_{e , -} {e}^{+ i Et} \\ {S}_{i , +} {e}^{+ i Et}\end{matrix} ) = 0 )}_{p} \\ {( ( \begin{matrix}E + e φ - m & - σ \cdot ( p + e A ) \\ - σ \cdot ( p + e A ) & E + e φ + m\end{matrix} ) ( \begin{matrix}{S}_{e , +} {e}^{- i Et} \\ {S}_{i , -} {e}^{- i Et}\end{matrix} ) = 0 )}_{e}\end{matrix} )$$
where ( )ₑ denotes electron, ( )ₚ denotes proton and (( )ₑ( )ₚ) denotes an electron-proton system.

15: A method as in claim 12 wherein said elementary particle comprises of an electron and said drawing is modified to include an unspinized proton, said unspinized proton being modeled as a second elementary particle, and interaction fields of said electron and said unspinized proton, said modified drawing comprising:
$$1 = {e}^{i 0} = 1 {e}^{i 0} 1 {e}^{i 0} = {( L {e}^{+ i M - i M} )}_{p} {( L {e}^{+ i M - i M} )}_{e} = {( \frac{{E}^{2} - {m}^{2}}{{p}_{i}^{2}} {e}^{+ i {p}^{μ} {x}_{μ} - i {p}^{μ} {x}_{μ}} )}_{p} {( \frac{{E}^{2} - {m}^{2}}{{p}^{2}} {e}^{- i {p}^{μ} {x}_{μ} + i {p}^{μ} {x}_{μ}} )}_{e} = \\ {( ( \frac{E - m}{- \vert {p}_{i} \vert} ) {( \frac{- \vert {p}_{i} \vert}{E + m} )}^{- 1} ( {e}^{+ i {p}^{μ} {x}_{μ}} ) {( {e}^{+ i {p}^{μ} {x}_{μ}} )}^{- 1} )}_{p} {( ( \frac{E - m}{- \vert p \vert} ) {( \frac{- \vert p \vert}{E + m} )}^{- 1} ( {e}^{- i {p}^{μ} {x}_{μ}} ) {( {e}^{- i {p}^{μ} {x}_{μ}} )}^{- 1} )}_{e} \\ -> {( ( \begin{matrix}E - m & - \vert {p}_{i} \vert \\ - \vert {p}_{i} \vert & E + m\end{matrix} ) ( \begin{matrix}{S}_{e , -} {e}^{+ i Et} \\ {S}_{i , +} {e}^{+ i Et}\end{matrix} ) = 0 )}_{p} {( ( \begin{matrix}E - m & - \vert p \vert \\ - \vert p \vert & E + m\end{matrix} ) ( \begin{matrix}{S}_{e , +} {e}^{- i Et} \\ {S}_{i , -} {e}^{- i Et}\end{matrix} ) = 0 )}_{e} \\ -> ( \begin{matrix}{( ( \begin{matrix}E - e φ - m & - \vert {p}_{i} - e A \vert \\ - \vert {p}_{i} - e A \vert & E - e φ + m\end{matrix} ) ( \begin{matrix}{S}_{e , -} {e}^{+ i Et} \\ {S}_{i , +} {e}^{+ i Et}\end{matrix} ) = 0 )}_{p} \\ {( ( \begin{matrix}E + e φ - V - m & - σ \cdot ( p + e A ) \\ - σ \cdot ( p + e A ) & E + e φ - V + m\end{matrix} ) ( \begin{matrix}{S}_{e , +} {e}^{- i Et} \\ {S}_{i , -} {e}^{- i Et}\end{matrix} ) = 0 )}_{e}\end{matrix} )$$
where ( )ₑ denotes electron, ( )ₚ denotes unspinized proton and (( )ₑ( )ₚ) denotes an electron-unspinized proton system.

16: A model as in claim 11 wherein formation of said matrix rule in said drawing comprises:
$$-> 1 = L = \frac{{E}^{2} - {M}^{2}}{{p}^{2}} = ( \frac{E - m}{- \vert p \vert} ) {( \frac{- \vert p \vert}{E + m} )}^{- 1} -> \frac{E - m}{- \vert p \vert} = \frac{- \vert p \vert}{E + m} -> \frac{E - m}{- \vert p \vert} - \frac{- \vert p \vert}{E + m} = 0 \\ -> ( \begin{matrix}E - m & - \vert p \vert \\ - \vert p \vert & E + m\end{matrix} ) -> ( \begin{matrix}E - m & - σ \cdot p \\ - σ \cdot p & E + m\end{matrix} ) or ( \begin{matrix}E - m & - s \cdot p \\ - s \cdot p & E + m\end{matrix} ) , \\ -> 1 = L = \frac{{E}^{2} - {p}^{2}}{{m}^{2}} = ( \frac{E - \vert p \vert}{- m} ) {( \frac{- m}{E + \vert p \vert} )}^{- 1} -> \frac{E - \vert p \vert}{- m} = \frac{- m}{E + \vert p \vert} -> \frac{E - \vert p \vert}{- m} - \frac{- m}{E + \vert p \vert} = 0 \\ -> ( \begin{matrix}E - \vert p \vert & - m \\ - m & E + \vert p \vert\end{matrix} ) -> ( \begin{matrix}E - σ \cdot p & - m \\ - m & E + σ \cdot p\end{matrix} ) or ( \begin{matrix}E - s \cdot p & - m \\ - m & E + s \cdot p\end{matrix} ) , \\ -> 1 = L = \frac{{m}^{2} + {p}^{2}}{{E}^{2}} = {( \frac{E}{- m + i \vert p \vert} )}^{- 1} ( \frac{- m - i \vert p \vert}{E} ) \\ -> \frac{E}{- m + i \vert p \vert} = \frac{- m - i \vert p \vert}{E} -> \frac{E}{- m + i \vert p \vert} - \frac{- m - i \vert p \vert}{E} = 0 \\ -> ( \begin{matrix}E & - m - i \vert p \vert \\ - m + i \vert p \vert & E\end{matrix} ) -> ( \begin{matrix}E & - m - i σ \cdot p \\ - m + iσ \cdot p & E\end{matrix} ) or ( \begin{matrix}E & - m - i s \cdot p \\ - m + i s \cdot p & E\end{matrix} ) , or \\ -> 1 = L = \frac{{E}^{2} - {p}_{i}^{2}}{{m}^{2}} = ( \frac{E - \vert {p}_{i} \vert}{- m} ) {( \frac{- m}{E + \vert {p}_{i} \vert} )}^{- 1} -> \frac{E - \vert {p}_{i} \vert}{- m} = \frac{- m}{E + \vert {p}_{i} \vert} -> \frac{E - \vert {p}_{i} \vert}{- m} - \frac{- m}{E + \vert {p}_{i} \vert} = 0 \\ -> ( \begin{matrix}E - \vert {p}_{i} \vert & - m \\ - m & E + \vert {p}_{i} \vert\end{matrix} ) -> ( \begin{matrix}E - σ \cdot {p}_{i} & - m \\ - m & E + σ \cdot {p}_{i}\end{matrix} ) or ( \begin{matrix}E - s \cdot {p}_{i} & - m \\ - m & E + s \cdot {p}_{i}\end{matrix} ) ,$$
where σ=(σ₁, σ₂, σ₃) are Pauli matrices, |p|=\sqrt{p²}=\sqrt{−Det(σ·p)}→σ·p represents fermionic spinization of |p|, S=(S₁, S₂, S₃) are spin operators for spin 1 particle, |p|=\sqrt{p²}={square root over (−(Det(s·p+I₃)−Det(I₃)))}→s·p represents bosonic spinization of |p|, pᵢ represents imaginary momentum, |pᵢ=\sqrt{pᵢ²}=\sqrt{−Det(σ·pᵢ)}→σ·pᵢ represents fermionic spinization of |pᵢ|, and |pᵢ|=\sqrt{pᵢ²}={square root over (−(Det(s·pᵢ+I₃)−Det(I₃)))}→s·pᵢ represents bosonic spinization of |pᵢ|.

17: A model as in claim 16 wherein
said external object interacting with said internal object through said matrix rule is modeled as self-gravity or self-quantum entanglement;
fermionic spinization |p|=\sqrt{p²}=\sqrt{−Det(σ·p)}→σ·p and/or reversal of said fermionic spinization σ·p→\sqrt{−Det(σ·p)}=\sqrt{p²}=|p| is modeled as a first form of weak interaction;
bosonic spinization |p|=\sqrt{p²}={square root over (−(Det(s·p+I₃)−Det(I₃)))}→s·p of said elementary particle with rest mass and/or decay of said massive boson is modeled as a second form of weak interaction;
said bosonic spinization of said elementary particle with no rest mass and/or reversal of said bosonic spinization s·p→{square root over (−(Det(s·p+I₃)−Det(I₃)))}=\sqrt{p²}=|p| of said massless boson is modeled as a form of electromagnetic interaction;
a process involving imaginary momentum pᵢ is modeled as strong interaction; and
a second interaction between said external object of said elementary particle and a second internal object of a second elementary particle or between said internal object of said elementary particle and an second external object of said second elementary particle is modeled as gravity or quantum entanglement.
